(19) United States
(12) Patent Application Publication
(10) Pub. No.: US 2026/0147985 A1
(43) Pub. Date: May 28, 2026

(54) SOURCE BASED RESEARCH AND WRITING FRAMEWORK TECHNOLOGY

(71) Applicant: Retrove Inc., Chicago, IL (US)

(72) Inventor: Thomas Puech, Chicago, IL (US)

(21) Appl. No.: 18/962,417

(22) Filed: Nov. 27, 2024

(51) Int. Cl. G06F 40/169; G06F 3/0484; G06F 3/0487; G06F 40/103

(52) U.S. Cl. CPC G06F 40/169; G06F 3/0484; G06F 40/103; G06F 3/0487

(57) ABSTRACT

A web browser extension for annotating a web page in a web browser is described. The extension operates to create an annotation item box module in a side panel that contains separate annotation highlighted content that corresponds to and is the same as annotation highlighted content in the web page that was added by the user in the web browser. The separate annotation highlighted content in the side panel presents the annotation highlighted content to enable the user to view the annotation highlighted content without having to navigate to or view them on the web browser. The extension operates to automatically save the resource locator to the web page that is linked to the annotation in the side panel in an embedded link. The user can then visit the web page on which the annotation resides and share a selected trove and documents with others, maintaining the source citation.

### TECHNICAL FIELD

The present application relates generally to a software framework for collecting, classifying, and annotating content from an original source into a final document wherein the annotated content is associated with the original source locator, the annotated content is modular or rearrangeable within the final document, and/or the annotated content is migrated to another document or shared with another user.

### BACKGROUND

The world wide web (WWW), web browsers, and browser extensions are well known. The WWW is a global information source where assets such as web pages, pdf documents, images, audio clips, and videos are identified by unique uniform resource locators (URLs), and web browsers are software applications designed to access information on the WWW. Browser extensions are pieces of software designed to extend the capabilities of pre-existing web browsers. Web browser functionality can be modified either by modifying a web browser's software code base or by providing a web browser extension for those web browsers that support the addition of functionality by such means.

Teams, office personnel, students, or other persons often access web browsers or software applications to conduct research and/or find information. These persons also like to collaborate with others to discuss their findings, share their findings and thoughts on the findings, find what others already found on niche topics or curated content, and ask questions about the findings or research. These persons often need to retrieve information they have previously seen on the WWW. They need to send and discuss snippets of text within web documents with friends, colleagues, teachers or mentors. These persons often need to refer to specific pieces of text or context within a web document and/or ask specific questions about portions of web documents. Moreover, these persons often need to connect information across multiple web documents. They need to find and organize content and snippets for later use. They need to stay organized during these search and content generation processes.

As a specific example, researchers or students writing papers work with their teachers, other mentors or colleagues during the research and writing phases of a paper. Teachers or mentors need to interact with the students or researchers to review and collaborate during the research and writing phases. Teachers or mentors need to keep track of their student's progress. Students or researchers conducting research to find information on the WWW must then process or understand the information, assimilate the information, track the information and sources, and then write the paper. Students or researchers often review many different articles, documents, or information on the WWW via different types of software applications and these articles or documents become sources to cite in their papers. Students or researchers often copy and paste the citations or website addresses for the information in another application or software. Some applications such as a bibliography generator application tracks the citations or website addresses for the information and allows the user to make a bibliography summary for their paper. While reviewing the articles in web browsers, users take notes in other types of software such as a personal word processor or spreadsheet document. The user juggles between different types of software to track the resources and write a paper which creates inefficiency and time waste. Moreover, since the user juggles between different types of software, the mentor, teacher, or colleagues collaborating also juggles between different types of software to collaborate which also creates time waste. The parties may email messages or documents in order to share information however any progress or updates are not necessarily tracked unless this information is copied and pasted into the messages, documents, or software applications which can be challenging to keep up to date. Therefore real-time progress may not be captured. These barriers make collaborating difficult for both parties.

Providing methods and systems for handling these and other tasks in a more efficient manner would be advantageous.

### SUMMARY

The present application includes a means for highlighting or selecting and annotating a web page, document, or any other digital information including articles, PDFs, audio elements, videos, podcasts by any means such as internet search engines, web applications, websites, or social networks. The present application discloses a means to save, annotate, and sort the information that was selected from any digital medium and source, to organize and source the annotated content for reuse at a later time, either by simple classification or by creating a new personalized and sourced document. Each element that includes annotated content is a modular structure that can be migrated within or duplicated from one document or view to other documents or views or users. Beneficially, the original source for this annotated content is automatically saved with the annotated content so the user can refer to the original source whenever they view the annotated content. The present application extracts the citation metadata for that source and associates this with the annotated content. The present application includes various means to accomplish all of these tasks. Some of the means include annotation capable web browsers, web browser extension, desktop application, mobile application, word processing software, and/or other software integrations.

For example, the web browser extension or the webpage includes annotation capabilities that include any of an explanatory note, comment, or drawing added to any of a text, diagram, picture, document, video, image, or sound recording in the web page. The web browser extension or webpage operates to split a user's screen into two parts wherein the first part includes the user interface for the web browser with annotated content, highlighted text, image, audio, link or file that is selected by a user, and the second part includes a user interface of a side panel or notepad that allows users to save their quotes, notes, annotations, and additional sources in the notepad without having to copy and paste into the notepad. Annotations represent any comment or user content the user added to the original content. The web browser extension or webpage operates to create an annotation item box module (e.g., a set of user interface elements providing corresponding functionality) in the side panel or notepad. The annotation item box module contains separate annotation highlighted text, image, sound or video that corresponds to and is the same as the annotation highlighted text, image, sound or video in a web page associated with the web browser. The separate annotation highlighted text, image, sound or video presents the annotation highlighted text, image, sound or video to enable the user to view the annotation highlighted text, image, sound or video without having to navigate to or view the annotation capable web browser. The annotation item box module can also contain an embedded link that corresponds to the resource locator or URL for the annotation capable web browser and is intended to allow the user to click the embedded link and then visit or navigate to the web page of the web browser on which the annotation resides and the location of the annotation highlighted text, image, sound or video within the web page of the web browser exists. The annotation highlighted text, image, sound or video in web page associated with the web browser also shows or displays the notes from the user in the web page. The web browser extension operates to automatically save the resource locator to the web page that is linked to the annotation whenever the user saves that annotation on the web page.

In some embodiments, associated user interface features in the side panel or notepad of the web browser extension exist. The side panel of the web browser extension can include more than one notepad. Some of these notepads include and are delineated with interface features such as a recents tab, a trove tab, and a page tab. The trove tab has a trove notepad that can be shared with other persons externally for collaboration. The trove notepad includes the annotation item box module and any additional notes or content that the user desires. The page tab or on this page tab shows all the content saved or written on the current source. The page tab can also be shared with other users for collaboration, that will show as an annotated webpage.

In some embodiments, the notepads in the web browser extension include interface features. One such interface feature is a cite icon or button that creates a bibliography page in a separate clipboard or document from the embedded links saved with the annotation item box module and/or from additional resource locators or URL's saved by the user in the notepad. The cite icon or button can also copy any additional notes and content from the annotation item box module into the separate clipboard or document. Another interface feature of the web browser extension is that the interface adds a pop-up showing a preview of a website to which a hyperlink links to when hovering over the hyperlink or over any piece of content.

In some embodiments, another feature of the web browser extension includes the interoperability of the web browser extension and a website that can synchronize troves and make the troves available to other properly permissioned users or the public. In particular, the interoperability includes a drag-and-drop feature from the extension to the website, that allows users to grab any item box from the extension side panel into a trove on the website, dropping that item box in any place the user prefers on the website rendered trove. The website can also include the same system as the extension side panel, but allow the user to split the screen with a side panel on the website itself, allowing users on the website to have a different trove view open on each side and drag and drop them. One example of that would be the user converting their text and notes into a slide presentation and having both of those different troves or trove views opened at the same time on the website.

Still other features include browser extensions and word processing applications that are either desktop-based (such as word processing application) or cloud-based. Other features include a desktop application and mobile application which function similarly to the web browser extension and the website, while providing more reach and ease of use to collect content from any source directly on document readers, desktop folders and files and content from social media and messaging applications or any other application the user might want to collect content from or annotate on. For example, a user is able to collect, clip and annotate on a video from a social media platform on their phone and rearrange this modular content in a new document wherein the modular content retains the metadata for the original content.

Still other features include a way for users to drag and drop tags onto item boxes or any piece of content saved within the software, to then filter or sort by tag and organize their content in different ways such as by urgency, tracking tasks, theme, or subject, to name a few. This could also be done automatically with AI depending on user preferences. A tag can be dropped on any highlight, note, to-do list or source or title module, the user will then be able to filter all their content that have been tagged that way.

Still other features include reorganization of user content in any context or troves. A user could select multiple modules on any view and right click to open a menu and select the option to “export into new trove”, which will create a trove with the content selected. The user will have the choice to duplicate it from the original location or to move it to the new trove. If the module or content that was selected was within a trove, then by default the new trove will be created within the same trove but that can be changed by the user. Upon creating that new trove, the user will also have the option to use AI writing assistance or search to enhance the content based on what the user will define as their use case. This could be done through prompting the user with one or more questions. This would provide an alternate structure for the trove, including creating views for use cases.

Still other features include a recommendation engine or rendering suggestions that consist of sources or highlights, or any type of modules based on what the user is currently researching or working in their trove or in other system contexts. The user will be able to configure this to dive deeper into suggestions or can turn this off. Suggestions are shown based on other user's use of the content suggested in similar themes or fields of research. This could be done using AI or other sort of recommendation funnels, for example knowledge graph databases and semantic links between content.

Still other features include a citation and bibliography generator that seamlessly integrate or generate bibliographies, inline citations, citations, footnotes and any other parameters from the user's text and saved content within or outside of a trove. The citation and bibliography generator would automatically generate and reorder citations within the bibliography by order of which sources are mentioned in the trove and/or written piece the user is creating. The citation and bibliography generator enables users to go from research to draft to final written piece while linking all written output precisely to a citation or source, therefore saving user's time and avoiding struggles with plagiarism. One exemplary use case includes a user using references or saved content for creating or stitching videos together. The citations of one source, or generating a bulk linked bibliography from the user's trove in real-time and reflecting their changes as the user adds new content from sources or writes in the trove. This citation and bibliography feature can also be accessed through integrations with text editors to work where the user does.

Still other features include a way for users to hover their cursor over a link or source module and see a popup or other user interface that shows a preview of the information on this link. The preview information can contain information found in the metadata of the link that is fetched when the user saves that source or content on it. The preview information can also contain notes or other content the user saved on this source, along with citation metadata depending on the user's use case. This information can be tailored to the user's project and hence the preview can show different data for each trove. Example of preview metadata can include a title, a description, a cover image, author names, publication date, user notes, the user's profile which added that source and so on. In one iteration, the user might want to see all the content that was saved on this source by hovering their cursor over the link or source module and viewing the popup or other user interface.

Still other features include different ways for users to view or format a trove content or “views”. Views allow the user to see the same content or data in different ways. This allows the user to switch or select views depending on their use cases or stages of their project's process. View types include types of documents. For example, to allow the user to start with a sources view to save relevant information they find, then a text editor view to write an article about what they found and finally switch to a slide presentation view to present their findings in front of an audience, all within the same trove. The user can set views at the beginning of their research process when they create a trove or can convert an existing view into another type of view, or switch between views within the same trove. This allows the user to create different kinds of visualization and structure of the information they collect and expand on. This allows users to see the same content in different ways and determine how they want to present their research. Type of views can include: a text editor view, a text editor panel split with a side panel trove, a source view, a spreadsheet or table view, a whiteboard view, and a slide presentation view, which are described in more detail below. The user can create multiple views of the same kind if they wish or to rearrange the order of their lecture or speech on two different slide presentation views for example. This allows users to intuitively iterate between ideas and structures, while also encompassing the whole research process, from the point where the user saves information, to the point where the user shares or presents that information with their thoughts on it. Views and same types of views can be duplicated and configured in different ways, for example users could sort or filter the content in a single view by theme, keyword, tag, or date field in metadata of sources. Content saved in a trove can be specific to a view so that users can build on their research while still keeping the raw trove research intact in a separate view. One example might be text for slide presentations that is only present on the slides but not on the text editor or sources view. For example, a user can convert their text editor view with titles/headers so that each title can be the header text of one slide but the user can edit the title of the slide to be specific to the slide view.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a diagram of at least one embodiment of a system for selecting, classifying reusing, and exporting content from an original source into a final document;

FIG. 2 is a diagram of a compute device of the system of FIG. 1;

FIGS. 3-6 are flow charts of a method that may be performed by a compute device of the system of FIG. 1 for collecting, classifying, and annotating content from an original source into a final document;

FIG. 7 represents a user interface of an annotation capable web browser and a user interface of a web browser extension, in an exemplary embodiment wherein a web browser not capable of creating annotations has been augmented with a web browser extension providing annotation capability, after the annotation process has begun;

FIG. 8 represents a user interface of a website linked to the web browser extension;

FIG. 9 represents a user interface of the website for the web browser extension;

FIG. 10 shows the user interface of the annotation capable web browser of FIG. 7, before the annotation process has begun;

FIG. 11 shows the user interface of the annotation capable web browser of FIG. 10, after the annotation process has begun;

FIG. 12 shows the user interface of the annotation capable web browser of FIG. 11, after an annotation selection button has been selected and an annotation input box is displayed;

FIG. 13 shows the user interface of the annotation capable web browser of FIG. 12 and the user interface of the web browser extension, after the annotation process has begun;

FIG. 14 represents a second embodiment of a user interface of an annotation capable web browser and a user interface of the web browser extension, in an exemplary embodiment wherein a web browser not capable of creating annotations has been augmented with a web browser extension providing annotation capability, after the annotation process has begun;

FIG. 15 represents a third embodiment of a user interface of an annotation capable web browser and a user interface of a web browser extension, in an exemplary embodiment wherein a web browser not capable of creating annotations has been augmented with a web browser extension providing annotation capability, after a trove tab is engaged;

FIG. 16 represents the user interface of the annotation capable web browser and the user interface of the web browser extension of FIG. 15, after the user has selected a cite icon;

FIG. 17 illustrates a document that includes one or more citations in a designated bibliographic format and cited content, after the user has selected a desired citation format in the user interface of the web browser extension of FIG. 16;

FIG. 18 illustrates an exemplary embodiment of the user interface of the web browser extension and a user interface of a website connected or linked to the web browser extension;

FIG. 19 illustrates an exemplary embodiment of a user interface of a web browser extension and a user interface of a website connected or linked to the web browser extension, in a default configuration of the web browser extension;

FIG. 20 represents the user interface of the web browser extension and a user interface of another website, after a page tab is engaged on the web browser extension;

FIG. 21 represents the user interface of the web browser extension and the user interface of the website of FIG. 19, after a trove tab is engaged on the web browser extension;

FIG. 22 represents another embodiment of the user interface of the web browser extension and the user interface of the website of FIG. 21;

FIGS. 23-49 represent additional user interfaces that may be presented by the system of FIG. 1;

FIGS. 50 and 51 represent flow charts of operations that may be performed in connection with user interfaces presented by the system of FIG. 1; and

FIGS. 52-61 represent views that may be presented in user interfaces presented by the system of FIG. 1.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

Methods, non-transitory computer readable mediums (CRMs), and systems are provided for annotating web pages, documents, pictures, videos, and sound recordings within web browsers, websites, and applications or apps; organizing these annotations; viewing these annotations; connecting these annotations into useful digital notepads that include a set of annotations and additional content; sharing these annotations between multiple people; automatically storing a URL to the web page or pdf in a browser from which the annotation was created; and generating an accurate citation to a source on the web page (e.g., content item) from which the annotation was created; selecting a bibliography format for the citation. A web document has a URL and includes web pages, pdf documents, videos and other document types displayed in web browsers. In at least some embodiments, a file can be linked to the annotation (or note taken on the sidepanel) instead of a URL. For example, in embodiments in which the functionality described herein is incorporated into a desktop application, users may highlight content in their local pdfs and files. Furthermore, these methods, non-transitory CRMs, and systems provide facilities for curating content, sharing content with other users, and managing access controls. The descriptions contain flow charts showing a user's rationale for using the systems and non-transitory CRMs herein. In addition, graphical user interface (GUI) diagrams show the end result of computer readable medium instructions and what systems display. Furthermore, flowcharts describe methods.

An annotation is an explanatory note, comment, or drawing added to a text, diagram, picture, document, video, image, sound recording, or any type of content found on a webpage, mobile application or app, and/or document. When describing methods, nontransitory CRMs, and systems; terminology is introduced to describe annotations within different contexts along with the data elements and structures to represent annotations and objects that add to the context of annotations within web pages, web documents, mobile applications, documents, pictures, videos, and sound recordings as well as within separate context areas such as a web extension. Each element that includes annotated content is a modular structure that can be migrated within or duplicated from one trove (e.g., container) or view to other troves (e.g., containers) or views or users. The original source for this annotated content is automatically saved with the annotated content so the user can refer to the original source whenever they view the annotated content. The present application extracts the citation metadata for that source and associates this with the annotated content. The present application includes various means to accomplish all of these tasks. Some of the means include annotation capable web browsers, web browser extension, desktop application, mobile application, word processing software, video or sound processing software and/or other software integrations.

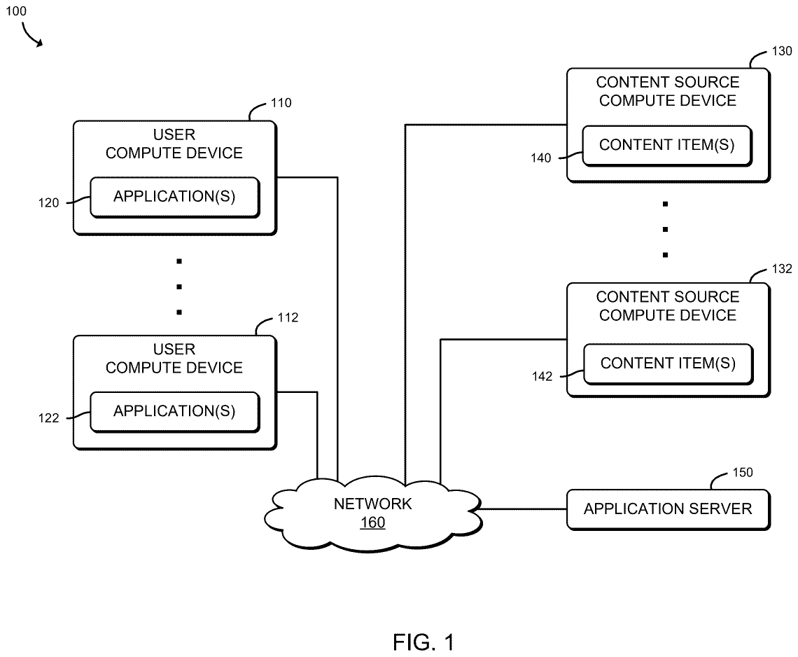

Referring now to FIG. 1, a system 100 for selecting, classifying reusing, and exporting content from an original source into a final document includes, in the illustrative embodiment, a set of user compute devices 110, 112, a set of content source compute devices 130, 132, and an application server 150 communicatively coupled via a network 160. Each user compute device 110, 112 may execute one or more corresponding applications 120, 122 (e.g., software applications) each of which may be embodied as a set of computer-executable instructions that, when executed, cause the corresponding compute device 110, 112 to perform a set of operations. The applications 120 may include a web browser application, one or more extensions for the web browser application (e.g., sets of code to supplement the operations of the web browser), content editing software (e.g., a document editor, such as Microsoft Word, and/or video and/or audio editing software), and/or others. Each of the content source compute devices 130, 132 may be embodied as a web server or other compute device configured to provide (e.g., via the network 160) one or more content items 140, 142 (e.g., upon request from a corresponding user compute device 110, 112). Each content item 140, 142 may be embodied as a web page, a document, an image, a set of audio and/or video, a combination thereof, and/or other media.

As described in more detail herein, a user compute device 110, 112, in operation, may receive data indicative of selected content (e.g., selected by a user, such as with a mouse pointer or other input device) within a content item (e.g., requested from a content source compute device 130, 132 and displayed within a web browser or other application 120) and classify the selected content within a user-designated container (e.g., also referred to herein as a folder or a trove) including storing information regarding the source of the content item. The user compute device 110, 112 may also store any user-provided notes associated or not with the content item in association with the container. Further, the user compute device 110, 112 may enable reuse of selected content stored (e.g., and notes) in one or more containers by enabling a user to incorporate the selected content (e.g., and notes) into a new publication (e.g., a report) that includes both the selected content (e.g., and notes), citations to the sources associated with the selected content (e.g., formatted to according to a user-selected citation format), and export the result (e.g., the report) to use in another application 120 (e.g., a content editing application) and/or for review by one or more other users. In at least some embodiments, all or a portion of the above operations may be supported by an application server 150, which may interact with the user compute device 110, 112 through one or more corresponding application programming interface (API) calls. For example, the application server 150 may store and/or retrieve data (e.g., selected content, citation data, data indicative of the corresponding containers, etc.) on an as requested basis and may facilitate the exportation and sharing of data (e.g., containers, selected content, notes, citations, reports, etc.) across users (e.g., across user compute devices 110, 112). Some embodiments may enable collaborative real-time editing of such data as well.

While a relatively small number of devices 110, 112, 130, 132, 150 are shown in FIG. 1 for simplicity and clarity, it should be understood that the number of devices, in practice, may range in the tens, hundreds, thousands, or more. Likewise, it should be understood that the devices 110, 112, 130, 132, 150 may be distributed differently or perform different roles than the configuration shown in FIG. 1. Further, though shown as separate devices 110, 112, 130, 132, 150 in some embodiments, the functionality of one or more of the devices 110, 112, 130, 132, 150 may be combined into fewer devices and/or distributed across more devices than those shown in FIG. 1.

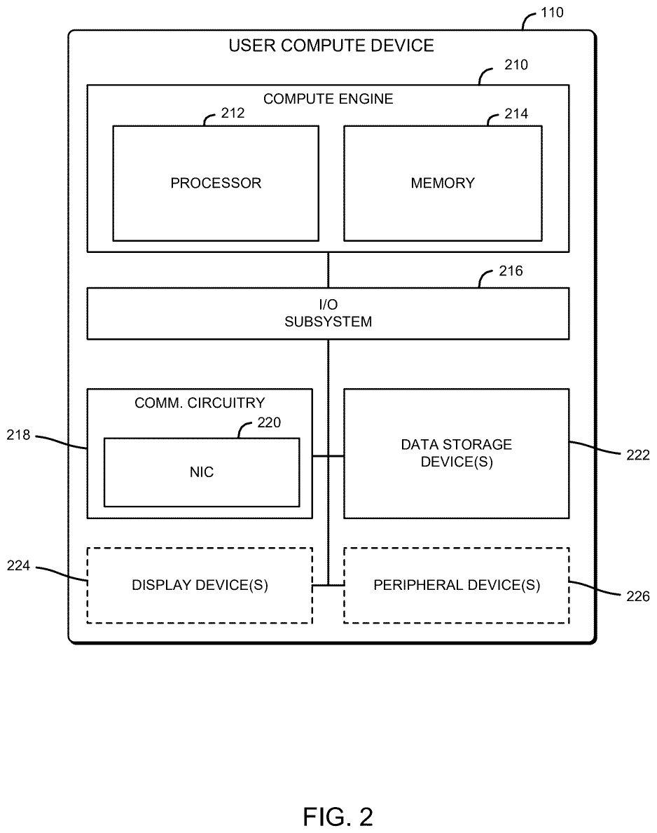

Referring now to FIG. 2, an illustrative embodiment of a user compute device 110, includes a compute engine 210, an input/output (I/O) subsystem 216, communication circuitry 218, and one or more data storage devices 222. In some embodiments, the user compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as at least one processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), one or more graphics processing units (GPUs), neural processing units (NPUs), and/or floating point units (FPUs), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the user compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as content items, selected content, citations, notes, containers, applications, libraries, and drivers.

The compute engine 210 is communicatively coupled to other components of the user compute device 110 via the I/O subsystem 216, which may be embodied as circuitry and/or components to facilitate input/output operations with the compute engine 210 (e.g., with the processor 212 and the main memory 214) and other components of the user compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the user compute device 110, into the compute engine 210.

The communication circuitry 218 may be embodied as any communication circuit, device, or collection thereof, capable of enabling communications over a network between the user compute device 110 and another device (e.g., a device 112, 130, 132, 150, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the user compute device 110 to connect with another device (e.g., a device 112, 130, 132, 150, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the user compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the user compute device 110 are housed in a single unit. However, in other embodiments, the components may be in separate housings. The other devices 112, 130, 132, 150 may include components similar to those of the user compute device 110. Further, the devices 112, 130, 132, 150 may include other components, sub-components, and devices commonly found in a computing device, which are not discussed above in reference to the user compute device 110 and not discussed herein for clarity of the description.

In the illustrative embodiment, the devices 110, 112, 130, 132, 150 are in communication via the network 160, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

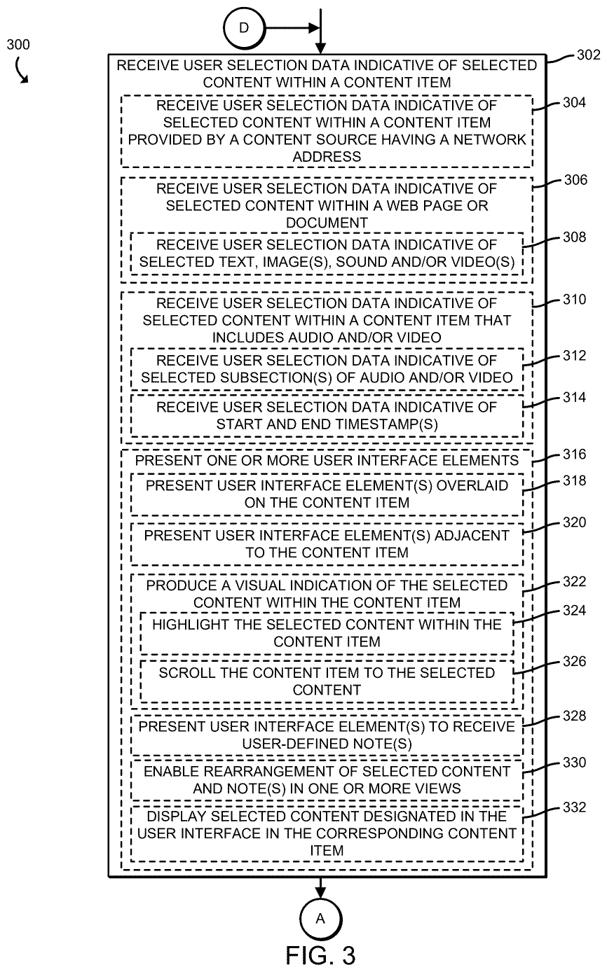

Referring now to FIG. 3, in operation, the system 100 (e.g., a user compute device 110) may perform a method 300 for collecting, classifying and annotating content from an original source to a final document (e.g., a report). The method 300, in the illustrative embodiment, begins in block 302 in which the user compute device 110 receives user selection data (e.g., provided via a mouse or other input device (e.g., a peripheral device 226)) indicative of selected content within a content item. For example. The user compute device 110 may detect that the user has selected a starting point within a content item (e.g., displayed by the compute device 110, such as in a web browser or other application 120) and selecting an ending point within the content item (e.g., by clicking a button on the mouse at the starting point, dragging the mouse, and releasing the button at the ending point). In other embodiments, the user compute device 110 may obtain user selection data entered through a touch screen (e.g., via the display device 224) or through another mechanism. As indicated in block 304, the user compute device 110 may receive user selection data indicative of selected content within a content item provided by a content source (e.g., a content source compute device 130, 132) having a network address (e.g., an internet protocol (IP) address, a uniform resource locator (URL), etc.).

As indicated in block 306, the user compute device 110 may receive user selection data indicative of selected content within a web page (e.g., a file comprising hypertext markup language (HTML), JavaScript, image file(s), sound or video file(s) and/or other content renderable by a web browser rendering engine (e.g., WebKit, Blink, Trident, Gecko, etc.)) or document (e.g., a portable document format (PDF) file, a Word document, a plain text document, etc.). As indicated in block 308, the user compute device 110 may receive user selection data indicative of selected text and/or image(s), sound and/or video(s) within the content item. In some embodiments, the user compute device 110 may receive user selection data indicative of selected content within a content item that includes audio and/or video, as indicated in block 310. In receiving user selection data for such a content item, the user compute device 110 may receive user selection data indicative of one or more selected subsections (e.g., clips) of audio and/or video from the content item, as indicated in block 312. The user compute device 110 may receive user selection data indicative of start and end timestamps (e.g., each embodied as any data indicative of a time, such as a number of hours, minutes, and seconds from the beginning of the content item), as indicated in block 314.

As indicated in block 316, the user compute device 110 presents user interface element(s) in connection with the selection of content within the content item. In doing so, and as indicated in block 318, the user compute device 110 may present one or more user interface elements (e.g., icon(s), button(s), etc.) overlaid on the content item (e.g., overlaid on a web page displayed by a web browser, from which the user selected a set of text or other content). In some embodiments, the user interface elements may enable the user to designate the selected content for subsequent operations according to the method 300 (e.g., for annotation, including highlighting, adding a note, etc., as described in more detail herein). In some embodiments, the user compute device 110 may present one or more user interface elements adjacent to the content item (e.g., in a panel next to a display of the content item, such as in a panel of a web browser or other application 120 in which the content item is presented), as indicated in block 320. The user compute device 110 may produce a visual indication of the selected content within the content item (e.g., a visual indication acknowledging that the content has been selected), as indicated in block 322. For example, and as indicated in block 324, the user compute device 110 may highlight the selected content within the content item (e.g., visually demarcating the selected content in a different color than the surrounding content). In some embodiments, the user compute device 110 may display a button or other user interface element in response to detecting that the use has selected content within a content item. In response to detecting that the user selected the button or other user interface element, the user compute device 110 may highlight the selected content. In other embodiments, the user compute device 110 may present a button (e.g., in a user interface above the content item or in a side panel (e.g., adjacent to the content item)) to enable the user to toggle a highlight mode. When the highlight mode is activated, the user compute device 110 may highlight any selected content within the content item (e.g., without requiring the user to select a separate button or user interface element to enable highlighting of the selected content). As indicated in block 326, the user compute device 110 may be configured to scroll (e.g., adjust a view of) the content item to any selected content (e.g., to focus a view of the content item on the selected content, such as by positioning the content item within a viewing window (e.g., of a web browser or other application 120) such that the selected content is in a center of, or at least within, the viewing window). In some embodiments, this “scroll to content” feature is activated when the user clicks on the source attached to the module/content (highlight) saved on that source. Accordingly, when the user wishes to navigate to the source linked to a content saved by the user, the view will automatically scroll to that content. The feature, in at least some embodiments, could be toggled off and/or have different buttons on the source or module that allow to toggle the scroll or not.

In some embodiments, as indicated in block 328, the user compute device 110 may present one or more user interface elements to receive user-defined note(s) (e.g., text) regarding the content item or specific selected content within the content item. For example, the user compute device 110 may present a button or icon that, when activated (e.g., by a mouse click or keyboard shortcut), presents a text field in which a user may enter one or more notes associated with the content item or specific selected content within the content item. The user compute device 110 may enable rearrangement of selected content and/or notes in one or more views that represent the selected content and/or notes, as indicated in block 330. That is, the selected content and/or notes may appear in an initial order (e.g., sorted according to particular characteristics, such as date of creation) in a view (e.g., a user interface) and may be rearranged (e.g., based on user input), such as through sorting by different characteristics and/or manual repositioning (e.g., dragging and dropping the selected content and/or notes to move them relative to each other) within a view. Example embodiments of views are described in more detail herein. As indicated in block 332, the user compute device 110 may display selected content designated in the user interface in the corresponding content item. That is, in response to user selection of selected content shown in the user interface (e.g., a set of text), the user compute device 110 may display the corresponding content item and adjust the view of the content item to display the particular selected content. Further, the user compute device 110 may highlight or otherwise visually indicate the selected content (e.g., selected in the user interface showing potentially multiple sets of selected content and/or notes) within the corresponding content item.

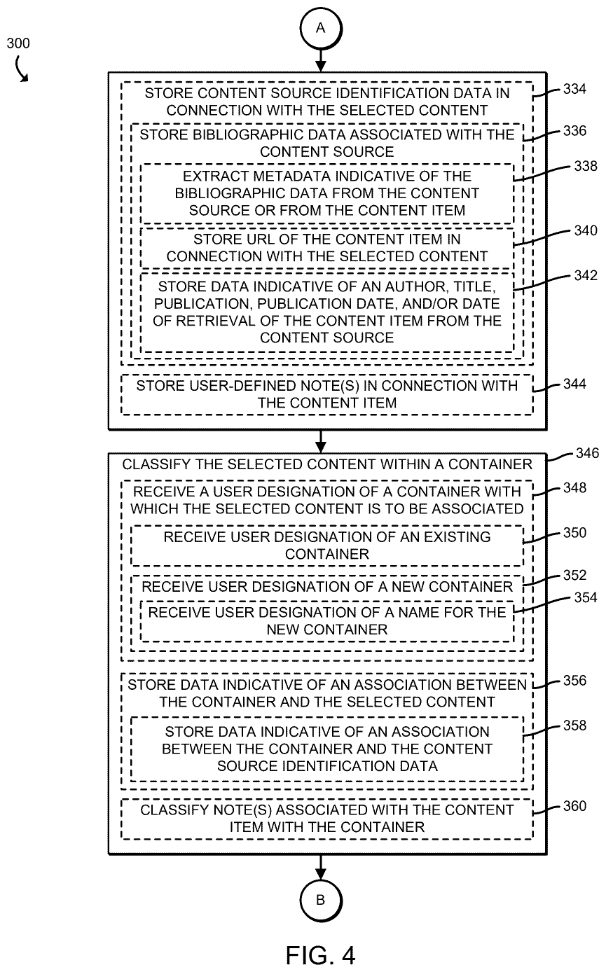

Referring now to FIG. 4, as indicated in block 334, the user compute device 110, in the illustrative embodiment, stores content source identification data (e.g., data indicative of the source of the content item) in connection with the selected content. In doing so, and as indicated in block 336, the user compute device 110 may store bibliographic data associated with the content source (e.g., data that appears in a citation according to one or more citation formats). In doing so, and as indicated in block 338, the user compute device 110 may extract metadata indicative of the bibliographic data from the content source (e.g., by requesting the data from the content source through one or more application programming interface (API) calls) or from the content item (e.g., by parsing data in a header section or other section of the content item, by performing optical character recognition on a rendering of the content item, etc.). Extraction of the data for use in a citation is described in more detail elsewhere herein. As indicated in block 340, the user compute device 110 may store a uniform resource locator (URL) of the content item in connection with the selected content. Further, and as indicated in block 342, the user compute device 110 may store data indicative of an author, title, publication (e.g., journal name), publication date, and/or date of retrieval of the content item from the content source (e.g., from a content source compute device 130, 132). In other embodiments, the user compute device 110 may store other additional or alternative data as the bibliographic data. Similarly, and as indicated in block 344, the user compute device 110 may store any user-defined notes (e.g., from block 328) in connection with the content item. In storing the data, the user compute device 110 may store the data locally (e.g., in data storage 222 of the user compute device 110) and/or may provide the data to another compute device (e.g., the server compute device 150), such as through one or more API calls for storage and subsequent retrieval.

In performing the storage operations, the user compute device 110, in the illustrative embodiment, stores data indicative of the location of the selected content in a content item. For a document or web page, in which the selected content is text, the user compute device 110 may store an index (e.g., a character count from the beginning of the content item) indicative of the starting point for a set of selected content and may store another index indicative of the ending point for the selected content. Additionally or alternatively, the user compute device 110 may store a prefix (e.g., a set of characters immediately before the selected content) and a suffix (e.g., a set of characters immediately after the selected content). The user compute device 110 may store the position of the selected content relative to the structure of the content item (e.g., a document object model (DOM), such as for a web page). For example, the user compute device 110 may store one or more parent HTML elements that the selected content (e.g., text) is in or spans across. In some embodiments, the user compute device 110 may store data associated with a range element in a DOM, which defines boundary points (e.g., start and end) for a portion of a content item (e.g., document). The range element may represent a part of the text (e.g., a word or sentence), a group of elements or nodes (e.g., <div>, <p>or <span>), or both text and elements simultaneously. The range may contain a start container and offset (e.g., the node where the range starts and the offset within that node) and an end container and offset (e.g., the node where the range ends and the offset within that node).

Continuing the method 300, in block 346, the user compute device 110 may classify the selected content within a container (e.g., a data structure, which may be represented as a folder, a trove, etc.). In doing so, the user compute device 110 may receive a user designation of a container with which the selected content is to be associated, as indicated in block 348. For example, the user compute device 110 may receive a user designation of an existing container (e.g., a container that was previously defined), as indicated in block 350. Conversely, the user compute device 110 may receive a user designation of a new container (e.g., a container that was not previously defined), as indicated in block 352. In doing so, the user compute device 110 may receive a user designation of a name for the new container, as indicated in block 354. Further, the user compute device 110 may receive a user defined description of the container and/or other properties of the container (e.g., an identifier of a project team or group associated with the container and/or one or more tags to be associated with the container). As indicated in block 356, the user compute device 110 stores data indicative of an association between the container and the selected content. Further, and as indicated in block 358, the user compute device 110, in the illustrative embodiment, stores data indicative of an association between the container and the content source identification data (e.g., from block 334) associated with the selected content. Similarly, and as indicated in block 360, the user compute device 110 may classify any notes (e.g., user-defined notes from blocks 328, 344 associated with a content item), by storing those note(s) in connection with a corresponding container (e.g., storing data indicative of an association between the note(s) and the container). In some embodiments, the user can take notes, similar to a typical text editor, anywhere in the trove (e.g., in the sidepanel) without being linked to a selected content on the source. However, that note will still be linked to the source URL and data if the user so desires. As discussed above, the user compute device 110 may store the data locally (e.g., in data storage 222 of the user compute device 110) and/or may provide the data to another compute device (e.g., the server compute device 150), such as through one or more API calls for storage and subsequent retrieval.

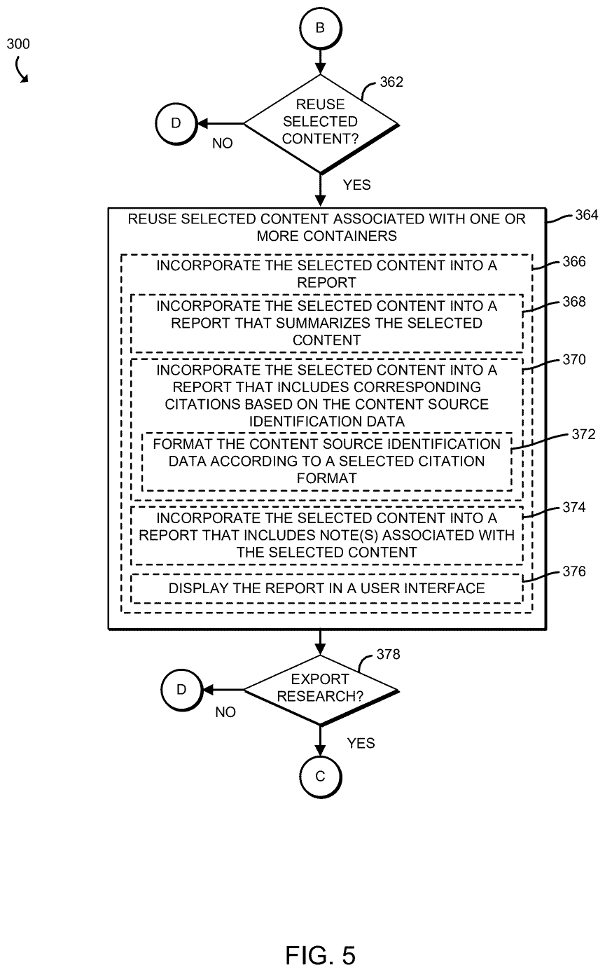

Referring now to FIG. 5, in block 362, the user compute device 110 determines the subsequent course of action based on whether the user has indicated (e.g., via interaction through a user interface) to reuse selected content (e.g., in a container). In response to a determination that the user has not indicated to do so, the method 300 may loop back to block 302 to potentially obtain data indicative of other selected content in a content item (e.g., to continue collecting snippets of text, images, audio, video, etc. from content items). However, in response to a determination that the user has indicated to reuse selected content, the method 300 advances to block 364, in which the user compute device 110 reuses selected content associated with one or more containers. In doing so, and as indicated in block 366, the user compute device 110 may incorporate the selected content into a report (e.g., a document or publication). The user compute device 110 may incorporate the selected content into a report that summarizes the selected content, as indicated in block 368. As indicated in block 370, the user compute device 110 may incorporate the selected content into a report that includes corresponding citations (e.g., for the selected content) based on the content source identification data (e.g., from block 334). As indicated in block 372, the user compute device 110 may format the content source identification data according to a selected citation format (e.g., selected by the user from a list of available formats). The user compute device 110 may incorporate the selected content into a report that includes any notes (e.g., user-defined notes, from blocks 328, 344) associated with the selected content, as indicated in block 374. The notes may be associated or not with the selected content, based on the preference of the user. As indicated in block 376, in the illustrative embodiment, the user compute device 110 displays the report in a user interface (e.g., for review and/or editing by the user).

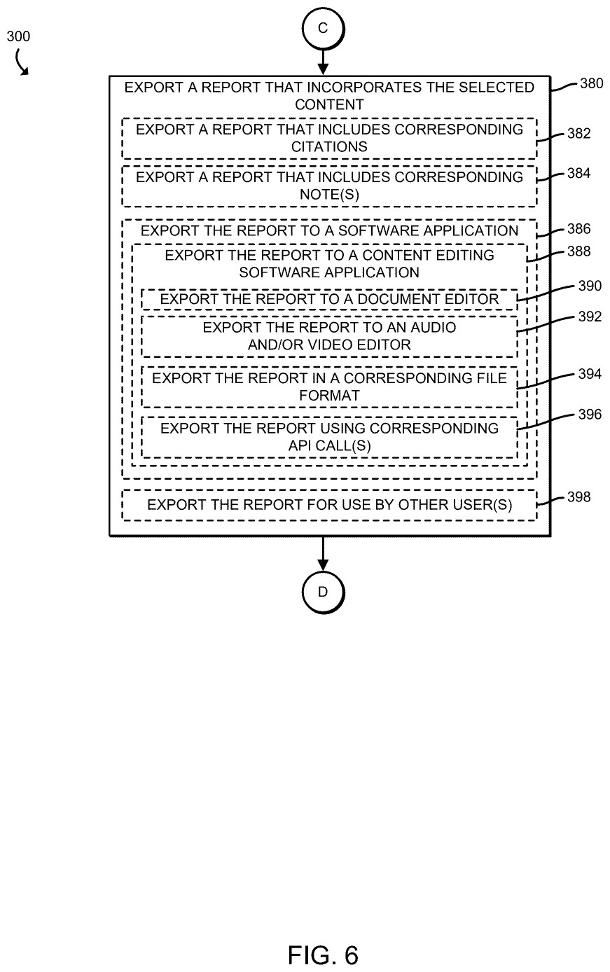

In block 378, the user compute device 110 determines the subsequent course of action based on whether the user has indicated to export the research (e.g., the items in one or more container(s), the report, etc.), such as through selection of a corresponding user interface element (e.g., a button, a menu item, etc.). In response to a determination that the user has not indicated to export the research, the method 300 may loop back to block 302 in which the user compute device 110 may continue to obtain selected content from one or more content items. However, in response to a determination to export the research, the method 300 advances to block 380 of FIG. 6, in which the user compute device 110 may export a report that incorporates the selected content (e.g., the report from block 366). In doing so, and as indicated in block 382, the user compute device 110 may export a report that includes corresponding citations (e.g., in the format selected by the user). As indicated in block 384, the user compute device 110 may export a report that includes any corresponding notes (e.g., user-defined notes, from blocks 328, 344). The notes may be associated or not with particular content, based on the preference of the user. The user compute device 110 may export the report to a software application (e.g., an application 120), as indicated in block 386. In doing so, and as indicated in block 388, the user compute device 110 may export the report to a content editing software application. For example, and as indicated in block 390, the user compute device 110 may export the report to a document editor (e.g., Microsoft Word). As indicated in block 392, the user compute device 110 may export the report to an audio and/or video editor software application. In exporting the report, the user compute device 110 may export (e.g., encode) the report in a corresponding file format (e.g., associated with the content editing software application, such as a .DOCX file for Microsoft Word, or a portable document format (PDF), etc.), as indicated in block 394. In other embodiments, the user compute device 110 may export the report to a spreadsheet (e.g., a Microsoft Excel spreadsheet) and/or whiteboard and citation managers (e.g. Zotero for sources view). The user compute device 110 may export the report using one or more API calls (e.g., to a software application 120 local to the user compute device 110 or to a software application executed by another compute device (e.g., the application server 150)), as indicated in block 396. The user compute device 110 may export the report for use by one or more other users, as indicated in block 398. That is, the user compute device 110 may send a file in which the report is encoded (e.g., a .DOCX, a .PDF file, etc.) and/or may send a link (e.g., a URL, to enable access to a remotely stored version of the file) to another user (e.g., to the user compute device 112) to enable review and/or editing of the report by the other user(s). In some embodiments, the user compute device 110 may send a notification to other users who have access to the container to notify them that another export/version of the trove has been created or updated. Subsequently, the method 300 may loop back to block 302 to obtain data indicative of other selected content and perform other operations of the method 300 described above.

Through the method 300 is described in a particular sequence for simplicity, it should be understood that the operations of the method 300 may be performed in a different order and/or concurrently. Further, multiple threads of the method 300 may be performed concurrently (e.g., in different instances of web browsers or other applications configured to enable the user compute device 110 to perform the operations of the method 300). Additionally, it should be understood that while the method 300 is described in connection with selection of content from a particular content item, as an illustrative example, in practice, the selection of content from content items may be performed many times over the course of multiple days, weeks, months, or other time period to form the contents of a corresponding container (e.g., folder, trove, etc.).

As an example scenario, for a scientific publication, a user may perform classic bibliographic research (e.g., Pubmed, etc.). In doing so, in connection with selection operations, the user may select the most relevant publications, highlight the most important paragraphs, and automatically link the origin of the content (e.g., journal name, title, and date of the article). Further, in connection with classification operations, the user may place the documents in a specific folder (e.g., container, trove, etc.) on the subject of future publications with classification of the excerpts. Additionally, in connection with the reuse operations, the user may write a new article with the integration of the excerpts from the publications, source for bibliography referencing in the text, using a bibliography format required by the publisher. Further, in connection with the export operations, the user may exchange the enriched article with a work team, then at the end of drafting, send the article to the journal's editorial board or to the publisher, for a book.

As another example, in connection with the selection operations, a user may research the most relevant law articles and case law decisions related to a case, highlight important passages, and link them to the original document. Further, the user, in connection with the classification operations, may classify, in a container (e.g., a folder, a trove) for the case, excepts according to the drafting of conclusions, with source links. Additionally, in connection with the reuse operations, the user may draft the conclusions with the integration of automatically generated case law citations. Further, in connection with the export operations, the user may export and share the draft with other lawyers for exchange before finalizing the text, then export the validated conclusions to a court (e.g., for review by a judge).

Another example pertains to an apartment search. In the example, in connection with the selection operations, a user may search for an apartment in a given geographic area, on real estate agency websites or private websites. The user may highlight key points in text documents and select virtual tour videos with source links. Further, in connection with the classification operations, the user may classify selected apartments with key points based on search criteria, while retaining links to the corresponding source(s). Further, in connection with the reuse operations, the user may classify the apartments (e.g., selected content associated with the apartments) according to prioritization criteria (e.g., price, location, area, etc.). Additionally, in connection with the export operations, the user may prepare a document for organizing visits and share the document with different family members.

The following description pertains to example embodiments in which a user compute device 110 is configured with an annotation capable web browser (e.g., an application 120) that supports the operations outlined in the method 300 of FIGS. 3-6. In the following description, the term “trove” corresponds with a “container” in the description of the method 300 above.

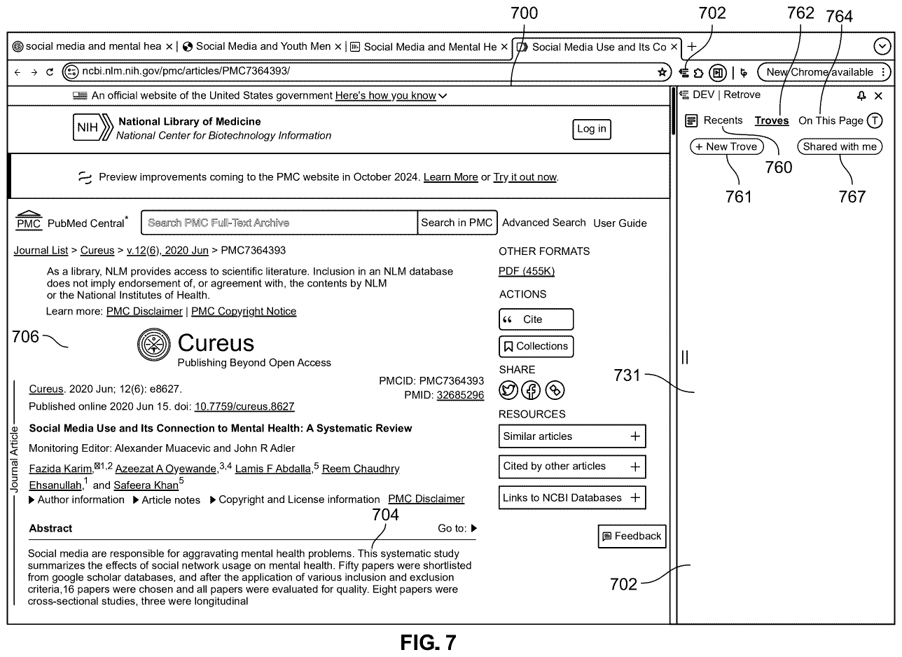

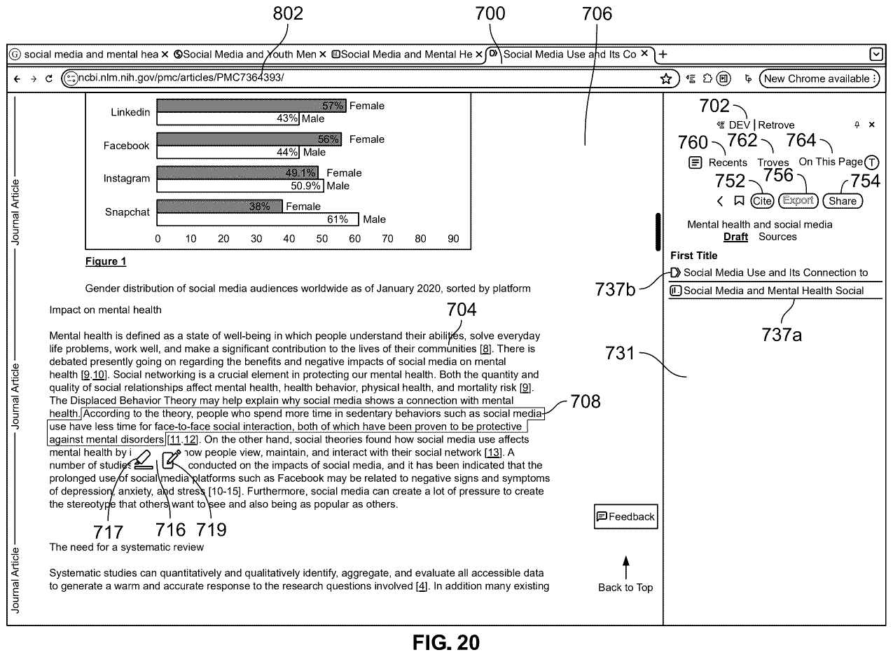

In FIG. 7 is an exemplary embodiment of an annotation capable web browser 700 (such as Chrome, Firefox, Safari or other browser with a sufficiently developed application program interface (API)) that supports an addition of a web browser extension 702 that includes annotation capabilities. The annotation capable web browser 700 includes a document or information resource that includes ordinary text 704 in a viewing area 706 however in other embodiments the ordinary text 704 and/or the viewing area 706 may be configured differently. The web browser 700 supports the addition of web extensions and is modified with an exemplary example of the web browser extension 702 that adds annotation capabilities to the web page of the web browser 700. The web browser extension 702 is a software package typically residing on a non-transitory computer readable medium that can be loaded into memory by the web browser 700, supporting the addition of web extensions, wherein the web browser application itself is a software application loaded in memory and running on a processor of an electronic computing device (e.g., a user compute device 110). Once the web browser application loads the web browser extension 702 into memory, the web browser extension 702 instruction set can be triggered by the user or may occur automatically. Some of the effects of the web browser extension 702 instruction set on the user interface presented to a user are shown in exemplary embodiment in FIG. 20.

Turning to FIG. 20, the web browser 700 includes a highlighted text, image, audio or video 708 (e.g., the “selected content” described relative to the method 300 and also collectively referred to in the following description as “highlighted text” hereafter for readability) on the document or information resource after a user selects text from the ordinary text 704. Throughout the application, the term “highlighting” is used however highlighting is simply an indication of selected or designated text, image, sound, or video that is of interest from the remaining content on the web page or document (e.g., content item).

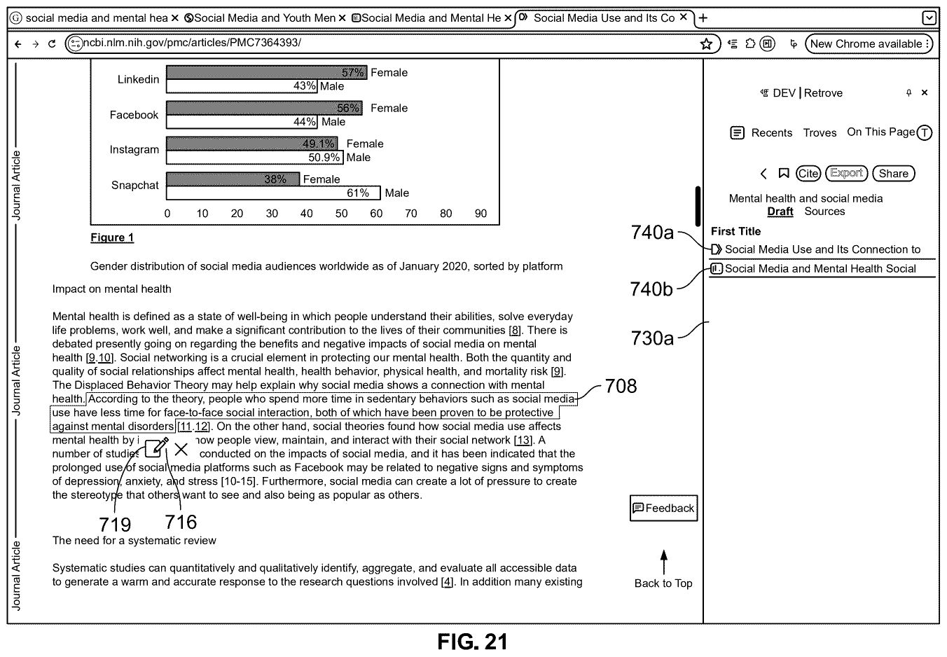

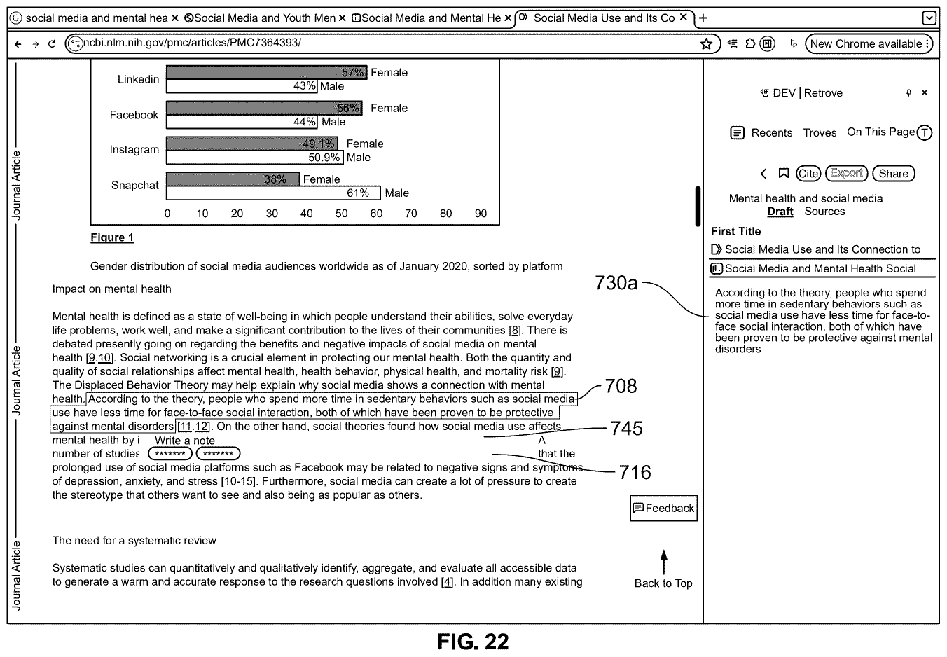

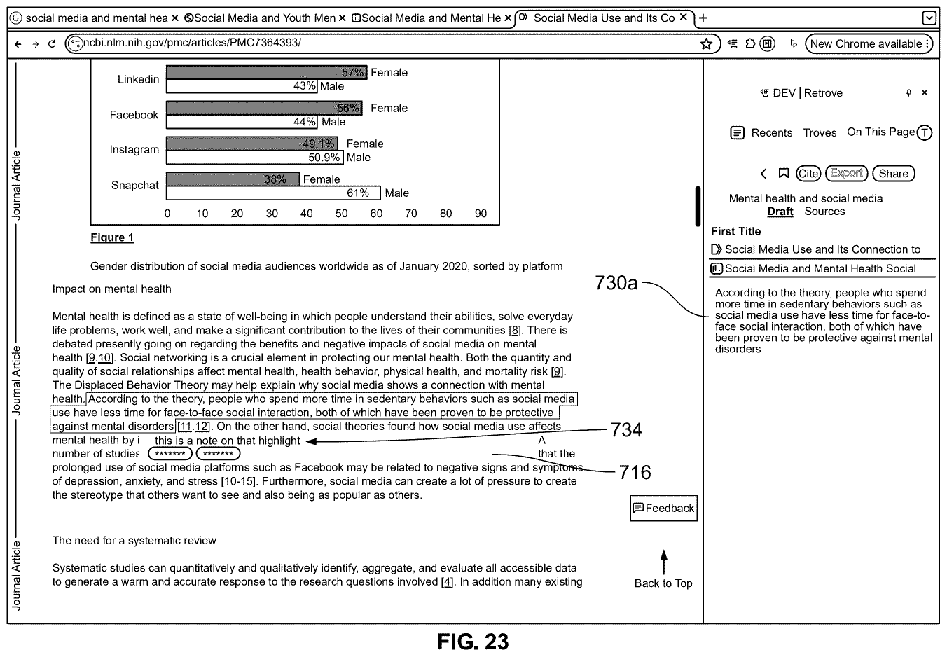

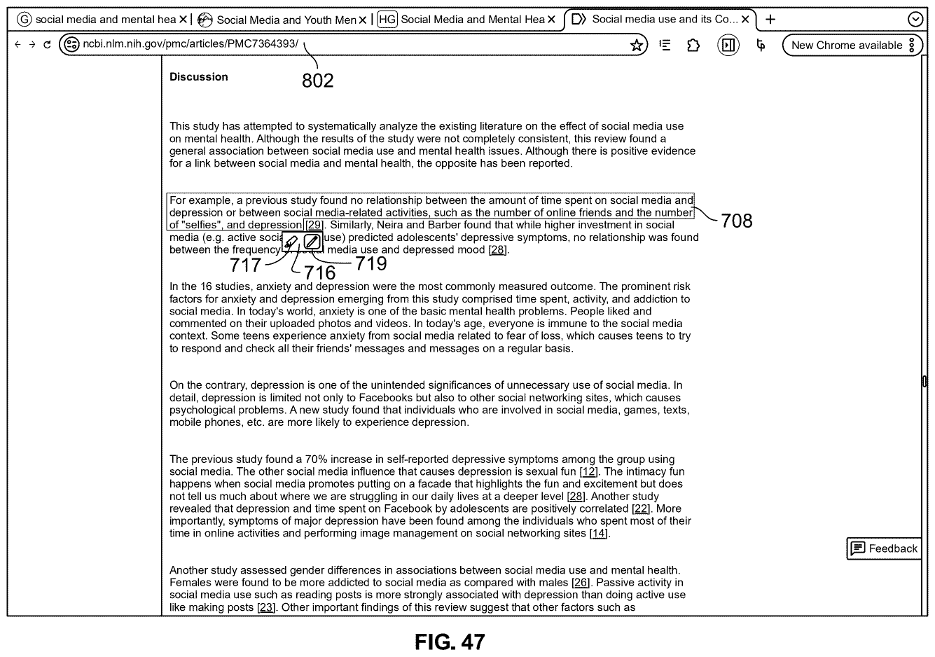

The web browser extension 702 simplifies the way businesses and individuals save and organize content found on sources that include websites, pdfs, videos, and audio files, add notes to the content, and automatically save the source, metadata, or URL of the website or source and associate that with the corresponding note or content. Sources throughout the application will be referenced as source documents (the “content items” of the method 300) and include any document, video, file, and/or audio files that users can open in their web browser. When the user visits a website 802 at a later time, the highlighted text 708 will be displayed along with an annotation input box 716 and a highlight icon or an actual note text, as shown in FIGS. 21-23. If the actual note text is desired for display then the note text that was entered into the annotation input box 716 is displayed. Additionally, if the user visits the same website 802 at a later time and highlights additional text 708 while the web browser extension 702 is closed, then a new annotation input box 716 is displayed for the user to add a note or highlight as illustrated in FIGS. 47-49. That is, in at least some embodiments, the user can click on the highlights to add notes or highlight other parts of the content in the webpage. Users of the web browser extension 702 no longer need to copy and paste websites to keep track of these websites visited for research and later citation as the web browser extension 702 instruction set operates to track, save, and format the source or reference in the website in a desired citation format. The web browser extension 702 instruction set operates to annotate or highlight text in a web browser 700 and track the source associated with the annotated or highlighted text, image, video, sound or any medium found on a source. The web browser extension 702 instruction set works or operates to split a user's screen into two parts wherein the first part includes the user interface for the web browser 700 with the highlighted text or image, and the second part includes a user interface of a side panel or notepad 731 that allows students, businesses, researchers, or other users to save their quotes, images, videos, sounds, notes, annotations, and additional sources in the notepad without having to copy and paste anything.

After the user highlights text, image, sound, or video from the website 802 and accesses the web browser extension 702, the user can close the browser 700 for the website 802. The web browser extension 702 instruction set saves metadata from the website 802 in a link from which the user can access to visit the website at a later date and the web browser extension 702 operates to associate the link with the highlighted text in the notepad. When the user visits the website 802 at a later time, the highlighted text, image, sound or video will be displayed. The system may provide similar functionality for other content items (e.g., pdfs or other files) opened locally or from URL(s). The web browser extension 702 makes research simpler and more intuitive as users no longer have to remember to copy and paste any sources, track these sources, associate these sources with any material from the source and their notes and can instead rely on the web browser extension 702 to do so. The web browser extension 702 instruction set operates to enable a user to perform a keyword search, a semantic search, and/or voice detection of the user for searching and/or dictation or transcription of audio to text.

In FIG. 20, the web browser extension 702 forms a split screen with the web browser 700 and a separate context area, side panel, or notepad 731. On the left side there is a user interface for the web browser 700, other tab, document, or a PDF. On the right side is a user interface for the separate context area, side panel, or notepad 731 formed by the web browser extension 702 that also includes other features and organization tools as described below. In some implementations, the side panel 731 may be associated with a manually opened new browser tab. The separate context area 731 includes a recents tab 760, a trove tab 762, and a page tab 764 that are further described below. In some embodiments, the web browser extension 702 may also provide a files tab for uploaded pdfs or other attachments. In the files tab, the user may be presented with their uploaded files, such as documents (e.g., pdfs or the like) and/or other files (e.g., uploaded from a local drive or imported from a URL).

The web browser extension 702 is connected or linked to the website 802. The web browser extension 702 enables a user to drag and drop any content saved from the user interface of the side panel 731 onto the user interface of the website 802. The website 802 can be organized into different troves, pages or boards to save content and enable the user to organize the content and annotations. The website 802 is a repository and/or organization tool for content that the user deems important.

In FIG. 7, the annotation capable web browser 700 includes the document or information (e.g., content item) such as the ordinary text 704 in the viewing area 706 before the user selects any text (e.g., selected content) and after the web browser extension 702 instruction set was triggered. The web browser extension 702 instruction set operates to display a new trove tab 761, a recents tab 760, a trove tab 762, a page tab 764, and a shared with me tab 767 in the side panel 731. In some embodiments, the web browser extension 702 may also provide a files tab for uploaded pdfs or other attachments.

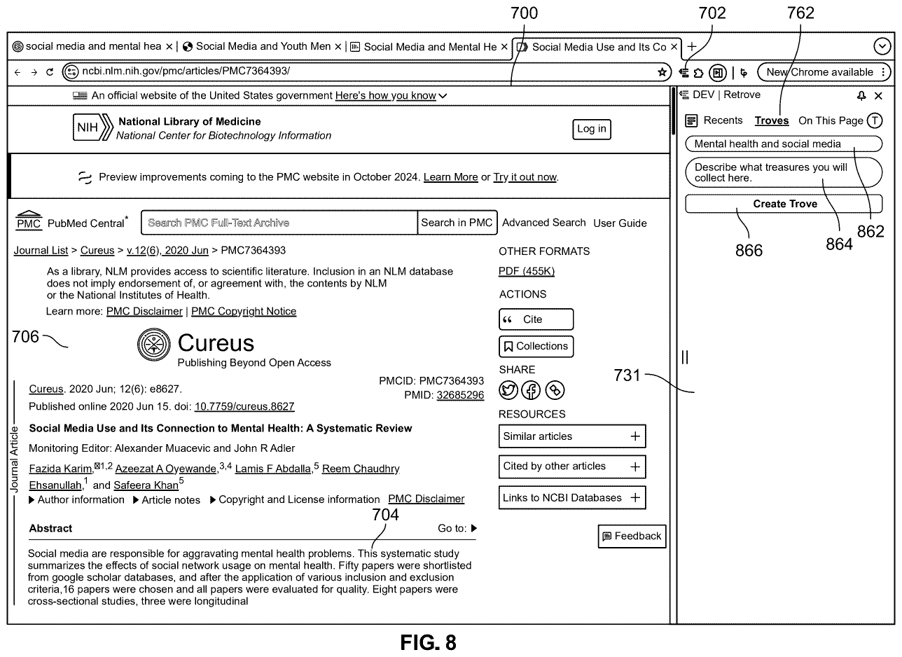

In FIG. 8, the user has selected the new trove tab 761 (from FIG. 7) and the web browser extension 702 instruction set operates to display a new trove 762 (e.g., a “container” in the method 300 described above) in the separate context area 731. The new trove 762 includes a title tab 862 for the user to enter a title of the new trove 762. The new trove 762 includes a description tab 864 for receiving text or other information by the user and a create a trove tab 866 for the user to click on to create a specific trove that includes the title from the title tab 862 and the description from the description tab 864 in the separate context area 731.

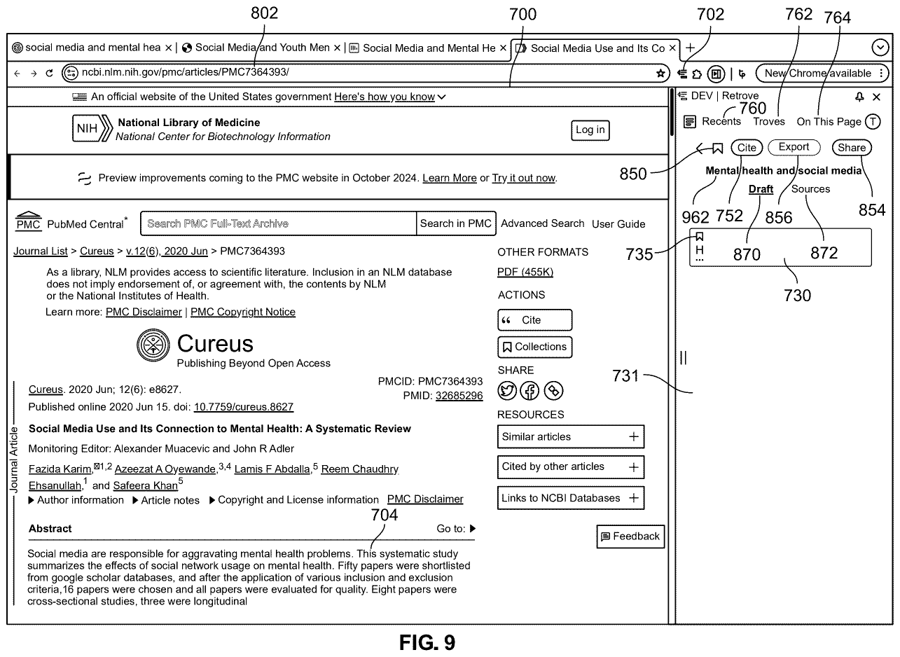

In FIG. 9, the user has selected the create a trove tab 866 and the web browser extension 702 instruction set operates to display a title 962 that corresponds to the title tab 862 in the separate context area 731. The web browser extension 702 instruction set defaults to display the recents tab 760, the trove tab 762, the page tab 764, an annotation item box module 730, a bookmark icon 850, a cite icon 752, a share icon 854, an export icon 856, a draft view 870, a source view 872, and a corresponding separate context area, side panel, or notepad 731.

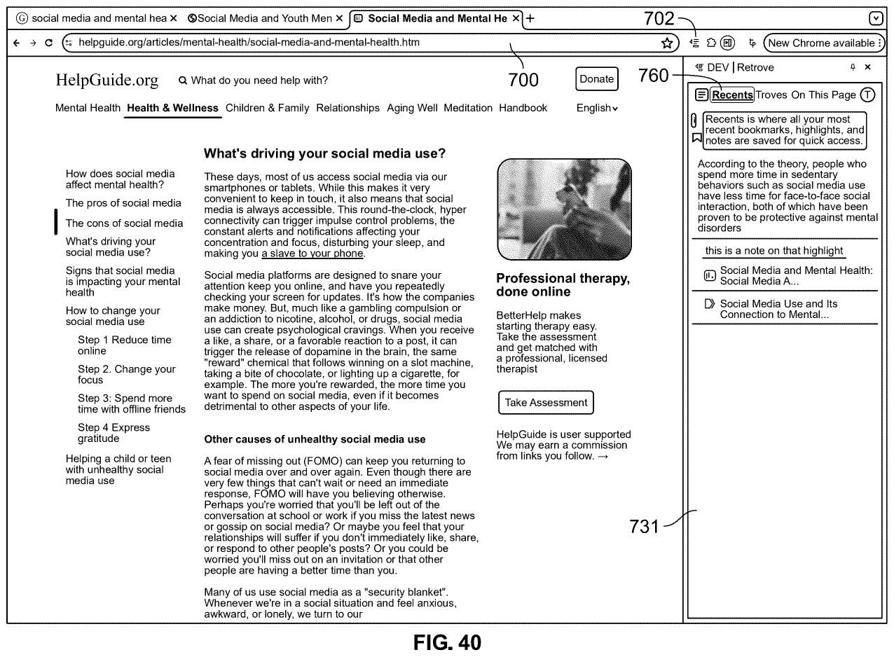

The web browser extension 702 instruction set operates to save quotes, notes, and sources from any web pages on web browsers 700 in one location that is the side panel 731 associated with the recents tab 760. The side panel 731 associated with the recents tab 760 organizes and saves content in the modules saved by the user in a reverse chronological order from all contexts. A user can select the recents tab 760 on the web browser extension 702 to view all of the saved modules in a reverse chronological order. The recents tab 760 is helpful when a user is unsure the order or use for the saved modules that include information, quotes, notes, and sources. Any content in modules saved by the user can be moved through drag and drop or other user interface actions to any other context the user has access to such as another side panel associated with another trove 762. Exemplary embodiments of the notepad 731 associated with the recents tab 760 are illustrated in FIGS. 40, 41, and 44.

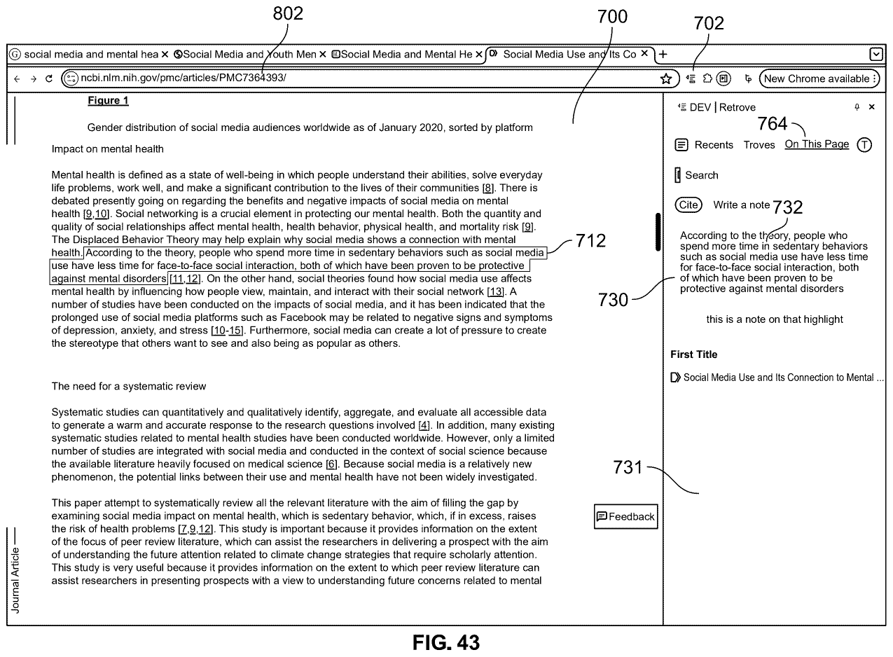

The web browser extension 702 instruction set operates to save all modules that have been saved on a specific tab from which the user has saved information in one location that is the side panel 731 associated with the page tab 764. An exemplary embodiment of the notepad 731 associated with the page tab 764 is illustrated in FIG. 43. When the user engages the page tab 764, then a separate context area, side panel, or notepad 731 is displayed wherein the context area allows the user to view quotes, notes, and sources saved on a specific or particular tab or document that is associated with a specific source such as the website 802. As the user continues to save content or adds note modules to the saved content then these modules are displayed in the notepad 731 that is associated with the page tab 764 for a single specific website 802 or the single specific source. The web browser extension 702 instruction set operates to add annotation capabilities to the web page 802 of the web browser 700. As such an annotation item box module 730 that contains separate annotation highlighted text or image 732 is displayed in the notepad 731. The annotation highlighted text or image 732 corresponds to and is the same as the annotation highlighted text or image 712 in the web page 712 associated with the web browser 700.

When the user engages the trove tab 762, the web browser extension 702 instruction set operates to display the side panel 731 wherein the user can organize sources, notes, annotations, highlights, and any other content or document collected from the web or uploaded by the user. The web browser extension 702 instruction set operates to create a single one of the side panel 731 that is associated with that specific trove tab 762. The side panel 731 for the specific trove is helpful when the user is working on a specific or single project, conducting research, outlining their thoughts, and writing a document. The web browser extension 702 instruction set operates to enable the user to add notes, highlights, comments, sources, or other information in annotation item box modules 730 to the side panel 731, automatically saves these modules 730, and enables the user to select the modules 730 and rearrange and nest modules 730 as desired within the specific side panel 731 associated with that specific trove. In some embodiments, a user may move or duplicate modules (through drag and drop or other user interactions) from one trove to another. The web browser extension 702 instruction set operates to enable the user to drag and drop sources, notes, annotations, and highlights in the annotation item box modules 730 within the side panel 731. Each piece of content can be dragged and dropped horizontally to nest content under other content or vertically to rearrange the order of the content in the annotation item box modules 730. In some embodiments, the user may desire to create a plurality of trove folders wherein each trove folder includes one of the side panels 731 that is created when the web browser extension 702 instruction set is executed. The plurality of trove folders can be accessed as desired by the user to enable the user to create and work in multiple projects wherein each of the trove folders corresponds to a specific project. In some embodiments, users may create troves within troves (nest containers inside each other) and reference (@) troves within troves. When the user engages the trove tab 762, the web browser extension 702 instruction set operates to display a list of troves, folders of troves and projects the user has access to (either created or has been shared with the user). The annotation item box modules 730 are any note, highlight, source or other module that is displayed in a trove once selected from the list showed on the troves tab 762.

In the illustrated embodiment, the side panel 731 for the trove can have any format as desired by the user. For example, the side panel 731 for the trove can include an outline format that includes a plurality of titles that can include text, audio, videos or images provided by the user. The plurality of titles can be collapsed or viewable for the user. In other embodiments, the side panel 731 for the specific trove does not have an outline format. The web browser extension 702 instruction set operates to display a plurality of annotation item box modules 730a-730c in the side panel 731 as described below. As such, the user can add an explanatory note, comment, or drawing in an annotation item box module 730d that is not linked to any of the annotation item box modules 730a-730c previously entered in the side panel 731. The web browser extension 702 instruction set operates to enable the user to drag and drop, rearrange, and nest the annotation item box modules 730a-730d as desired. The user can add additional text that is an explanatory note, comment, information, or drawing associated with any of the plurality of annotation item box modules 730a-730c such that this additional text in the annotation item box 730d is linked to another one of the annotation item boxes 730a-730c. The additional text can also potentially be generated using natural language processing techniques along with image captioning techniques.

In some embodiments, the web browser extension 702 instruction set operates to display a plurality of tags that are configured for the user to drag and drop onto any of the annotation item box modules 730 in the side panel 731. The plurality of tags are labels that can be dragged and dropped on any of the annotation item box modules 730. The plurality of tags can be added manually by the user or automatically by the web browser extension 702 instruction set such as with the aid of artificial intelligence (“AI”) on any of annotation item box modules 730. In some embodiments, the web browser extension 702 instruction set operates to filter and/or search through the plurality of tags and sort or filter the annotation item box modules 730 by the filter which can be any of the tags. Additional and/or alternative tags can be added to the plurality of tags as desired or the user can rename existing tags and change their colors. For example, one of the tags includes “to read” text to indicate that the user should review or read something. For example, another tag includes “important” text to indicate to the user that something is important or very relevant.

Other embodiments of the web browser extension 702 instruction set include AI recognition of the content in the side panel 731 including any of the annotation item box modules 730 to summarize content, provide comments, and/or sort content or information. The AI recognition of the web browser extension 702 can generate a document or draft of a final written output from this content which can be useful for a user to review and edit. This AI generated written output will automatically keep track and can show what the user generated such as user notes and what was original source content like highlights, images, or any other kind of content collected from the browser or documents. This allows users to give credit and cite automatically used sources or content while allowing the user to keep writing with their original thoughts. This avoids plagiarism and paraphrasing issues later on, while keeping track of copyright assignments to the content and knowing who has rights to it.

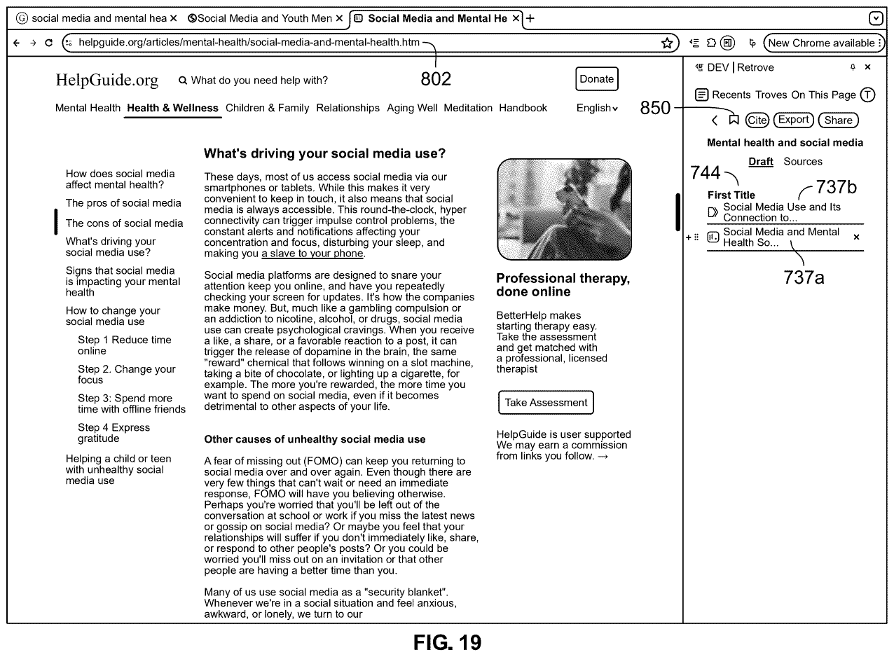

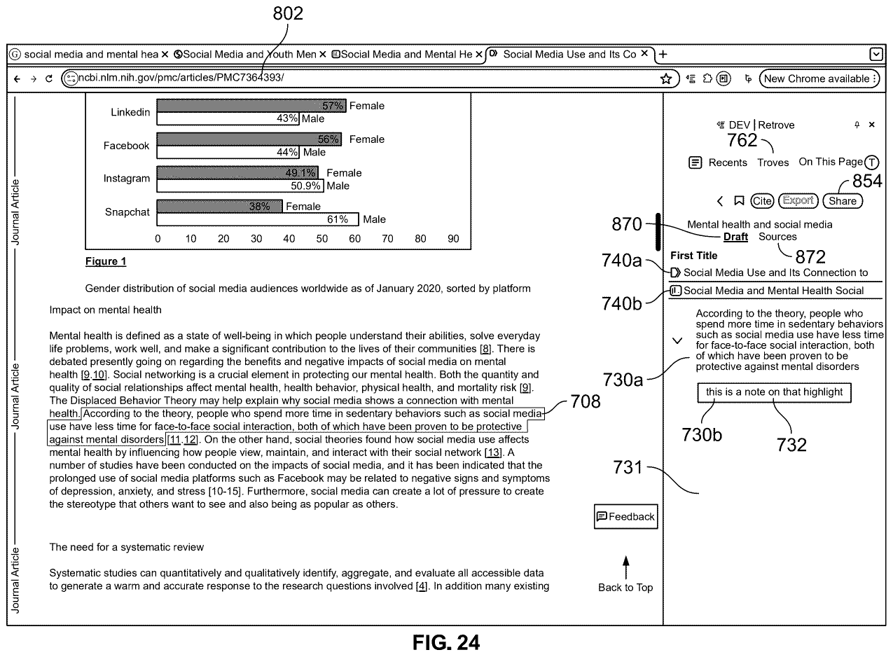

FIGS. 21-24 further illustrate the states of the annotation capable web browser 700 and the web browser extension 702 before and after an input annotation has been created or added in the annotation input box 716. After the user enters a separate input annotation 734 in the annotation input box 716, a bundle of data elements representing the input annotation, the annotation highlighted text, video, audio or image, the URL, and the metadata for the source, that can be a web page, pdf, document, video, audio file associated with the web browser 700 is sent to a server. This bundle of data elements can be used by the web browser extension 702 instruction set to construct an annotation item box module 730 in the separate context area, side panel, or notepad 731 as shown in the exemplary embodiment depicted in FIG. 24. The annotation item box module 730 contains a separate annotation highlighted text or image (or audio and/or video) 732 that corresponds to and is the same as the separate input annotation 734 in web page 802 associated with the web browser 700. The separate annotation highlighted text or image 732 enables the user to view the separate input annotation 734 without navigating to or viewing the annotation capable web browser 700. In one embodiment, the annotation item box module 730 also contains an embedded link that corresponds to the URL for the annotation capable web browser 700 and is intended to allow the user to click the embedded link and then visit or navigate to the web page of the web browser 700 on which the annotation resides and the location of the annotation highlighted text or image (or audio and/or video) 712 within the web page of the web browser 700. In at least some embodiments, the annotation capable web browser 700 may scroll directly to an annotation selected by a user. In the illustrated embodiment, the separate context area or notepad 731 includes one or more source modules 740a-740b as illustrated in FIG. 24, which may be explicitly saved by a user (e.g., by selecting a bookmark button (e.g., element 850 in FIG. 19)).

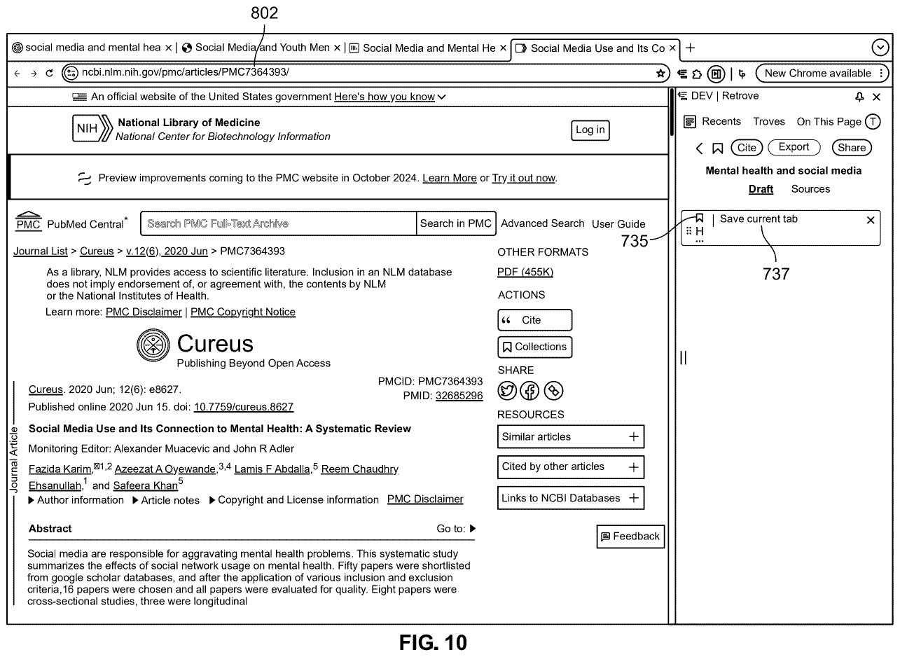

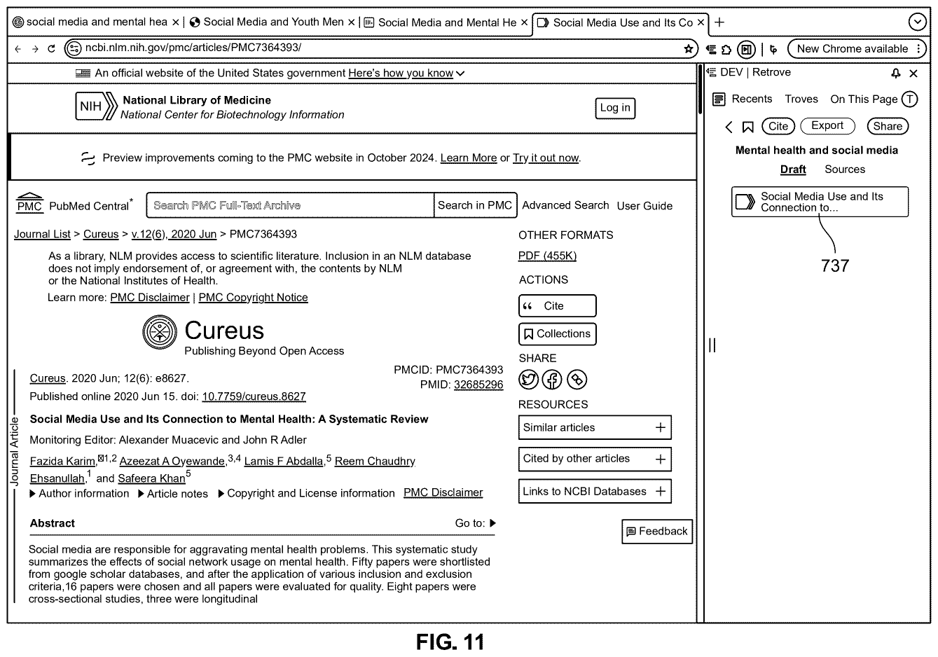

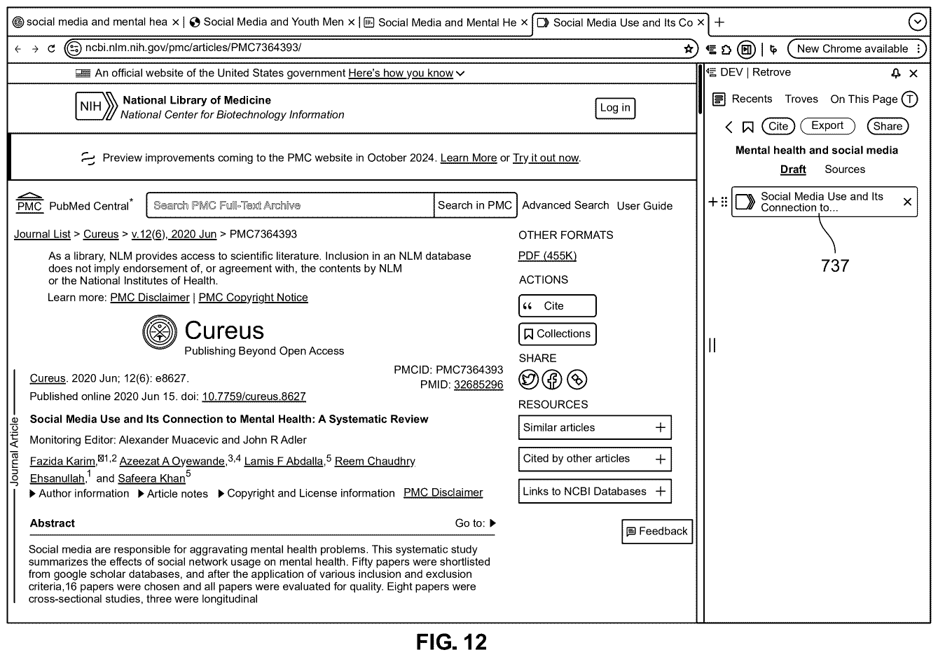

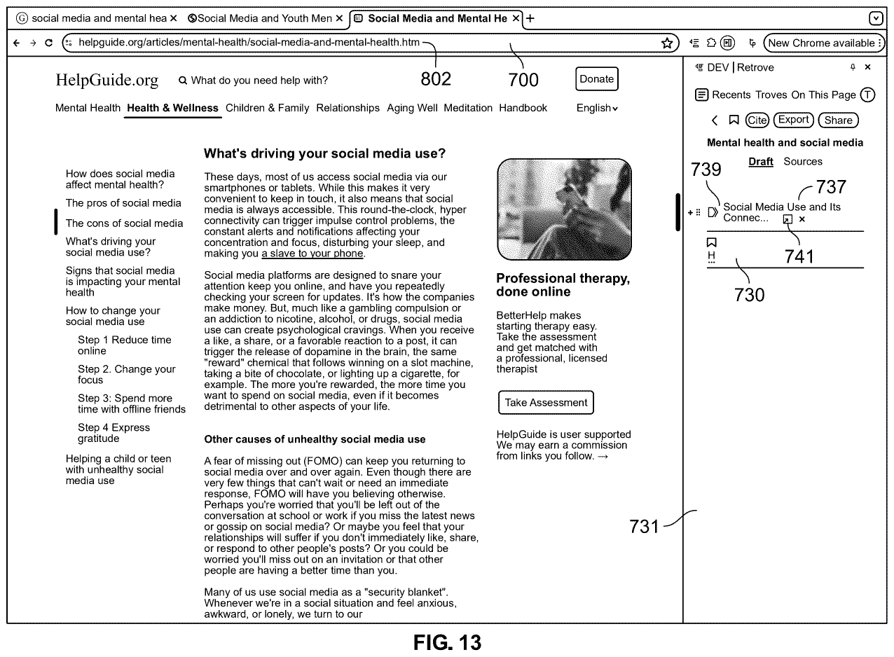

Returning to FIG. 9, after the web browser extension 702 instruction set was triggered the draft view 870 (a text editor view) is displayed that includes the annotation item box module 730 displayed in the separate context area, side panel, or notepad 731. The web browser extension 702 instruction set also displays a bookmark or source icon 735 associated with the annotation item box module 730 wherein the bookmark or source icon 735 that can be engaged or clicked on by a user as illustrated in FIG. 10. FIG. 10 displays a source module 737 that corresponds to the web page 802 of the web browser 700 as illustrated in FIG. 11. In FIG. 12, a user can optionally hover their cursor next to the source module 737 as illustrated. In FIG. 13, a user hovers their cursor on the source module 737 to cause the web browser extension 702 instruction set to display a redirect button 741.

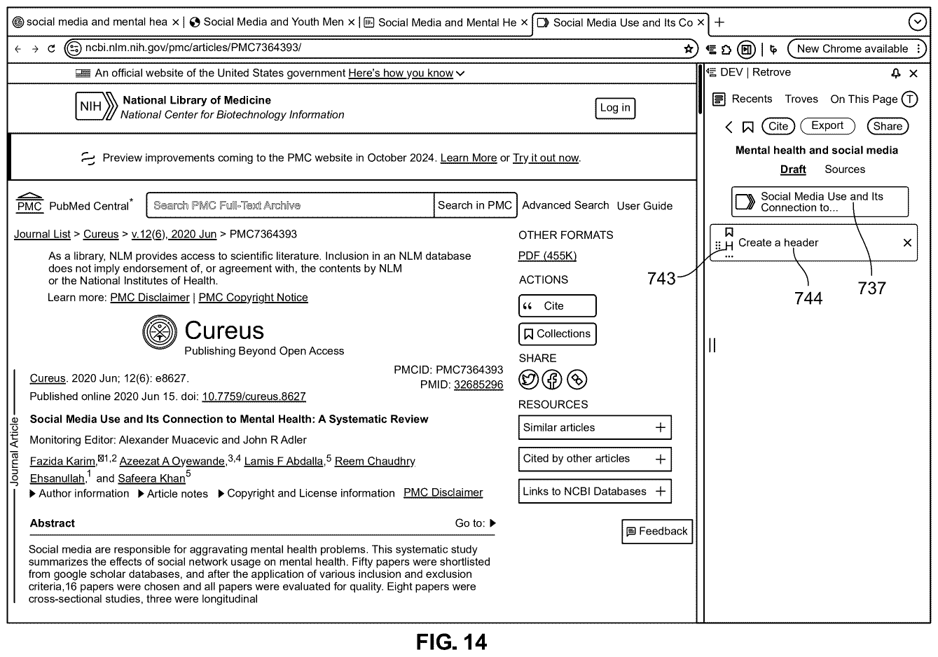

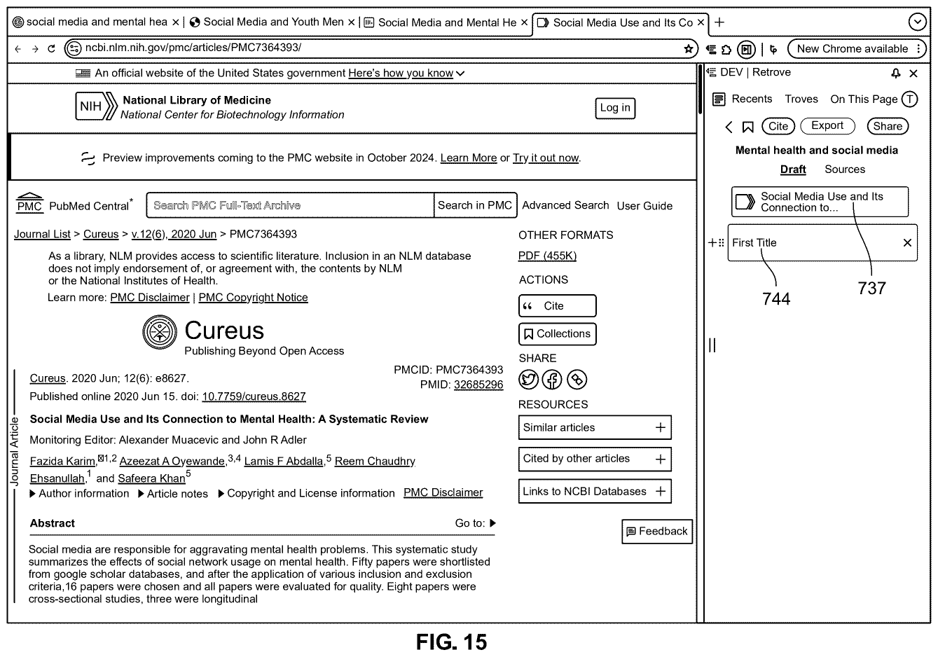

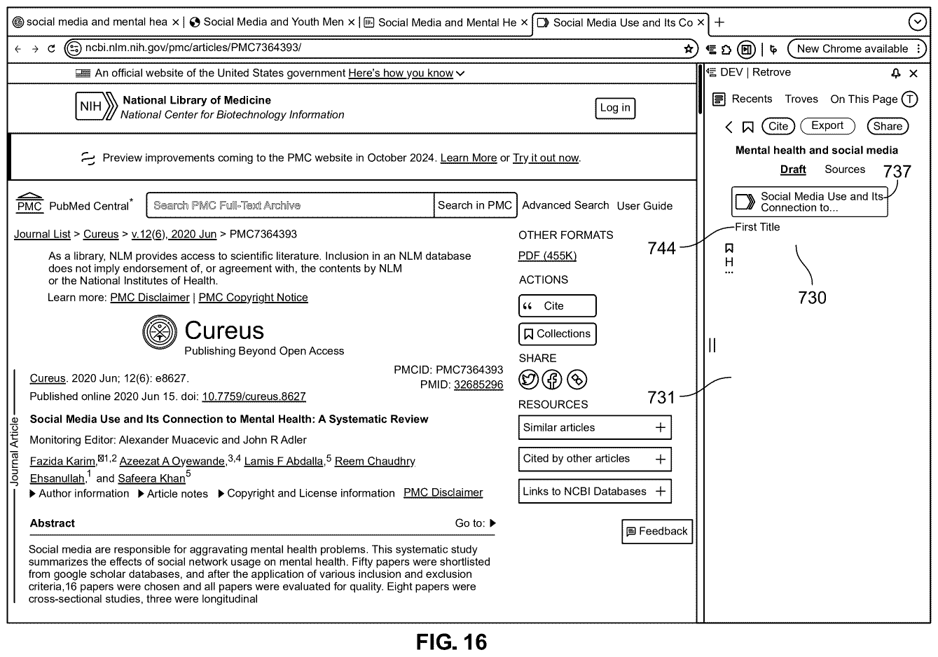

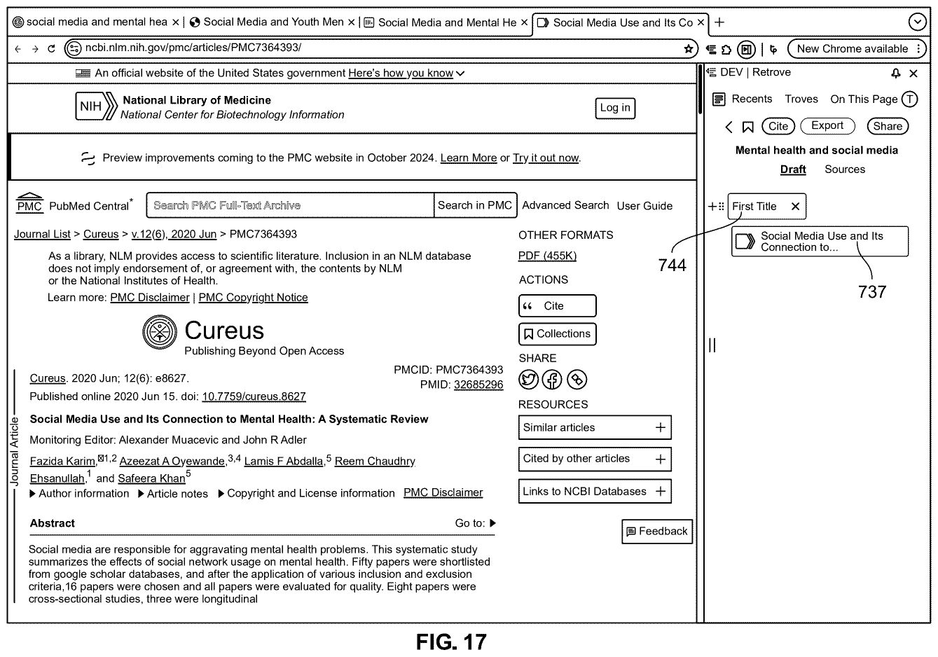

Turning to FIGS. 14-17, the web browser extension 702 instruction set also operates to display a header or title icon 744 such that a user can hover their cursor over the header or title icon 743 and a header or title module 744 is displayed. A user can then select or click on title icon 744 and type or enter a title or text in the title module 744. After the user has clicked enter to save the title in the title module 744 there is an annotation item box module 730 that is displayed in the notepad 731 in which the user can enter text. The web browser extension 702 instruction set operates to enable a user to drag and drop the title module 744 above the annotation item box module 730 as shown in FIG. 17.

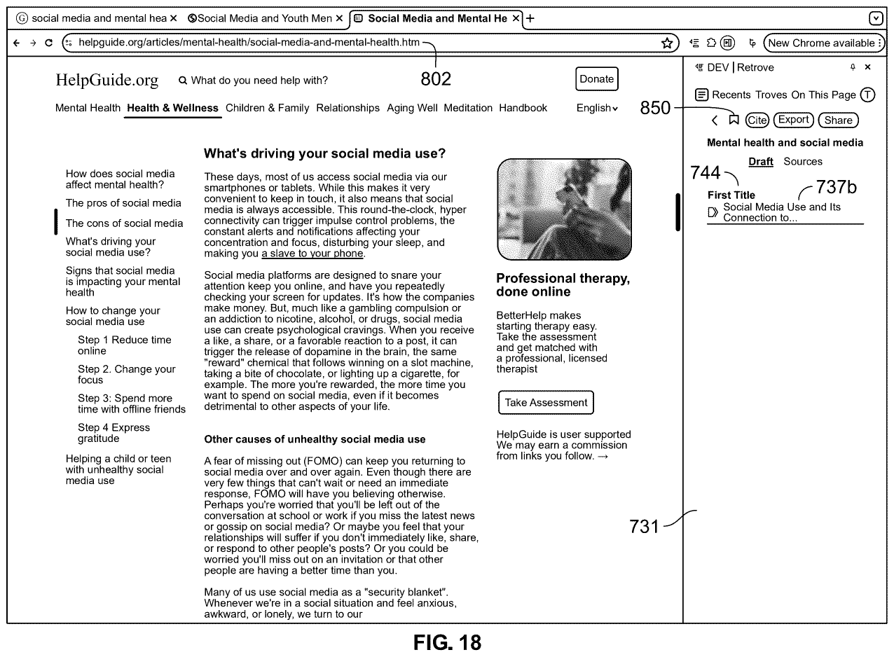

Turning now to FIGS. 18-26, the user has navigated to another tab or website 802 that was not previously visited. The web browser extension 702 instruction set also operates to enable the user to select or click the bookmark icon 850, then the web browser extension 702 instruction set operates to save the source 802 as another source module 737b wherein the previously saved source module 737b is also displayed. The user can select the text they want to highlight (selected content) 708 and this highlighted text 708 will be displayed along with the annotation input box 716 that includes a toolbar with a highlight button 717 or a note button 719 as illustrated in FIG. 20. If the user selects the highlight button 717, then the highlighted text 708 appears in the annotation item box module 730a in the notepad 731. If the user selects the note button 719, then the web browser extension 702 instruction set operates to display a note box 745 to receive the separate input annotation 734 or typed text from the user. After adding or entering the separate input annotation 734, then the web browser extension 702 instruction set also operates to display the annotation item box module 730b in the notepad 731 that now includes annotation highlighted text or image 732 that corresponds to the separate input annotation 734. In another embodiment, the user can click directly on the note icon, and that note will be added with the text selected as included in the source module metadata, and the rendering of the note on the webpage will be different than a highlight. In other embodiments, the web browser extension 702 instruction set also operates to display additional annotation item box modules 730b in the notepad 731 for the user to enter information as desired.

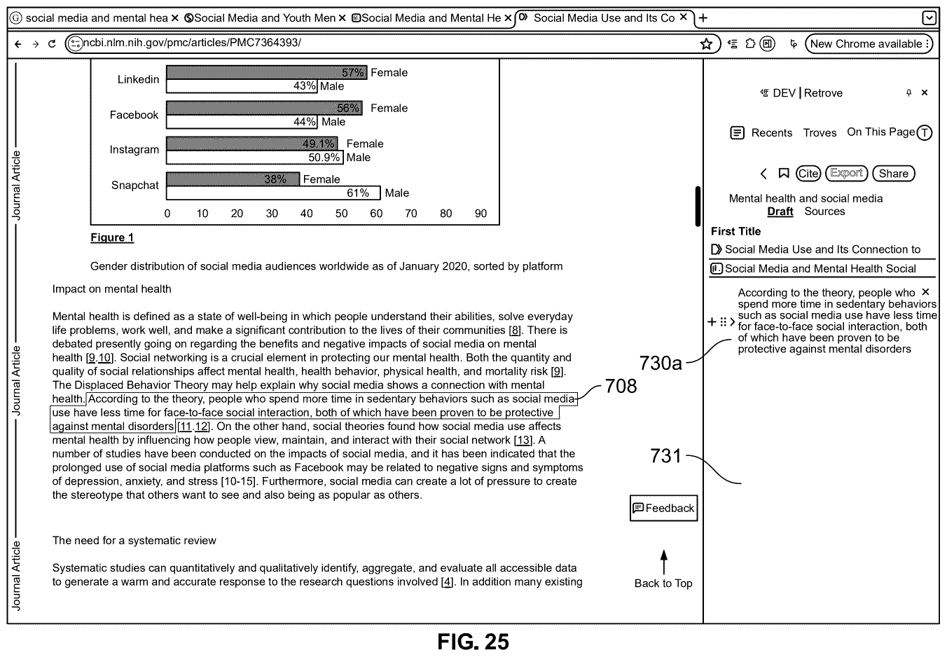

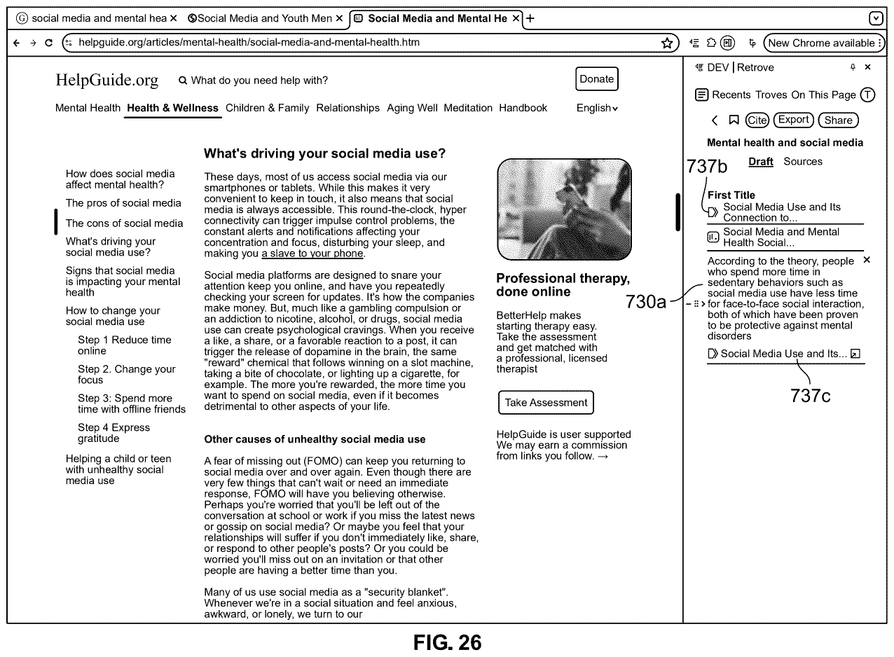

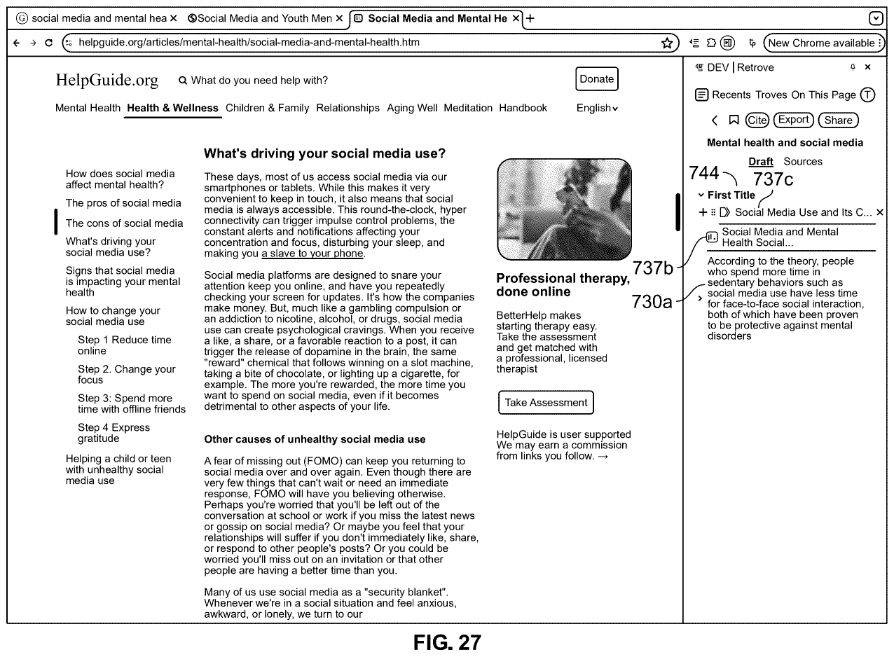

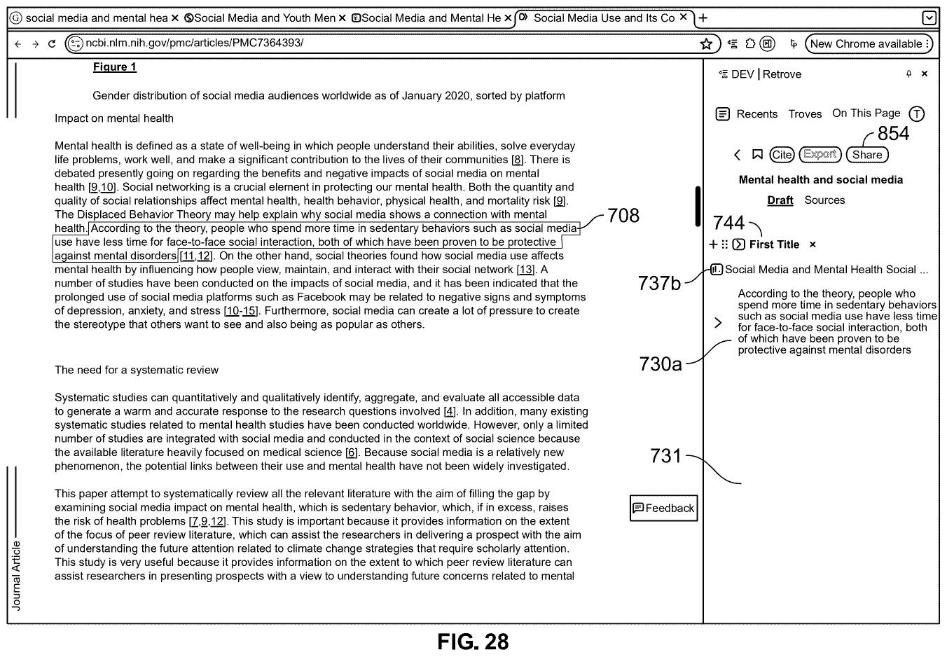

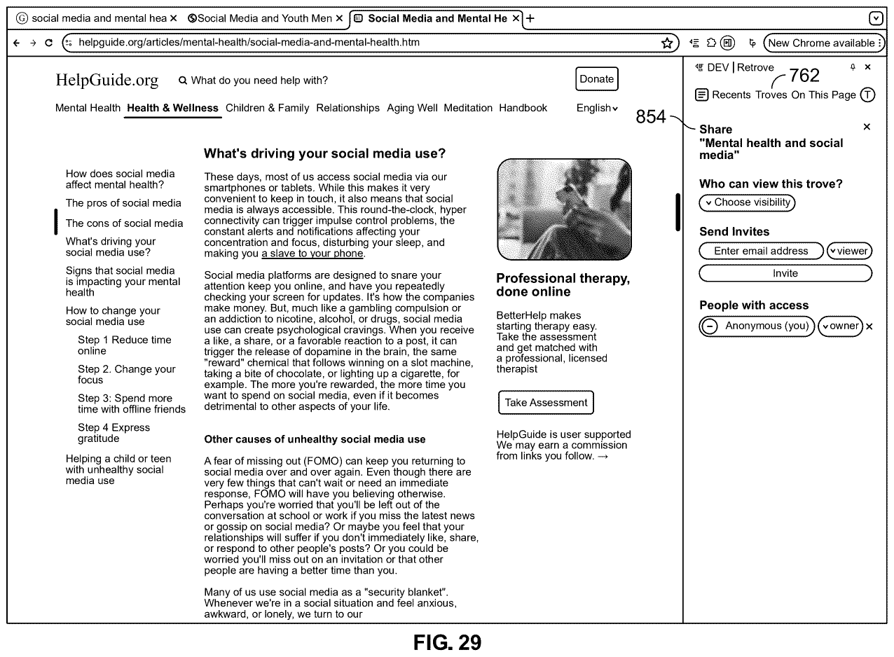

Turning now to FIG. 25, the web browser extension 702 instruction set also operates to enable the user to collapse the annotation item box module 730a that includes the highlighted or selected text 708 such that the annotation item box module 730b is not displayed. Turning now to FIG. 26, the user hovers their cursor over the highlight module 730a which causes the web browser extension 702 instruction set to operate and display the source module 737c. In FIG. 27, the user moves by dragging and dropping the source module 737c under the header or title module 744 to thereby nest the source module 737c under the title module 744. In FIG. 28, the user has selected the icon next to the title module 744 to thereby collapse or not display the contents under the title module 744. The user is able to move and/or nest the source modules 737b-c in any order under the title module 744. As additional source modules 737 and annotation item box modules 730 are added in the side panel 731, these can be re-arranged and nested as desired by the user in any order.

Turning now to FIG. 28, the user selects or clicks on the share button 854 which causes the web browser extension 702 instruction set to operate and display various options to share some of or all of the contents of the trove 762 in the notepad 731. For example, the web browser extension 702 instruction set operates to enable the user to select other certain users with certain viewing privileges of the contents of the trove 762. For example, the web browser extension 702 instruction set can operate to share by social media, text, or email all of or a portion of the contents of the separate context area or notepad 731, a link to the separate context area or notepad 731, and/or one or more URL's for corresponding websites. As another example, the web browser extension 702 instruction set operates to enable users to invite new users by email and/or restrict access to only invited users, or allow access to anyone with the link to the trove 762. As another example, the web browser extension 702 instruction set operates so that the user can share the annotated webpage (with notes and highlights rendering on it or on the side panel) or selected content. As another example, the web browser extension 702 instruction set operates so that the user can publish or share via the share icon 854 the trove 762 or annotated pages which will make the user content accessible in search results on other platforms or a community page on retrove to allow users to interact and share their research more globally.

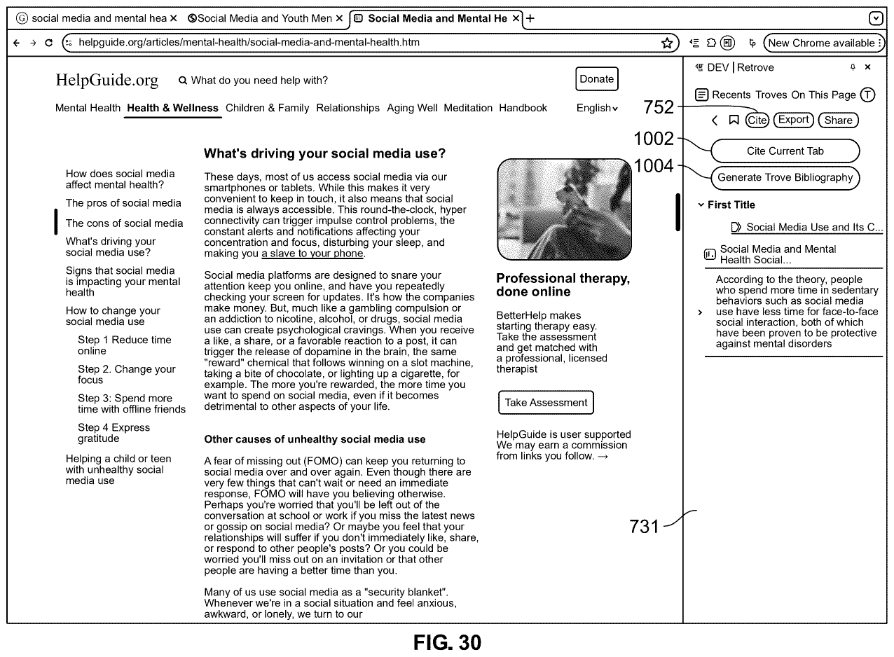

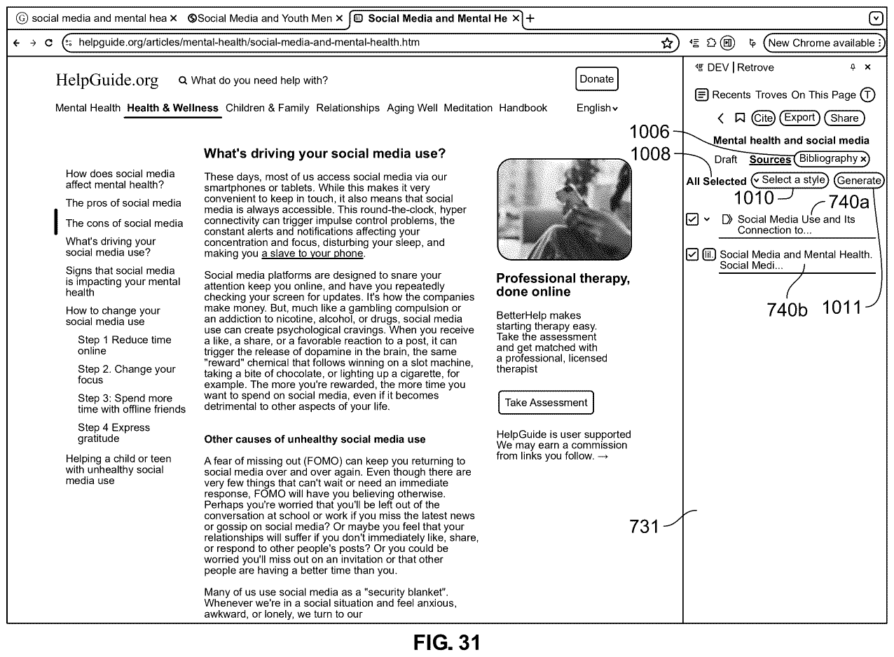

Turning now to FIG. 30, the user selects or clicks on the cite button 752 which causes the web browser extension 702 instruction set to operate and display a cite current tab icon 1002 and a generate trove bibliography icon 1004. When the user clicks on the cite current tab icon 1002, the web browser extension 702 instruction set operates to create a citation (e.g., for the presently displayed website on the left side of the screen) in a designated bibliographic format. The web browser extension 702 instruction set operates to fetch or retrieve details or metadata such as an author, date that the article was published, page number of article, an accessible link for a website, an article title, a retrieval date, a source URL, and any other information needed to create a citation in a format. In FIG. 31, after the user selected or clicked on the generate trove bibliography icon 1004, the web browser extension 702 instruction set operates to display a bibliography icon 1006, a select style drop down icon 1010, a generate bibliography icon 1011, and automatically defaults to selecting all of the source modules 740a, 740b.

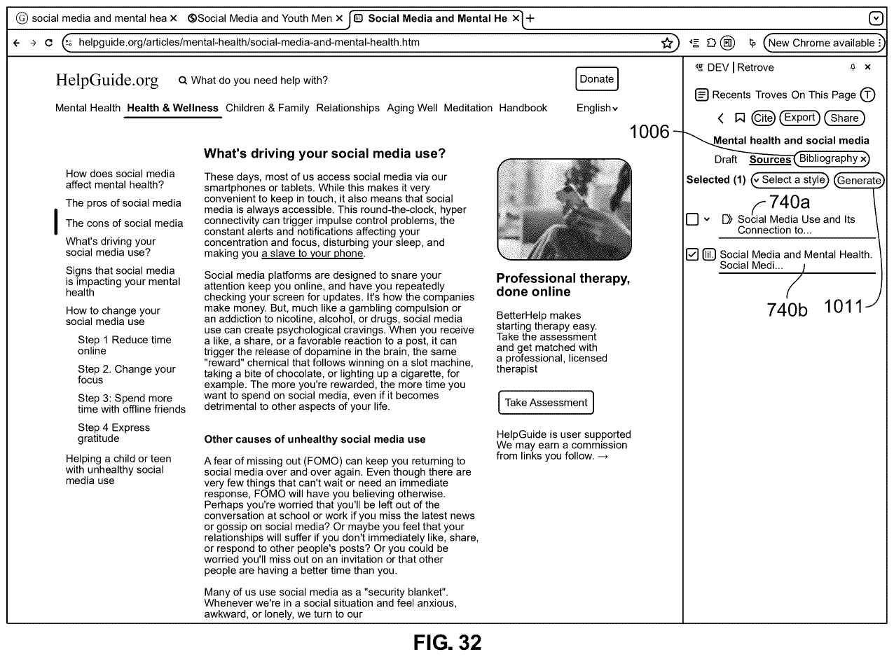

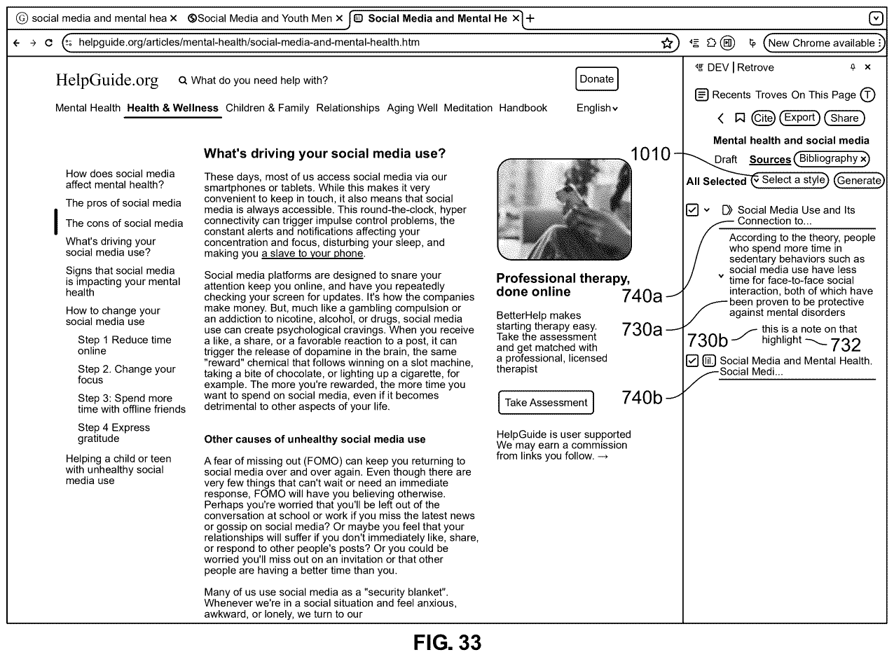

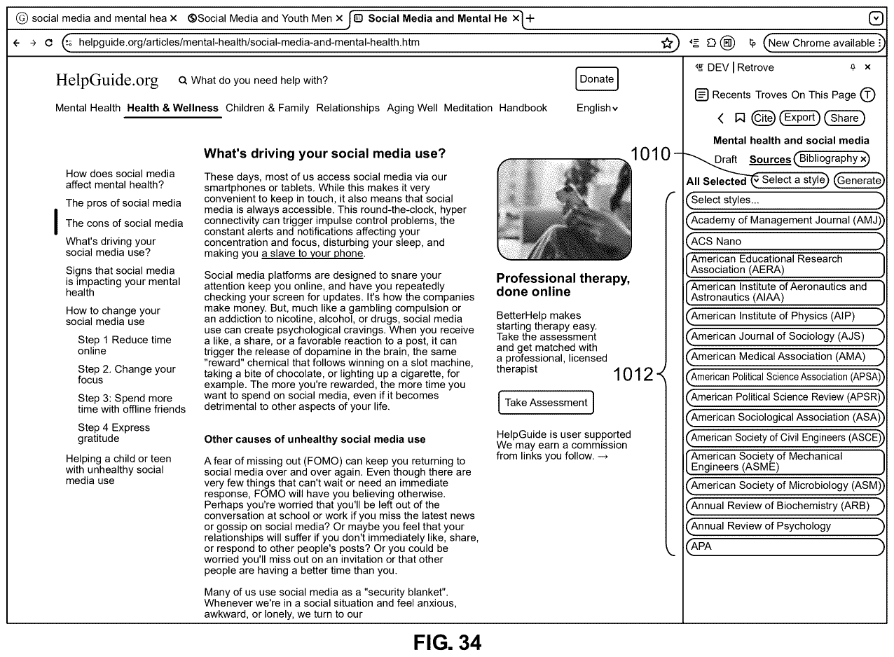

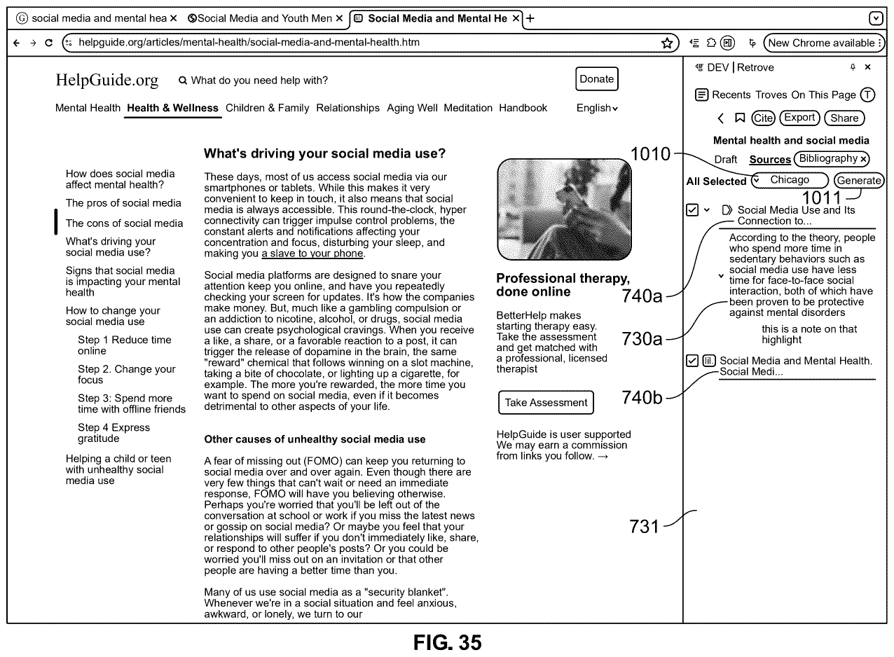

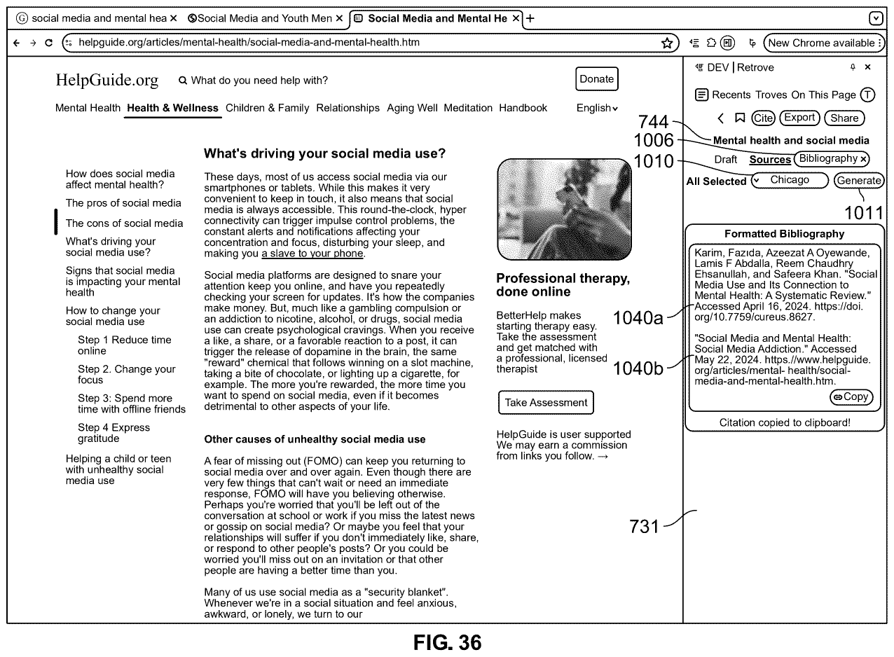

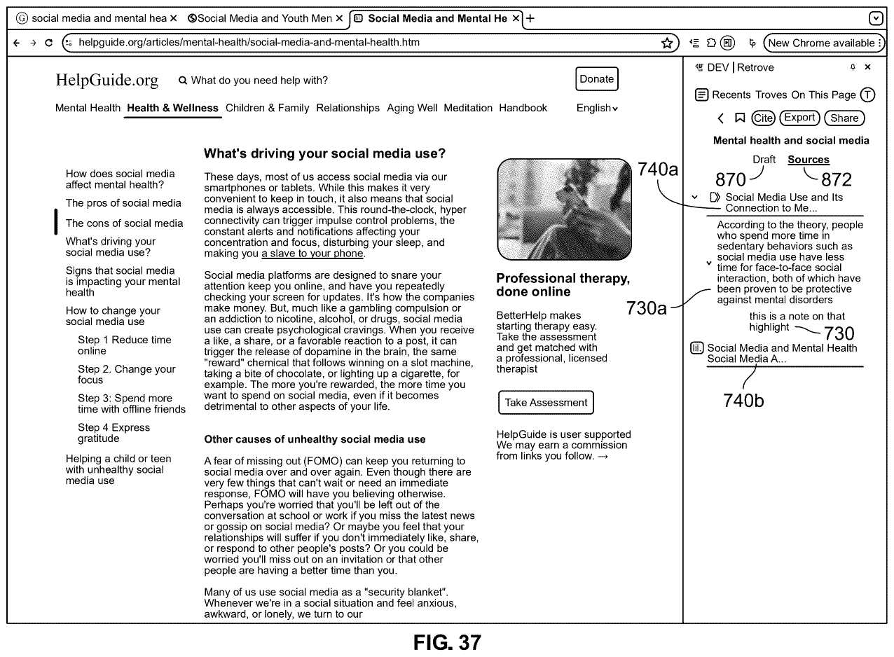

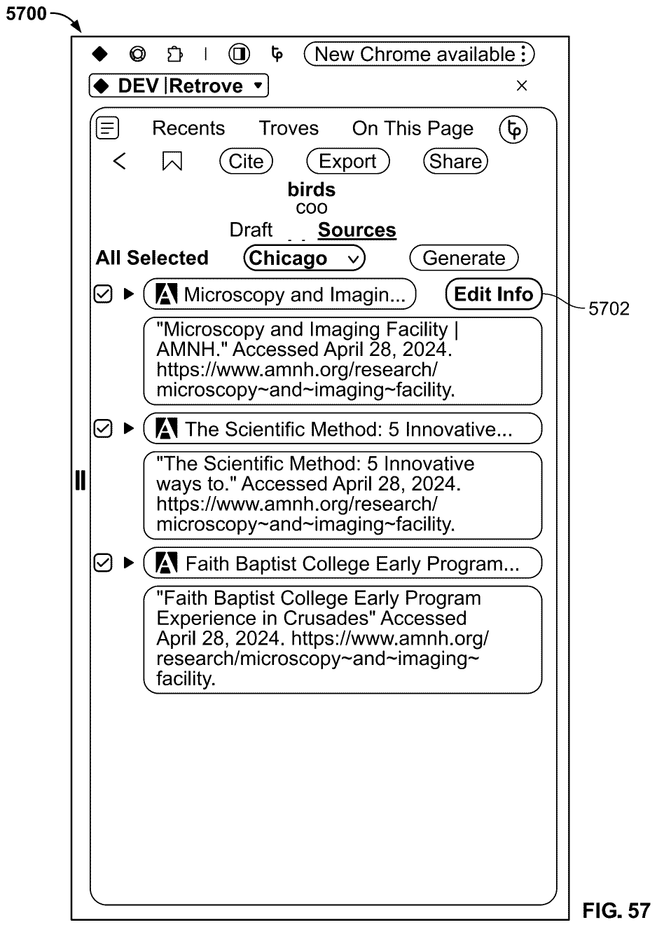

The user can optionally deselect the first source module 740a as illustrated in FIG. 32. In FIG. 33, the web browser extension 702 instruction set operates to enable the user to select the first source module 740a and view the content in the expanded source to see its content that includes the annotation item box module 730a with the highlighted or selected text 708, e.g., the highlight module 730a, and the annotation item box module 730b that includes separate annotation highlighted text or image 732. In FIG. 34, the web browser extension 702 instruction set operates to enable the user to select or click on the select style drop down icon 1010 which causes a plurality of desired citation format modules 1012 to display in the side panel 731. Some examples of the desired citation format modules 1012 include a Simple Citation, APA, MLA, Chicago, Harvard, Vancouver, or the like. In FIG. 35, after the user has selected the Chicago style from the plurality of desired citation format modules 1012, the web browser extension 702 instruction set operates to display the identifier of the selected one of the desired citation format modules 1012 in the style drop down icon 1010. In some embodiments, the user can edit the source's metadata associated with the source module 740. In FIG. 36, after the user selects or clicks on the generate bibliography icon 1011, the web browser extension 702 instruction set operates to format the one or more source identifiers 740a-740b to generate one or more citation modules 1040a-1040b in the designated bibliographic format that is displayed in the notepad or side panel 731. The web browser extension 702 instruction set extracts metadata and generates citations from the web page of the web browser 700. The metadata can include the author of the webpage or if the webpage is a scholar portal and the webpage is of an article or piece of original content also save the date of publication, the co-authors, any other bibliography or citation data that can be found on the webpage or other servers. The one or more citations 1040a-1040b are automatically formatted in accordance with the desired citation format 1012. In one example, the desired citation format 1012 can be selected in the account settings of the web browser extension 702 or can be saved and selected at a trove or project level or can carry over the previous decision of the user as default for other context(s). In an alternative view, the one or more citation modules 1040a-1040b are displayed along with the header or title module 744, and the annotation item box modules 730a, 730b. FIG. 57 represents such a view. Additionally, the one or more citation modules 1040a-1040b can include a generation date, an article title, a retrieval date, and a source URL depending on the user preference and the citation style selected. The user is able to expand the one or more citation modules 1040a-1040b to display the annotation item box modules 730a, 730b. Those modules and annotation item box modules can be editable just like they would in the draft view. The user can select any of the one or more citation modules 1040a-1040b to edit the text therein. In some embodiments, the web browser extension 702 instruction set operates to display a copy icon 752 which enables a user to copy some or all of the contents of the one or more citation modules 1040a-1040b to another document. In FIG. 36, after the user selects or clicks on the bibliography icon 1006 then the web browser extension 702 instruction set operates to format the source modules 740a, 740b to change the view of the notepad or side panel 731 to the source view 872 to display the annotation item box module 730a and the source modules 740a, 740b.

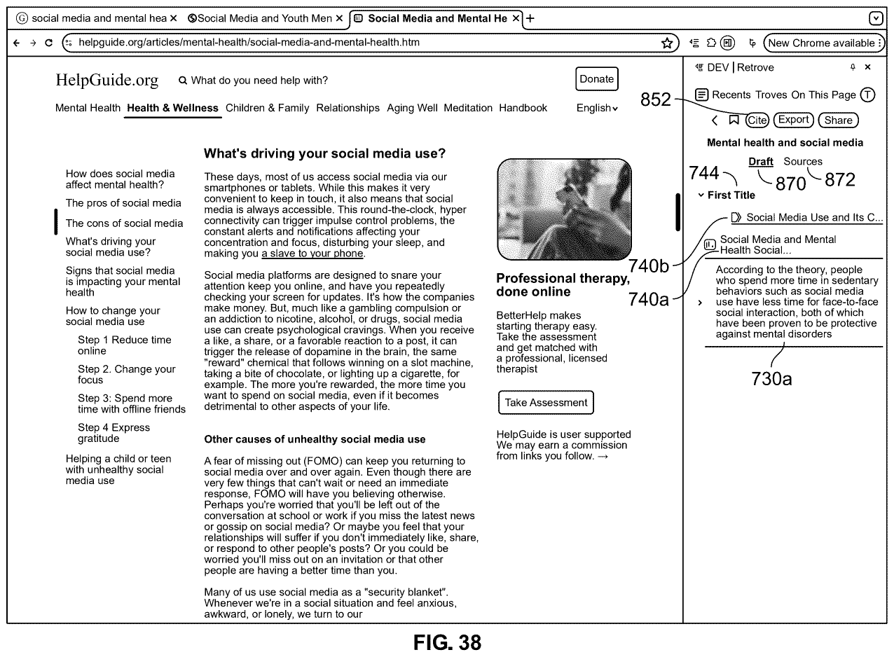

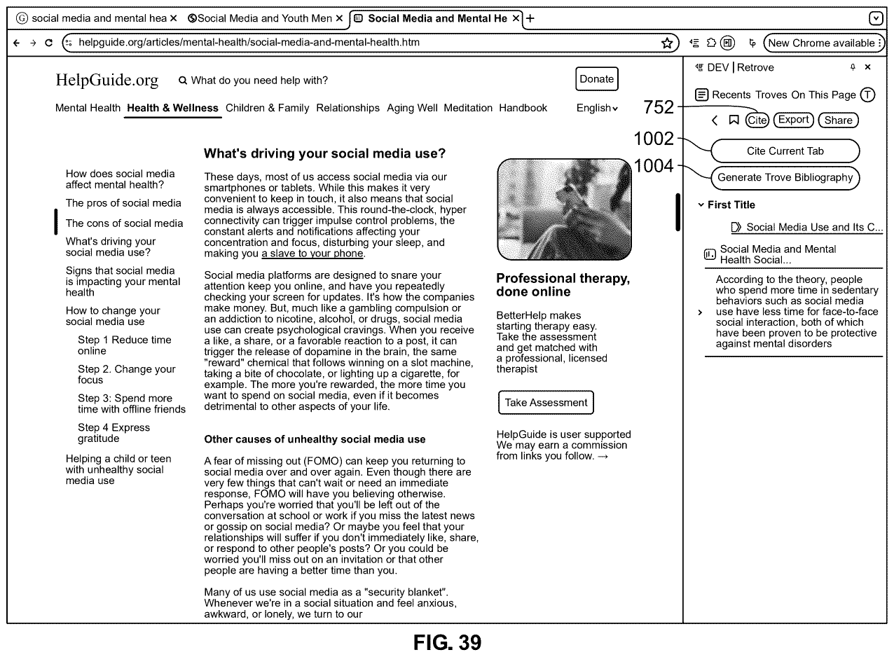

Turning now to FIG. 38, the user has selected the draft icon 870 then the web browser extension 702 instruction set operates to display the annotation item box module 730a. Source modules 740a, 740b are displayed. Turning now to FIG. 39, after the user has selected or clicked on the cite icon 752, the which causes the web browser extension 702 instruction set to operate and display the cite current tab icon 1002 and the generate trove bibliography icon 1004.

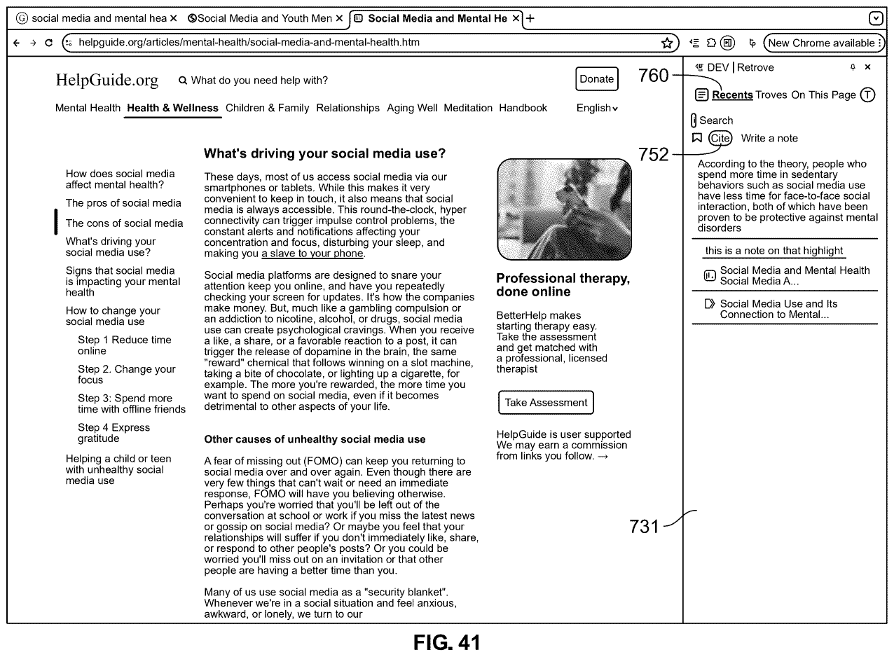

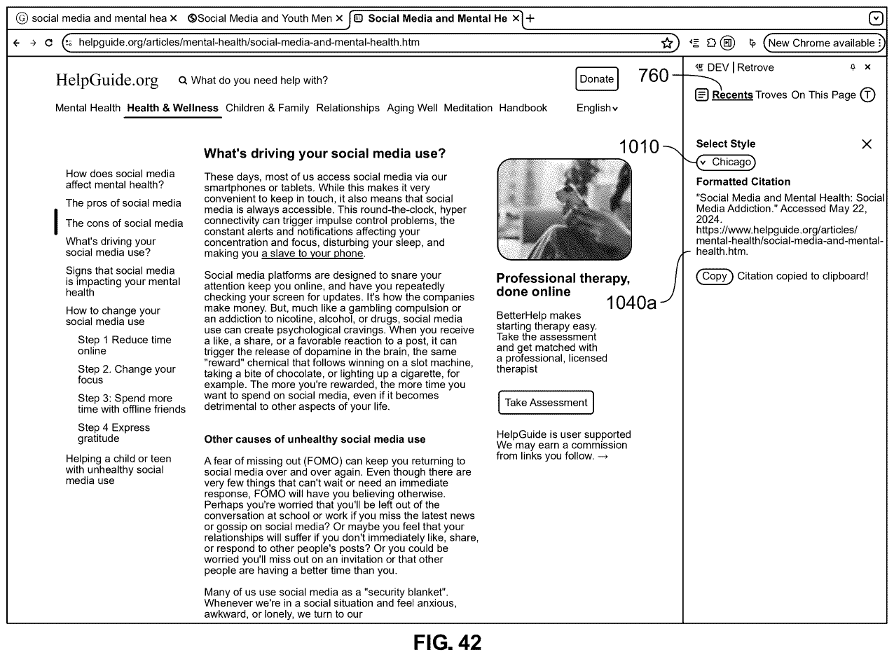

In FIGS. 40-41, the user selects the cite icon 752 while in the recents tab 760 view to cause the web browser extension 702 instruction set to operate to format in the most recently selected style from the plurality of desired citation format modules 1012 and generate the citation module 1040a. The recently selected style from the plurality of desired citation format modules 1012 can be changed in the style drop down icon 1010.

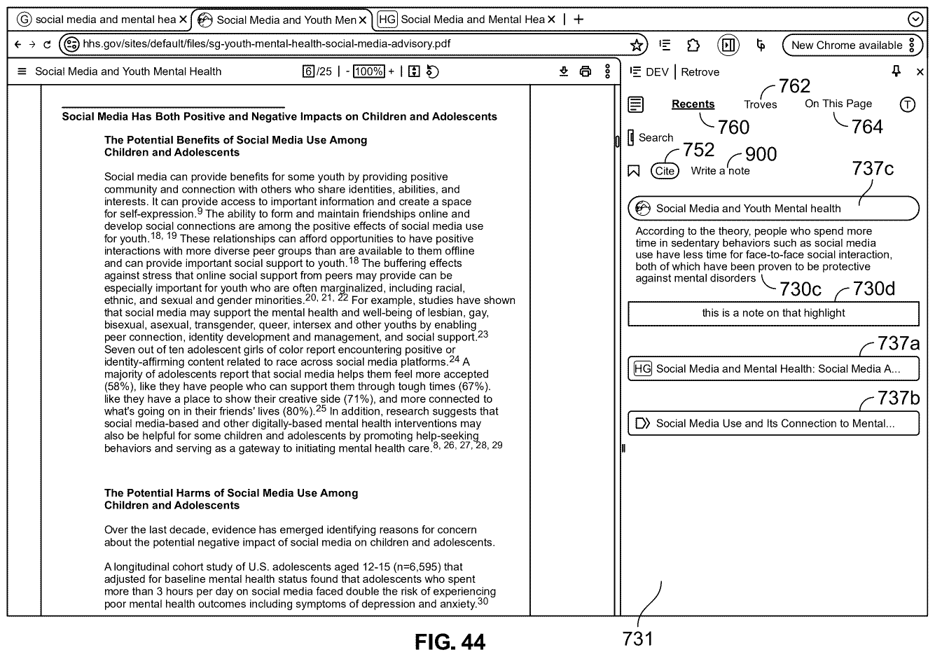

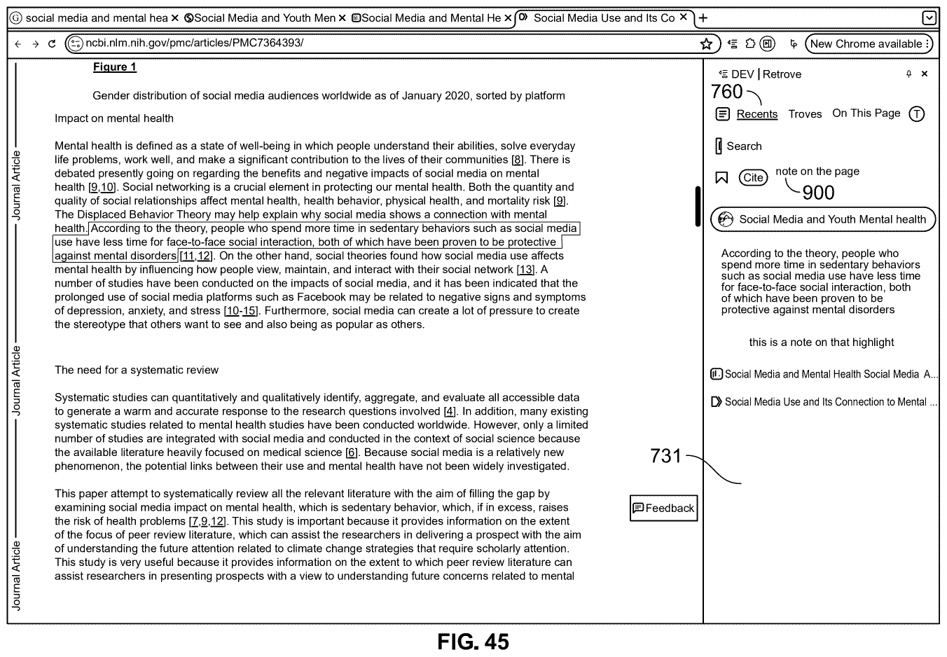

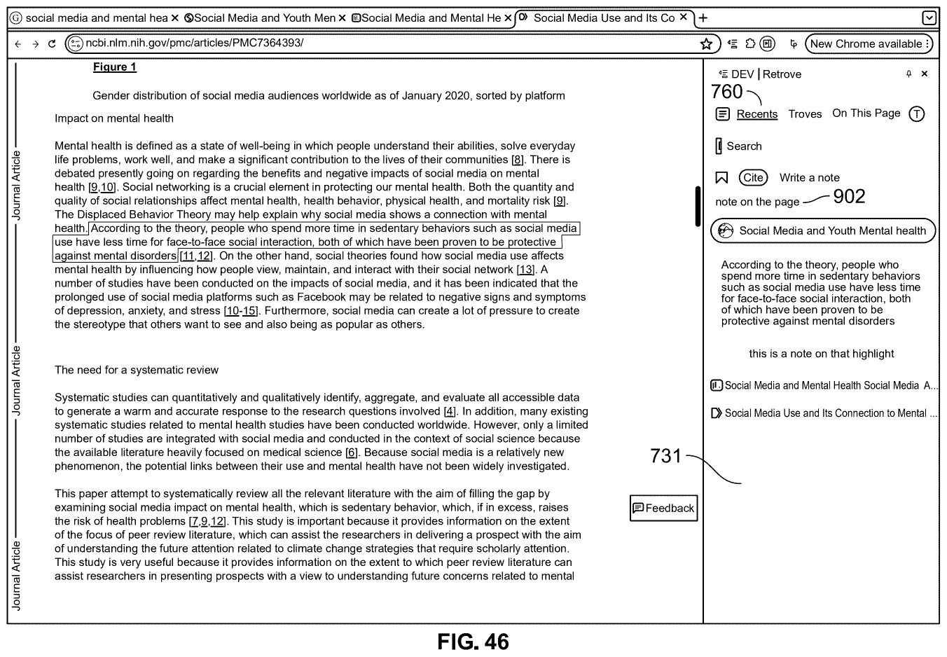

Turning now to FIG. 44, after the user has selected the recents tab icon 760, the web browser extension 702 instruction set operates to organize and save the source module 737a-737c and the annotation item box modules 730c-730d saved by the user in a reverse chronological order from all contexts and display in the side panel 731 associated with the recents tab 760. As can be appreciated, there may be many more of the source modules 737 and the annotation item box modules 730 in other embodiments. In FIG. 45, the web browser extension 702 instruction set operates to display a note input text box 900 that is configured to receive text from a user in the side panel 731. In FIG. 46, after the user clicks enter to save the content entered into the note text box 900, the web browser extension 702 instruction set operates to transform the note input text box 900 to the note input module 902.

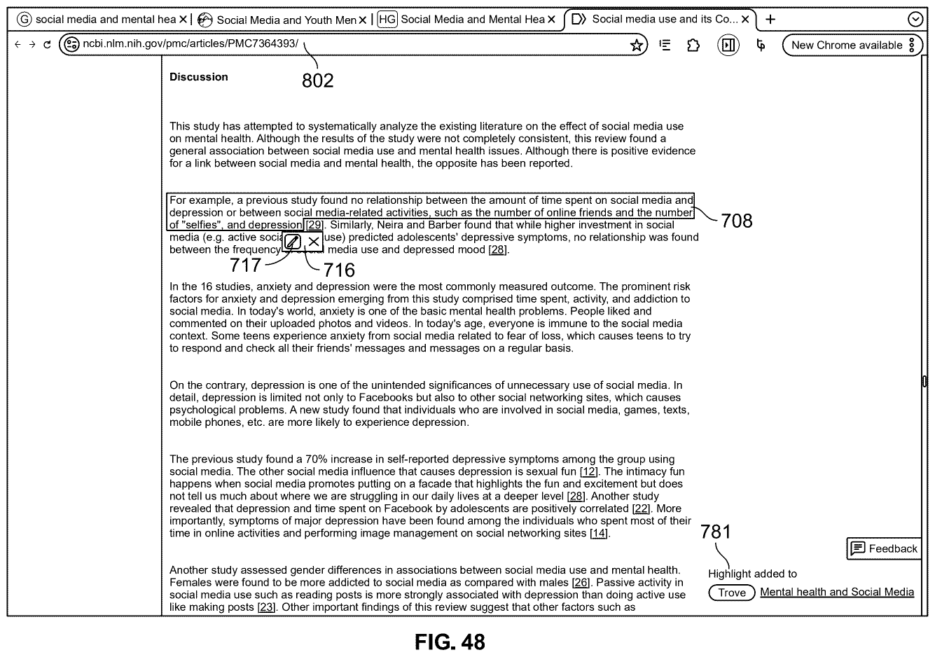

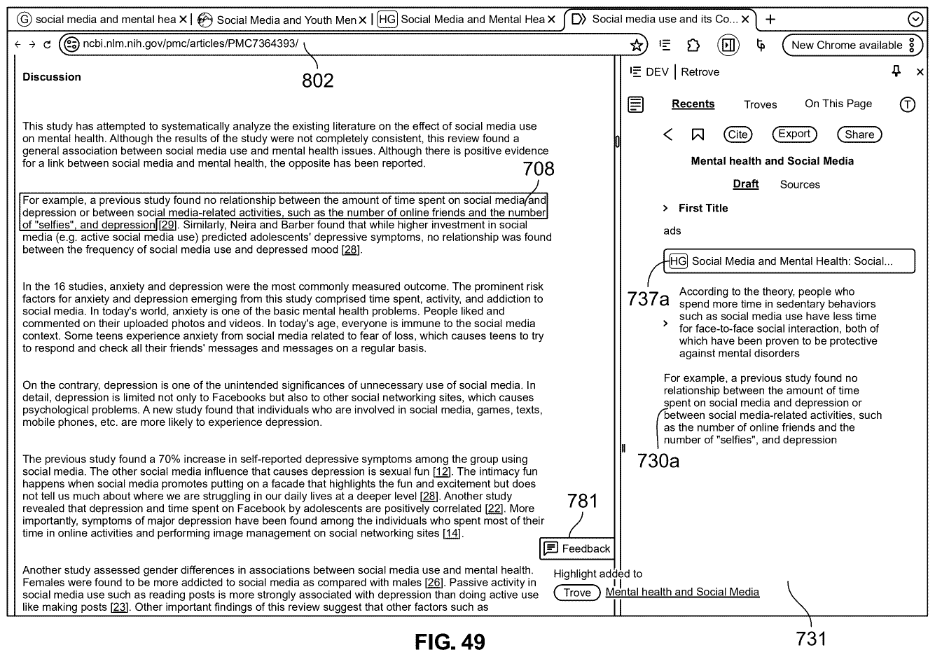

Turning now to FIG. 48, the user has closed the side panel 731 and thereafter the user visits the same website 802 at a later time and the user selects some text 708 from the website 802. The website 802 is integrated with source code or content scripts from the web browser extension 702 that would enable a user to simply visit the website 802 without the side panel 731 displayed in a user interface. Some exemplary integrations with the web browser extension 702 can include Microsoft word, Google, and Zoom platforms however other platforms can be integrated. The integration of the web browser extension 702 into these platforms enables a user to take notes on and work directly in these platforms, using content saved on their account across different software. The web browser extension 702 instruction set operates to display the annotation input box 716 that includes a toolbar with a highlight button 717 or a note button 719 next to the highlighted text 708. If the user selects the note button 719, then the web browser extension 702 instruction set operates to display the note box 745 to receive the separate input annotation 734 or typed text from the user. The separate input annotation 734 is saved in the web browser extension 702 but the web browser extension 702 instruction set operates to not open the side panel 731 automatically. Instead, the user continues reading and highlighting and annotating without opening the side panel 731. But when the user wants to open the side panel 731, then the side panel 731 will show the content saved and notes. In FIG. 48, the web browser extension 702 instruction set operates to display a trove notification 781 that the user can select to cause the web browser extension 702 instruction set to operate to open the side panel 731 as illustrated in FIG. 49 and display the annotation item box module 730a that includes the highlighted or selected text 708 and the source module 737a in the side panel 731. The user can rearrange the annotation item box module 730a and the source module 737a in the side panel 731 as desired. The user can also click on this notification to open a dropdown or menu that lets them select which trove or context the content they just saved should go to if they want to switch the destination of the module. This allows the user to easily switch contexts when working across projects and enhances organization.

When the user clicks on the export icon 856, the web browser extension 702 instruction set operates to export the contents of the side panel 731 into a document or text format or into a format that can be imported in other text editors or complementary software to the web browser extension 702. The document can be created in a variety of formats including PDF, Microsoft Word, and a variety of other open source and proprietary document formats.

In other embodiments, the web browser extension 702 instruction set includes a system-wide search feature of an operating system that also creates an index of all items and files on the operating system and can search all of these items and files. This search can be triggered by the user typing keywords to find a piece of content, source, file or trove that the user saved or has access to, which could be enhanced with AI to show even more accurate results.

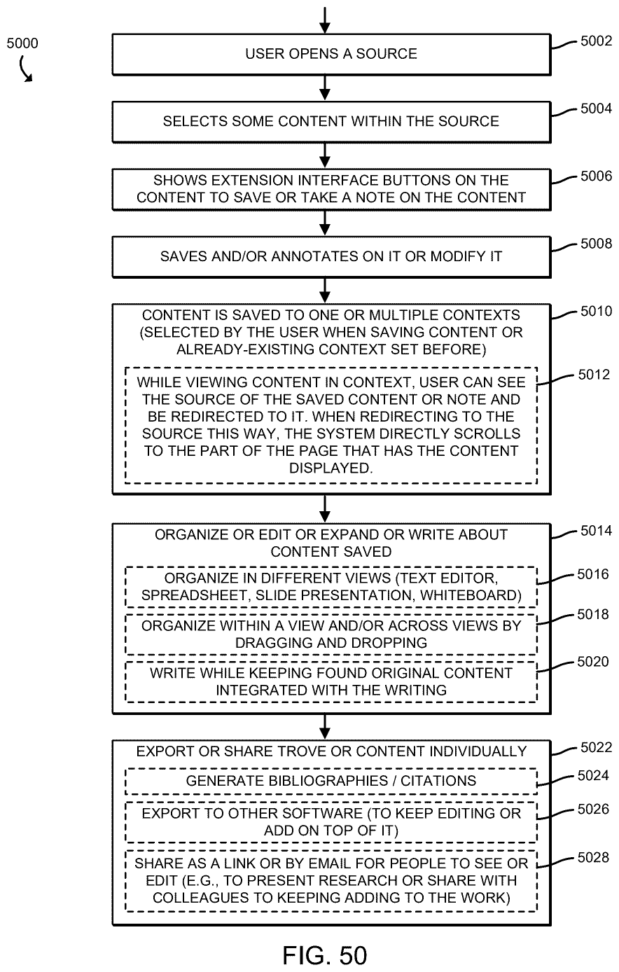

Referring now to FIG. 50, an exemplary embodiment of a flowchart 5000 of an annotation creation is presented showing the steps carried out by the instruction set of the web browser extension 702 that transforms any web browser that supports the addition of the web browser extension 702 into the annotation capable web browser 700, as shown in any previous figure. FIG. 50 shows the steps carried out by the user, the web browser 700, and the web browser extension 702 when creating the annotation item box module 730. Referring generally to block 5002, the user opens a web browser 700, and then the web browser 700 loads the web browser extension 702 so that the web browser 700 operates as the annotation capable web browser. Next, the user visits a URL of a website, and then the web browser 700 loads data sent from the visited URL. Referring generally to block 5004, the user views a web page on the web browser 700 and highlights or selects text or an image (or any piece of content, video, audio, ... (e.g., selected content)). At this point, and referring generally to block 5006, the web browser extension 702 shows an annotation selection button or icon 710 bar available as a result of the execution of the instructions in the web browser extension 702. Next, the user presses a button corresponding to annotation selection button or icon 710, and the web browser extension 702 instruction set makes the annotation input box 716 available in response. Next, and referring generally to block 5008, the user enters text in the annotation input box 716 and hits enter or presses a confirm button or clicks outside of the annotation input box 716. As generally indicated in block 5010, the web browser extension 702 instruction set sends a bundle of data elements to a server or cloud storage (e.g., the application server 150 of FIG. 1). After the user enters text and hits enter, the web browser extension 702 instruction set also retrieves from existing source metadata or generates a citation metadata bundle for the embedded link 736, and the web browser extension 702 instruction set sends a bundle of data elements to a server or cloud storage (e.g., the application server 150 of FIG. 1). Now, the web browser extension 702 instruction set receives the bundles of data elements and displays content from the annotation item box module 730 including embedded link 736 on either the web page 1102 and/or any of the notepads 731, 831, and/or 1131. Now, the user views either the web page 1102 or the notepads 731, 831, and/or 1131 and can click on any of the embedded links 736 to return to the URL of the web page (at the scroll position where the highlighted or annotated content is located), as indicated in block 5012.

As indicated in block 5014, the web browser extension 702 instruction set enables the user to organize, edit, expand, or write about content that has been saved. In doing so, the web browser extension 702 instruction set enables the user to organize selected content and notes in different views (e.g., a text editor view, a spreadsheet view, a slide presentation view, a whiteboard view, and/or an audio/video editor view), as indicated in block 5016. The views are described in more detail below. Additionally, as indicated in block 5018, the web browser extension 702 instruction set enables the user to organize content within a view by dragging and dropping the content (e.g., to a different location within the view). Relatedly, the web browser extension 702 instruction set enables the user to organize content by dragging and dropping the content across views (e.g., dragging selected content (e.g., highlighted content) from a text editor view and dropping the selected content into a spreadsheet view). In some embodiments, dragging and dropping can be performed across the extension 702 and its parent website application, or within the extension 702 opened as a new tab and the extension sidepanel. Additionally, in some embodiments, content can be dragged and dropped across troves or contexts in this way. Further, and as indicated in block 5020, the web browser extension 702 instruction set enables the user to write while keeping found original content integrated with the writing. Further, and as indicated in block 5022, the web browser extension 702 instruction set enables the user to export or share a trove (e.g., a “container” in the method 300) or content individually. In doing so, the web browser extension 702 instruction set may generate bibliographies or citations, as indicated in block 5024. Further, and as indicated in block 5026, the web browser extension 702 instruction set may export to other software (e.g., to enable a user or a team of users) to continue editing and adding to the exported content from the trove (e.g., the “container” in the method 300). Additionally, the web browser extension 702 instruction set may enable the user to share (e.g., as a link or by email) the content for people to see or edit (e.g., to present research or share the research with colleagues to continue adding to the work), as indicated in block 5028.

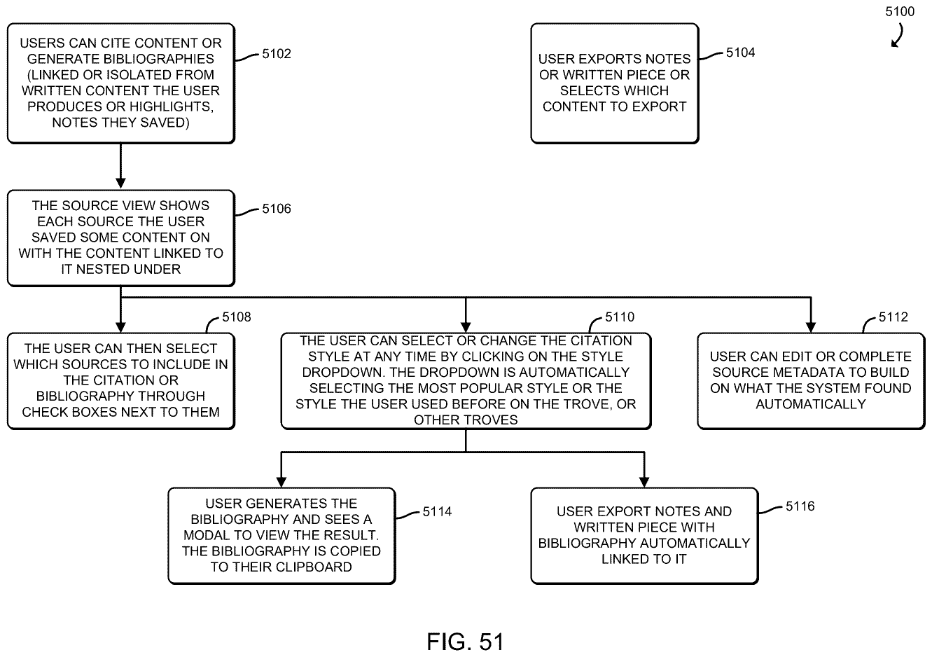

Referring now to FIG. 51, a set 5100 of interrelated features and operations enabled by the system 100 (e.g., the web browser extension 702 instruction set executed by a user compute device 110) is shown. As indicated in block 5102, users can cite content or generate bibliographies (e.g., linked or isolated from written content that a user produces or highlights, and any notes that they saved). As indicated in block 5104, a user may export notes or a written piece or may select which content to export. As indicated in block 5106, a source view shows each source the user saved some content on with the content linked to it, nested underneath. From the source view, a user can then select which sources to include in a citation or bibliography through check boxes next to the sources, as indicated in block 5108. As indicated in block 5110, the user can select or change the citation style at any time by clicking on a style dropdown. The dropdown may automatically select the most popular style or the style the user last used on the trove or other troves or contexts. Further, as indicated in block 5112, the user can edit or complete source metadata to build on what the system 100 found automatically. As indicated in block 5114, the user (e.g., via interaction with the system 100 (e.g., the web browser extension 702 executed by a user compute device 110)) generates a bibliography and sees a modal (e.g., a pop-up window) to view the result. The bibliography is copied to the clipboard (e.g., an area of memory 214 allocated for temporary data). As indicated in block 5116, the user may export notes and the written piece with the bibliography automatically linked to it.

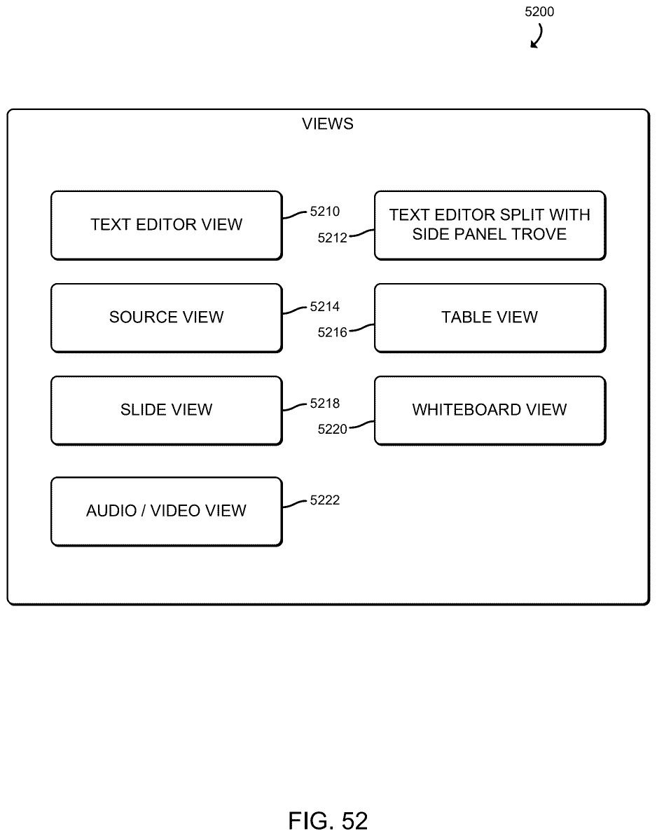

Referring briefly to FIG. 52, the system 100 may produce a variety of different views 5200 to accommodate management of content in troves. On the side panel of the website, a user can reorganize saved highlights and notes in troves by dragging and dropping them, both horizontally (e.g., nesting under other content) or vertically (e.g., rearranging the order in which the content is displayed on the trove). Among the views 5200, the system 100 may produce a text editor view 5210, which allows a user to start from saved content, then write and integrate that content within their writing. Additionally, the system 100 may produce a text editor split with side panel trove view 5212. That is, in some embodiments, the system 100 may present a split screen layout with, on one side (on the side panel or as an integrated side panel within the website version of the extension), the trove content a user saved and took notes on and, on the other side (e.g., website retrove text editor), a blank text editor page where the user can write while seeing their research simultaneously. The user can then drag and drop content from the trove into the text editor view on specific segment of the written text to link saved content with their writings (e.g., creating inline citations, quoting and generating the bibliography or footnotes automatically). The user can also drag and drop content from the trove into the text editor view in between lines of text or other modules, and the dropped content will be rendered (as linked or duplicated depending on the user's selection) in the text editor. In some embodiments, the user can duplicate, move, or create different trove views that are or are not linked to the other views (e.g., separate and not synchronized, like an iteration) to create slide presentations instead of a text report. That is, a user may create a view and any edits in the new view will not modify the content in the other views. Alternatively, a user may chose to link the views such that editing a module in one view causes corresponding modifications in other view(s).

Further, a source view 5214 that may be produced by the system 100 allows user to see all sources with their linked saved content under them. The system 100 may also produce a table view 5216, which allows a user to organize their content as a spreadsheet. In such a view, the cursor will automatically move to another cell (e.g., vertically or horizontally depending on user behavior and preference) after the user saves content. The system 100 may also produce a slide view 5218, which allows a user to organize their content on slides to create a slide presentation. Users can either (a) create a slide view after working from another view (e.g., a text editor view) or (b) save content in a slide view from the beginning. If a user is creating a slide view after working from another view, the system 100, in at least some embodiments, will display the current view and, on the other side of the screen, will display the slide view without content on it. The user can then drag and drop content from their original view into the slides (e.g., in the slide view) as needed. Another view that the system 100 may produce is a whiteboard view 5220. In the illustrative embodiment, the whiteboard view 5220 allows a user to organize their content on a whiteboard to brainstorm ideas or organize their projects, conduct workshops, and/or link themes. The whiteboard view 5220 may work similarly to the slide view 5218, in that users could either create the view later and drag and drop or import content from their original view or start adding content into the whiteboard view 5220 from the beginning. In some embodiments, the system 100 may produce an audio/video view 5222 that presents a user interface to enable users to edit and rearrange clips (e.g., selected content) of audio and/or video in a timeline.

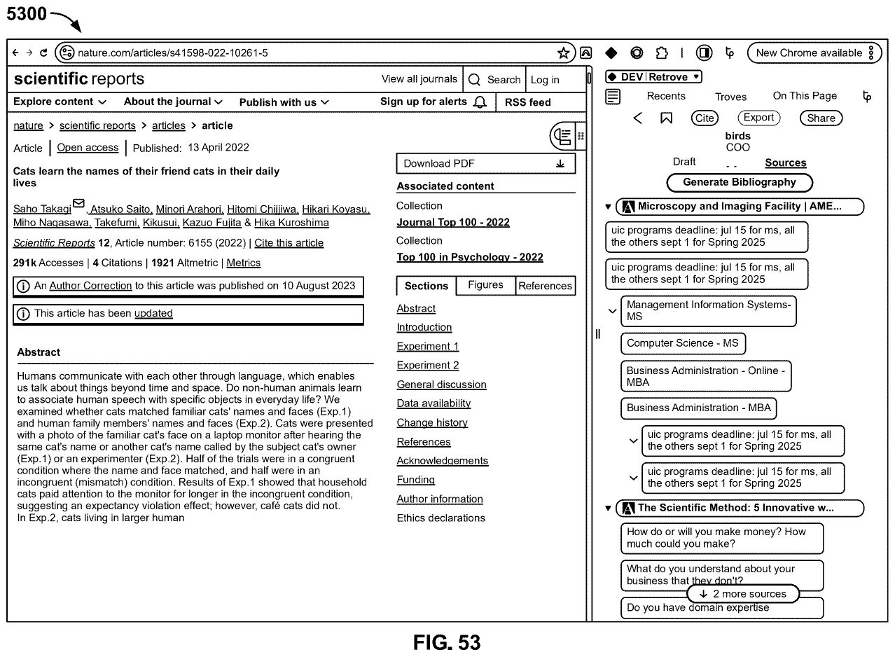

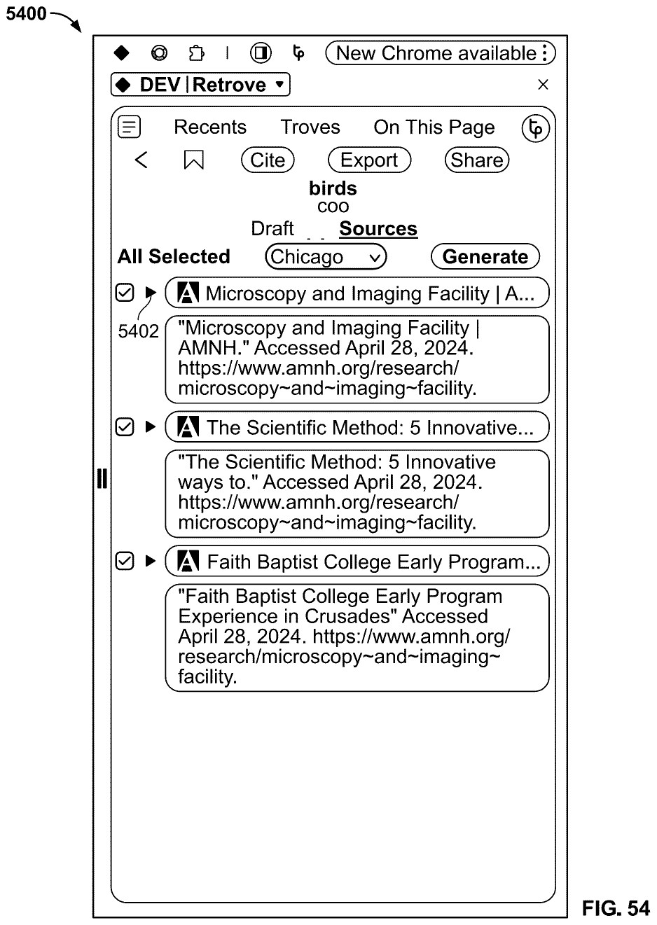

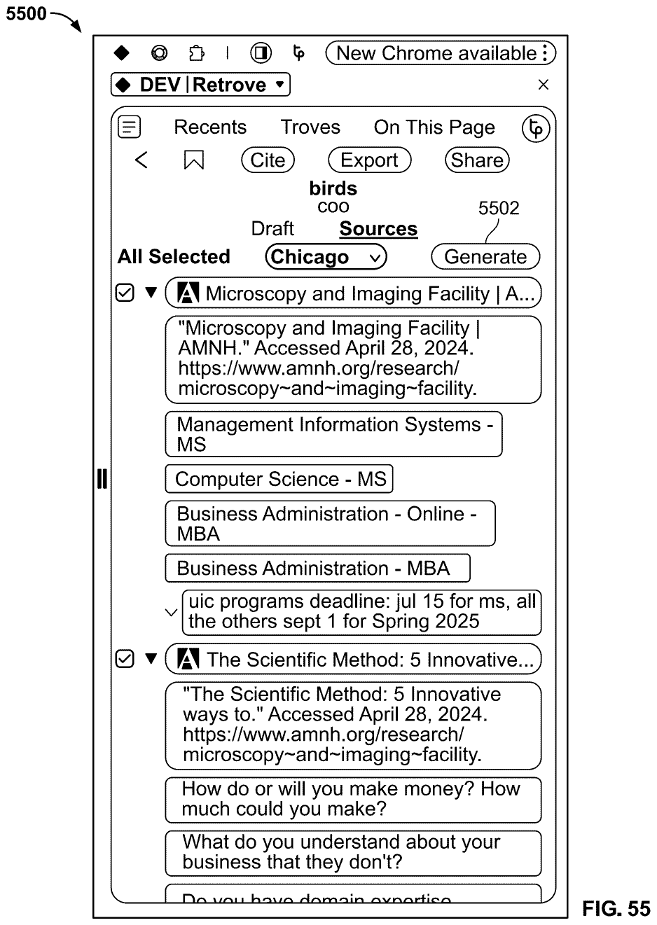

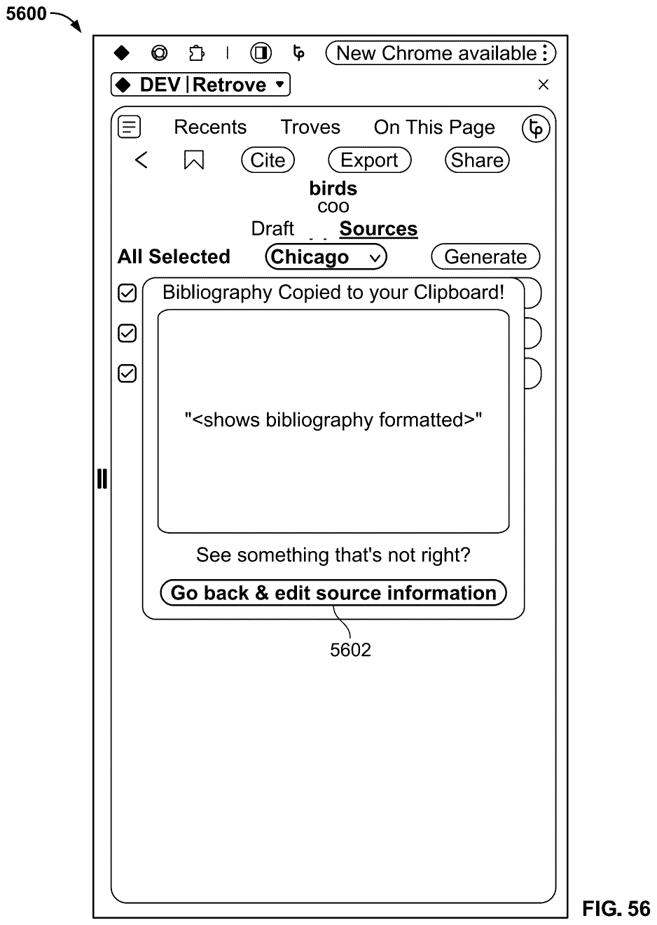

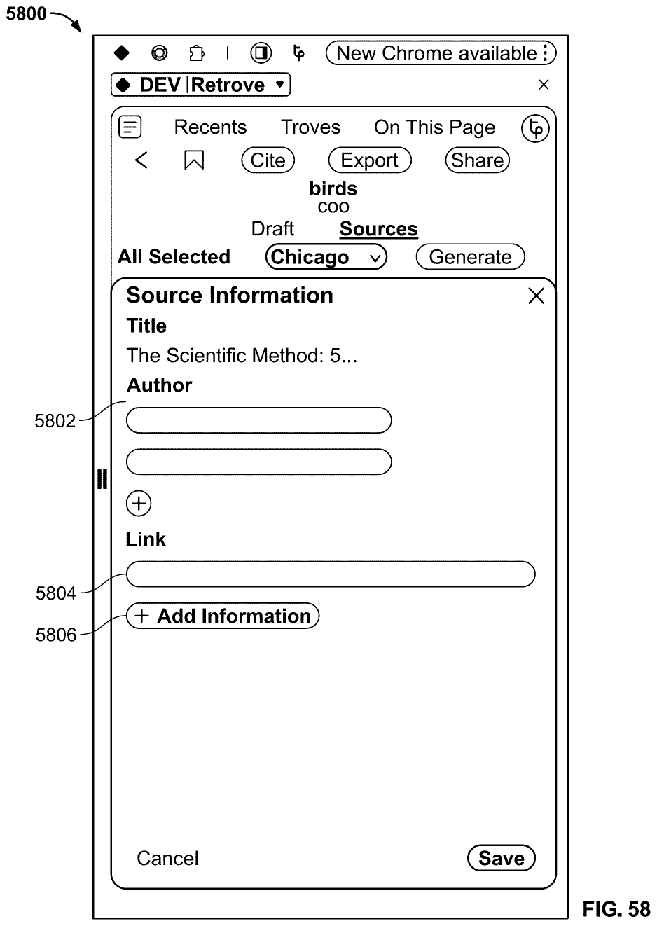

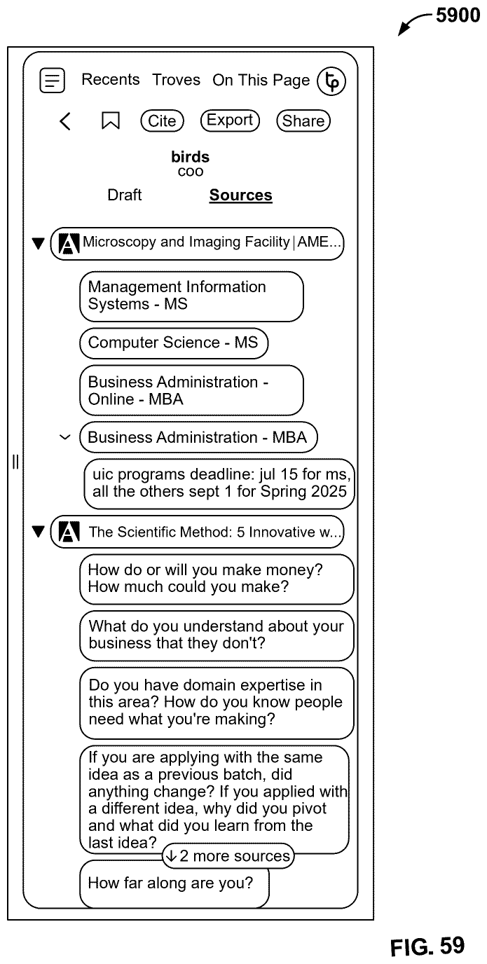

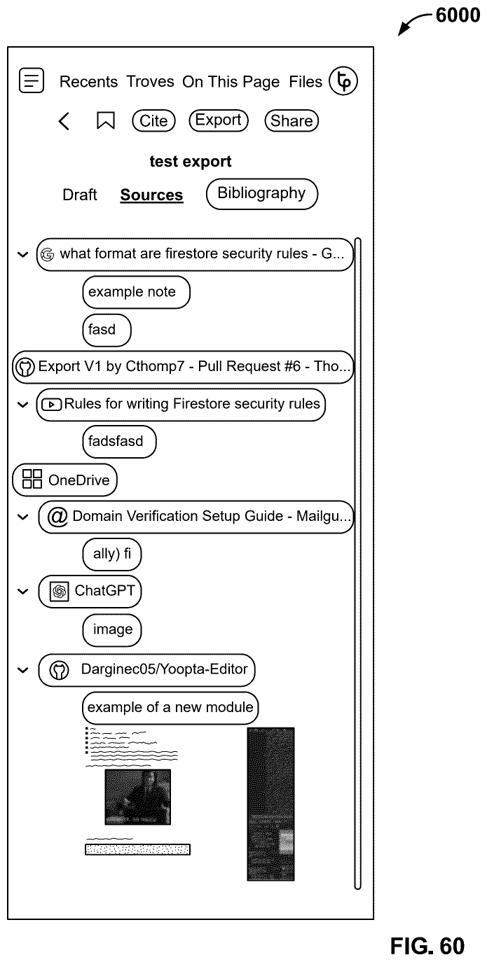

Regarding the source view 5214, and referring now to FIGS. 53-58, the system 100 (e.g., a user compute device 110 executing the web browser extension 702) may produce a sequence of user interfaces 5300, 5400, 5500, 5600, 5700, 5800 in response to user interactions to progress from a source view to a generated bibliography. In the user interface 5300 of FIG. 53, the source view is shown in an initial state with a set of sources with their linked saved content under them in the web browser extension 702. From the user interface 5400 of FIG. 54, focusing on the source view, in response to a user selecting an arrow 5402 associated with a source, the system 100 (e.g., a user compute device 110 executing the web browser extension 702) may produce the user interface 5500 of FIG. 55. In response to selection (e.g. by the user) of the generate button 5502, the system 100 (e.g., a user compute device 110 executing the web browser extension 702) may produce the user interface 5600 of FIG. 56. In response to detecting that the user selected a button 5602 (e.g., to “go back”), the system 100 (e.g., a user compute device 110 executing the web browser extension 702) may produce the user interface 5700 of FIG. 57. Further, in response to detecting that the user selected a button 5702 (e.g., to “edit info”), the system 100 (e.g., a user compute device 110 executing the web browser extension 702) may produce the user interface 5800 of FIG. 58. The user interface 5800 enables the user to edit or supplement source information pertaining to a particular content item, including an author (e.g., in a section 5802), a link such as a URL (e.g., in a section 5804), indicative of where the content item can be accessed (e.g., via the network 160 of FIG. 1), and/or other data (e.g., through selection of the button 5806). The user interfaces 5900, 6000 of FIGS. 59 and 60 each represent embodiments of a source view that may be produced by the system 100 (e.g., by a user compute device 110 executing the web browser extension 702). Specifically, the user interface 5900 of FIG. 59 illustrates a source view in “reading order”, meaning content is displayed in the order in which that content appears on the content items (e.g., websites, pdfs, other documents) from which they were obtained.

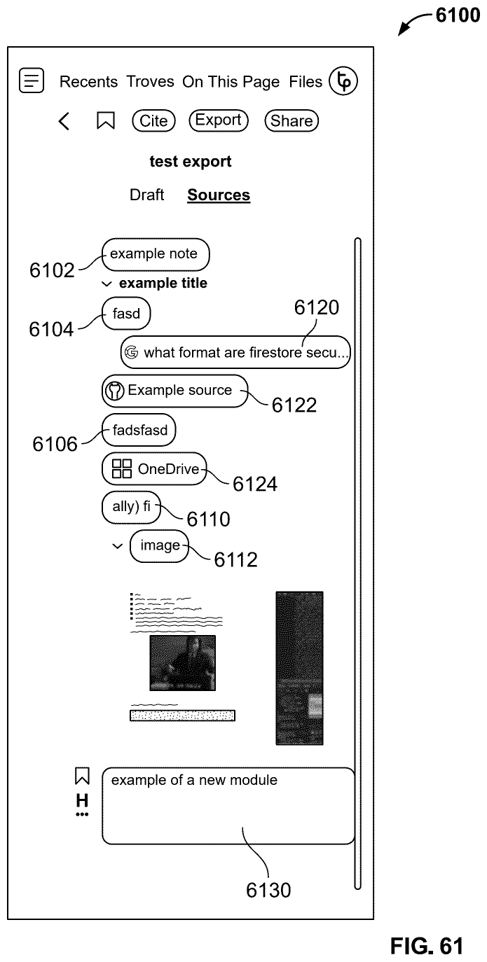

The “test export” trove (e.g., container) illustrated in the user interfaces 6000, 6100 of FIGS. 60 and 61 represents an example a user switching between two views associated with the same trove (e.g., container). Referring to FIG. 60, the user interface 6000 illustrates a “test export” trove in a source view. Referring now to FIG. 61, a user interface 6100 represents a text editor view for the “test export” trove. The text editor view allows a user to start from saved content, then write and integrate that content into a resulting document (e.g., a “report” in the method 300). The user can also choose to start writing and save content from sources as they write. In the text editor view represented in the user interface 6100, user defined notes 6102, 6104, 6106 are represented and the user may add custom modules to render highlights 6110, 6112 (e.g., in a defined color, such as yellow or other color selected by the user) and sources 6120, 6122, 6124 are represented in a different color (e.g., blue). A new module 6130 is also shown in the text editor view represented in the user interface 6100. Images, titles, and other modules may be represented in the text editor view as well.

Other features include an AI-sorted view in the side panel or notepad 731 of the web browser extension 702 enabling organization by relevance, task deadline, or topic. AI can also help the user going from research and notes to redacting an article of piece of writing by both generating content based on the content saved and notes taken and helping reformulate and write. For example, AI can perform automatic redaction of the paper based on research (a trove for example), then AI can reformulate and highlight the content the user took. AI or user generated writing can be discerned as this content relates to a citation and/or a quote. The source tracking at paragraph level will be maintained when the user is generating writing content with AI. When the user is writing on a highlighted quote then AI tracks from which quote that writing is referencing or inspired from. When AI generates content from user research or notes, the original content the user extracted from sources will still be linked to the written output generated by AI and can be visually delimited to stand out compared to what written piece was generated or written by AI or the user. AI generated content will also track what it is writing on as precise a level as it could, the most realistic being paragraph. For example, if the generative AI produces text that references or takes inspiration from a certain highlighted quote or note the user took, then the AI system will be able to link that written output to its source, similarly to when a user takes a note on some text and can then see the source of that text by hovering on it in the side panel.

Still other features include an AI search engine that performs or conducts the research steps and combines with the AI redacting piece of the engine after research material has been gathered to create a fully fleshed out final output. The AI search engine would work similarly to a chatbot and will take as context the trove setup and general user use cases and workflows, data. If the user triggers the AI search engine outside of a trove context, the search results and final output can be outputted in a trove. The AI search engine's input can be anything the user wants, including detailed search tasks description just like the user would send an email to someone. After the user triggers the search, the engine would find relevant sources by browsing the web and/or the user's content, annotate on sources it found relevant with highlights and notes while capturing any other content necessary like images from the sources, then it will output the result of the search using the trove module structure, showing the highlights and other content along with its notes to provide an answer. The advantage of this is that it creates a trove just like a user would while researching and linking to the source and specific passages of a source. This allows the user to go back to where the engine found the passages and see them highlighted or annotated in the full context of the original source. The next step if the user desires is having the AI redaction agent take action on the AI search engine's result if the user wants to create a written output or any other type of document like described in trove views.

Still other features include automating the transcription and summarization of any audio input or source into text within a trove or any other context of the system using AI. One use case for this is creating a transcript of a team meeting into a trove that summarizes what each person needs to do and what was discussed in the meeting. This allows users to have a centralized document with which they can come back to keep track of their work. Another use case might be, as an example, a student listening in a lecture in a classroom and enabling the system to record it and automatically transcribe it into a trove, instead of the student taking notes themselves and missing some information or not listening intently. In this lecture use case, the audio of the teacher will be transcribed into text and the students will also have access to the trove slide presentation if the teacher shared it with them, alongside the teacher's notes on slides. This allows students to get all their class content in a single place, while also having their student notes on the lecture in the same context.

Still other features include a visual notification that prompts the user of important or attention worthy elements whether using the web browser extension, desktop application or integrated in a virtual meeting application. For example, an important element includes mention and scheduling of the next virtual meeting. AI is used to analyze the audio and video content of the meeting, determine which part of the meeting is of significance to the user in their use case and context and then trigger the display of a notification on the screen to let the user know to pay particular attention to a certain part of the meeting. These notifications will vary in importance and will include a short summary of what the speaker said that was of significance. The notification will also have buttons that allow the user to act on such notices, for example to set a reminder or add that content as a task or summary into a trove. One use case might be in a teacher's lecture, in which students are notified that an assignment is due at a certain time. A notification will then pop up on students'screens to show what assignment is due at which time, and have a button to add that assignment to their personal task list and set a reminder in the web extension, desktop application, and/or the mobile application to notify them before the deadline. Other notices might require less engagement from the user and act more as an announcement or indicate a certain important notion. For example, a notification or message can notify the user of a new language term used and provide a short description with a button to learn more that when clicked would redirect to a summary or web search about the new language term. Another example would be a notification letting the user know of a deadline, then user will then be able to click on a button on the notification to add that deadline to their trove and set a notification for it on their Retrove account or sync it to their calendar.

Still other features include retention boosting mini-games that can be generated with AI from the account activity or a trove content. Those mini-games could be generated after the user finished a research project and wants to retain the information when coming back to study or learn in an entertaining way. Those mini-games could include crosswords, spelling bee, flashcards and other word or semantic meaning guessing games. An example of this would be a student who transcribes their lectures into a trove (manually or automatically) with notes and now wants to study for a test the week later. Instead of going back to the content and re-reading all of it, the user would be able to re-discover the same content in those mini-games while also retaining information faster. Those mini-games can be configured as reminders to fit someone's learning schedule too. A user can set to have reminders at the end of every day or another period of time to do those mini-games for each class, similar to homework but more entertaining. An example of a mini-game would be a crossword puzzle where each word the user has to guess is a keyword or new notion that was introduced in the trove (as a lecture for example). Hints would be questions to prompt the user to guess the word, that would be either generated automatically using AI or by a teacher, or a question another classmate or teacher asked. For words that were not guessed correctly or where the user was stuck on, then those words would be included in a review sheet that refreshes the user's memory at the end of the crossword. The user might or might not have access to the trove while completing this mini-game, depending on what the user or the teacher decided. This allows students to have access to the raw lecture, teachers notes, their notes, and tools for memorization like mini-games and summaries all in a single place and software readily accessible. The user will also be able to choose between a variety of mini-games while learning, to accommodate for different learning styles or introduce more entertaining learning experiences, which helps retain the content in different ways.

Still other features include a mechanism that reminds the user of what they learned during the day at the end of the day or allows users to see what tasks are the most prioritized for that day. AI would nudge the user to look at certain time sensitive or high priority tasks and automatically tell the user what would be most crucial to work on if the user tagged, catalogued and saved due dates and importance of tasks or ongoing projects. Another way this could help the user is by the AI prompting the user to review a summary or the entirety of what they saved or did today, yesterday or from any period of time, with the purpose of allowing users to learn, retain certain key information and keep focused on tasks at hand. To reactivate their memory, the reminder could prompt the user to play a mini-game on today's topics.

Still other features include module organization features. One feature allows users to move, duplicate or synchronize one or multiple modules across the different contexts and troves the user works in. Task type modules can contain any text the user inputs and always show a checkbox on the left of each module. Another feature might be the ability to add captions or linked notes to other modules. Those linked notes or captions will be inherently linked and displayed on the first default display of the module it is taken on. This could be used to caption pictures or create a more direct link between a quote or highlight and its notes.

Still other features include tab management features that allow users to organize, keep track of open tabs, close and reopen tabs as needed and categorize them per project, trove or profile. Tabs can also be referenced to as sources since a user can always be redirected to the source's URL or file through their browser (or computer file system). When the user wants to see a source, clicking on the open source button will either redirect them to the already opened tab or source or open this source in a new tab or file browser. Another feature allows the user to create groups of tabs in troves or other contexts. This enables the user to link groups of sources or tabs to a project or save that group to come back to later. The user will then be able to close or open all tabs or sources within that group with a single button, making switching workflows easier. The user will also be able to have any organization interaction that is possible within a trove within those groups of sources or tabs, including editing those sources and adding modules to those sources like notes. Users could rearrange tabs in the group or rename them, remove them from our interface while still having those changes instantly reflected in the tabs rendering of their browsers. In one iteration, tab groups are separate from sources modules but can be viewed and interacted with in the same way, which will allow users to drag and drop sources or tabs from any group into a trove that will convert that tab into a source module. That source module can then be used to generate a bibliography or to be included in any export of the trove. In another iteration, the tab group is the same as a list of source modules and is rendered within the same tree structure as the trove it is in, making the tab group only a grouping rendering of source modules that could be seamlessly integrated in exports or bibliographies. The choice of those two iterations could be left to the user's preferences. Another feature would allow users to have their browser tabs be automatically sorted into tab groups synced both within the browser and within the web browser extension, desktop application or integrated in the web application. This could be done using semantic AI to analyze tabs or sources metadata and choose which group to move the tab into right after the user navigates to a website or file.

Still other features include a quick action toolbar rendering on the current webpage or source the user is on. Clicking this icon will open the full options and buttons of the toolbar, which could include the following: a search button, a save source button to save a source module into the selected context, a cite button to generate a citation and edit the metadata for the current source the user is on and/or add the source to a trove for more detailed bibliography generation, a note button to allow the user to take a note on the source, options to show or hide highlights or the toolbar or other elements of web browser extension, desktop application or integrated in the web application on the source, and other buttons as needed or configured by the user's preferences. The options to hide the system's interfaces could include allowing the user to hide or show the rendering of highlights, notes or the visual interface that appears when the user selects content by default to save it. Other hide or show options could include hiding the toolbar on this current source or to hide the toolbar on all sources until asked to be shown again. The cite button when clicked would open the same context, side panel or user interface the user is familiarized within the system, however it will open it showing options to cite the current source. Citation options will include changing the style of the citation, editing or adding on to the metadata that was retrieved from the source, and other options such as inline citations as needed. By default on clicking the cite button, the source will be cited in the last used citation style by the user or the citation style the user configured within the trove they are currently in the context of, to accelerate the process.

Still other features could include showing a search bar on top of all other source specific elements (meaning the webpage or file opened). To open the search bar, the user would either click on it in another interface of the system like the toolbar or the side panel or they could open it with a keyboard shortcut command. This search bar would act as a first point of entry for users to search through the entirety of the data in any context of the system or trigger actions directly within the source context without needing to go through other interfaces. Users could search by keywords like on any other search engine or they could ask questions and the search engine would suggest results of troves, modules or teams, projects or people that would show as a list under the search bar with options to sort or filter the results. This would still render on top of the source page, without the user having to navigate out of the source. Once a user clicks on a result, they could have the option to be redirected to the source in which that result might be found if it is a highlight for example, or they will be redirected to open the trove or context in which that result is shown. If the former happens, then the user will be redirected to the source of the highlight result and the source will automatically scroll to the highlighted passage. If the latter happens and the search result was a specific module, then the context showing that module will automatically scroll to the module if needed and visually emphasize the module to have it stand out from its context. Another thing users could do through this search bar is quick actions like saving the source as a module or taking a note on it without interacting with other contexts or interfaces. All the actions that could be triggered through the source toolbar (described above) will also be accessible through this interface. Other quick actions could include switching the context within which information is saved for the current project or by default, allowing users to quickly switch between activities without losing flow. For example, a user would be able to switch into which trove their content will be saved to in the next research session, and could do so whenever they switch activities or projects.

Still other features include the ability to highlight or annotate on selected parts of videos and audio content. The user selects the audio or video and specifically delimits on either the timeline of the video player accessible on the webpage or by manually selecting the time range that they want to collect, then show a similar note interface as taking a note on some text. The source data of any module saved from a video or audio source will contain metadata specific to the media and allowing users to be redirected to the source at the exact start point in the media timeline to which they saved content on. The user can also just highlight or collect a specific part of a video or audio source without taking a note on it, and it will be saved in the user's context. Another functionality allows users to rearrange with drag and drop clips of video or audio found. This could be done in a specific “studio” trove view similar to a video production editor with timelines and clips the user can freely rearrange and modify. A user is able to collect clips of audio and video, then stitch them together, edit them and add original user content clips to the trove to create new audio and video content from this studio trove view. Another functionality allows users to preview and play that excerpt saved from a video or audio within the trove or context they are on, without having to browse or open the source.

Still other features include automatically extracting an original work's copyright information form the source where the user saved some content on. This copyright information is referencing the content's original source, for example if the user saved some text commenting on a painting or referencing another paper, the original work's copyright information would include the painting or paper along with the source's metadata that referenced this work, on which the user is taking content on. This copyright content is sometimes fetched directly from accessible source metadata but in the case that it would not be, the system will include some solution to use all context data possible to analyze the text or image using AI to link back not only to the secondary source but to the primary source such as the original painting or paper. This also can work to identify original content in AI generated content by using the C2PA framework's metadata, to track information back to its first primary source instead of stopping at the secondary source layer which might not give explicit credit to the original work it is based on. This could also be automatically done when the user saves some content on a source, by scraping the bibliography, credits or other data located on the source. For example, if the user saves some text from an article, the system would fetch the context of that article including data available on the page like bibliographies and also fetching to external APIs if possible to find the root source of the content the user just saved if the source is a derivation of that root or primary source. The system would then suggest to the user or determine if that root source is relevant to allow the user to truly give credit to authors. This is helpful for content creation and management companies that need to determine copyright and/or attribute royalties to authors.

Still other features include better automatic data extraction from sources like websites, pdfs, audio or video files. This could be enhanced with AI by grabbing the whole context of the webpage for example and adding to the source metadata the data points that may be useful considering the user's use case and context or trove. For example, if a user is searching and comparing apartments to move into, when saving some content on a listing's page, the date the listing was published can also be saved along with the source metadata and shown on user's interaction or demand, allowing them to get the full context of an apartment with their notes without having to redirect to the listing's page every time they look for information they already found. Another functionality could include this exemplary scenario: when a user just created a new project or trove, the first time they save content in that context, they will be prompted to select which source data points should be saved for their trove's sources'metadata. This can be changed later and allows the user to decide what is important to them and tailor to their workflow, while standardizing their source's metadata based on their project criteria.

Still other features include a technique to crowdsource metadata enrichment. This is done either through AI or by simply suggesting the modified or enriched metadata that another user might have completed when editing one's own source metadata for citing purposes. Either way, users can edit their source metadata in order to rectify or enrich what was found automatically through the system. Multiple users can have different metadata for citing the same source, so the system provides a way for users to select the same metadata that others found. If this process is enhanced by AI, then the system provides a more guided suggestion when citing, that instead of showing all other users'versions of the same source metadata, the system only provides the best most universal version that enhances the citation process and provides more accuracy. The way the user would select which metadata to choose amongst other user's suggested metadata would be either by selecting and editing the metadata for each data point (authors, date published, . . . ) or by being presented and selecting different versions of the formatted citation with each variation of the metadata being used, for a more direct approach. The user when browsing could also get suggested highlights that represent popular section of the text other users might have highlighted or took a note on or a piece of content they saved.

Still other features include a manual and automatic way to merge into a single source data point multiple URLs that serve the same original content. The system will discern duplicate or very similar sources and synthesize them into one source if needed, to avoid creating duplicates when generating bibliographies or exporting a trove. The system also lets the user resolve those similarities or conflicts manually if desired by the user.

Still other features include a flow to start a research project easily from scratch by configuring troves and their parameters or views according to the use case of the user. For example, a list of questions to the user and AI can organize the project automatically or kickstart with an outline for a paper. Some exemplary users include project managers to create and share project structure and briefs or by a researcher who gets access to the project or trove and needs to work on it. For the latter, the user can ask questions to the AI about the project and the AI will answer. For the former, the user will create the project structure, brief and guidelines, and goals depending on the project. For example, the user may be prompted to answer questions by filling out a short form. The form can be dynamically generated using AI to create a tailored project setup for the user that exactly fits their needs and workflow. Some questions might include: What is the goal of the research? What kind of sources will be referenced? How will the user publish or present their results? What is your teams workflow? Once created, this allows all users who are added to the project or trove to access and share the project's criteria, delimitation, and views. For example, a writer working with multiple authors to write a book will need multiple text editor views, an outline setup, initial references to start from and/or a slide presentation view to pitch ideas, whereas a sales manager will have a spreadsheet view to qualify leads that his team can work on and a slide presentation view template to present their quarterly results.

Still other features include extracting content from a source and exporting content that is formatted in any format, including text formats such as .docx, .txt, and .md; in PDF format such as .pdf; in image formats such as .png and .jpeg; in audio formats such as .mp3 and .wav; and in video formats such as .mp4 and .avi. Exporting can also be done as synchronizing in real time or delayed or in one action to export data to other tools the user might use to facilitate input and output into the extension. Users can then both export, import and synchronize their data and troves, projects between tools which uses external software integrations and their APIs.

Still other features include customizing the behaviors of the system through addons or plugins. These plugins enable users to customize their experience by adding features or modifying existing ones that are set by default. One example includes integrating a timer or clock assistant that could break work sessions into sets using a time management technique or another technique to schedule breaks and work sessions. Other examples of plugins include a calendar, AI plugins to generate or extract richer content, search engine plugins to search through different engines while in the system. Those plugins make the system widely adaptable to any use case and flexible. To customize and enhance user experience, on the first time a new user opens the web browser extension or app, or website, the user will be prompted to answer a few questions that will determine which plugins, default parameters, onboarding tutorial and templates the user should start with. Beneficially, the user will start with their workflow in mind and with minimal setup manually, since this will be done automatically in the background in a guided implementation. Some questions might be: “Will you be using the system to learn or only to work with others?”, “What is your job?”, “What company do you work at?”, “What will you use this for?”, “What is your usual research/learning/collaboration workflow?”. After or while answering those questions, the user will see the customization and plugins added to their version of the system and can make modifications if needed.

Still other features include a way for users to quickly get context or explanation on a word, sentence, person or any text or any content on a source by selecting that text and either right clicking and selecting a menu option or selecting the text and clicking on a button showing on top of the source's content in the toolbar next to the highlight and note buttons. When executing this action, the user can get background information about the selected text, context as to what the selection means in the scope of the project and any other information necessary for the user to understand more about this selection. Additionally, a learn more button is shown to allow the user to dive deeper in the explanation of that selected text or word. If a single word was selected, the user will get a definition of it as an overlay interface on top of the source content or in the side panel. The learn more button when clicked on will redirect the user to a full page or side panel interface where the user will see each additional information section in more detail, with sources. That additional information interface could be generated as its own trove that the user can come back to at any time, and/or it could also include a group of sources that the user can navigate to dive deeper in the explanation or context. Background information, context explanations and sometimes definitions can be generated by AI. On each AI generated content, the source of its generation will be linked so that the user can always be redirected and learn more about specific topics or get more context on what was generated for a better comprehension of the selected text. This function is an assistant to support auxiliary or smaller research tasks that support the main research task, while allowing the user to dive into other areas or get more context about specific text or content found on pages. This action to get more information on a selected text from a source can also be executed by selecting a module or some text within a trove. The overlay would then render on top of the trove content. For example, a user could select a word from a transcript of a meeting within a trove to get an explanation on what it means in the context of the meeting and of the company if it is a company specific use of the word. The additional information popup could also vary the type information that is displayed according to what is most useful to the user. For example it could show a definition from a dictionary along with links to continue to learn more about the meaning of it right in the overlay of additional information on top of the source or trove.

Still other features include illustrating progression in a project and gamifying it with purposeful milestones and goals. Users start a project or create a new trove will either have goals set automatically if the criteria or brief of the project is linked to the user's project or trove or will have to create and define the end goal. The system defines milestones using AI and determine when to send notifications of progress. As the user adds content to a trove or annotates sources, the user can visually see that they are finishing a project or progressing on towards the end of the project. The system can provide notifications on major milestones including but not limited to page or word count or finishing annotating a source to create a sense of progression and achievement when finishing a sub task while being entertaining. For example, a student writing a paper that needs to be 10 pages might see a discreet progress bar on the trove that fills up as the student writes or researches. When reaching 5 pages of the first draft, the student will have a notification that encourages and shows the progression towards the end goal. If the student finishes the paper ahead of the deadline, they would get a badge or reward that can be seen on their profile. Other badges or achievements can be collected in the same fashion by doing other tasks depending on the user's usage and can be tailored to the use case or work of the user. The user will be able to edit their preferences to receive or not receive those notifications and badges and how frequently those might be unlocked.

Still other features include annotating and adding content on top of webpages or sources similar to a whiteboard or scrapbook. Users can upload images to the web browser extension, website, or application and place the images on top of a source wherever the user wants and then the user can write or draw on top of the source. This rendering of an extra layer of user generated content can be done within the browser extension or app or could be done through the website by importing the source. In order to add images on top of a source, the user will display the image as an icon or cropped or reduced version of the image on the source to keep the source readable, in which case hovering or clicking on the image would expand the image rendering and show it in full as an overlay on top of the webpage. This mode can be toggled on and off to not see annotations on the webpage. The user can share that annotated source or page in itself as a link that will redirect to either render the webpage within the website with annotations on it or the URL of the webpage that was annotated so annotations can render on top of the webpage if the user receiving the link has the extension downloaded. After annotating a source, the user can also print it.

Still other features include the display of a notification on the user's current source or tab when they save content within a trove but do not have the side panel opened. This reminds the user which context that saved content is stored, in which project, trove, team and/or view. The user can click on the context location in which that content is saved to change the context and where that and future content should be saved from now on. They will be able to search for other troves or contexts to switch the location of the saved content. Depending on the view, the user might also need to select the location in that trove or context that saved content should be saved, for example in a text editor view, the user will be prompted to place their cursor in the text editor to determine where the content should be saved if the user desires. When the side panel is opened and the user saved some content, the notification will not be rendered on the source but the user could see the side panel automatically scroll to the location of the added content in a trove.

Still other features include the system enabling users to search multiple search engines and AI search engines and AI chatbots simultaneously through a single search input user interface and aggregated/centralized search engine. The search results could then be rendered within a trove if the user wishes to. The user can also generate a single answer synthesis from all the results of the different search engines, referenced as “sub-engines” below. That would include the user first asking their question or submitting their prompts or keyword search, then fetching the results of each sub-engine the user linked and selected for this search, then sending all the results into a synthesizing engine or AI that will generate the final answer the user will see. The synthesis is shown with links citing or referencing the specific parts of the other answers that were fetched by the aggregated search engine. The user can on each part of the synthesized answer see which part of the sub-engine answer was linked to it and can see the entire sub-engine response with the linked part highlighted in its context. The synthesizing engine could either be a custom engine or use a third party AI service to generate the final answer. The system will identify and merge similar parts of the sub-engines'responses since all of the results have the same answer part, the more that part should be emphasized in the answer. It will also need to identify and spotlight parts of answers that were present in only some or one of the responses since those can become enriching and sometimes the most qualitative answer parts. If the user does not wish to generate a synthesized answer, they can setup the search so that they directly see the results of all of their sub-engines side by side or consecutively to compare each result with one another and get the most complete picture for their question.

Still other features can include a screen capture function to allow users to save the screen captures as images in the connected website, web browser extension, and/or application or allow the user to extract the text, image or content from a source that might not allow them to select that content easily. If the latter situation occurs, then the text or content the user selected within that screen capture will be extracted and the user will be able to edit it and them save it within their current context or trove, either as a screen capture or as the raw content. If the latter is chosen, the user can see the screen capture in their context as an image or in the source context by being redirected to the source with a rectangle outline delimiting the screen capture. An example use case includes extracting text from a pdf or image that might not have its text as being selectable. The user will be able to trigger a screen capture through the spotlight bar on top of the source or through a keyboard shortcut or button on the user interface. Another way to extract the content from the source that is not as easily selectable, can include automatically detecting text and allowing the user to select the text from the source in the first place.

In at least some embodiments, in a trove text editor view, when adding a module (annotation item box module) from selected content, the user can choose to add modules “after the last touched” module, meaning after the module that was last moved or added (or edited in some embodiments). This would mean that a user could for example create a title in the middle of other modules and add a note nested under that title (this note is now the “last touched module”). Then, when the user adds a highlight from a webpage, that highlight will automatically go after the note that is under the title. This highlight would then become the “last touched” module and any other highlight would go under this highlight, and so on until the user moves or adds another module elsewhere. That way, instead of having the modules automatically added to the bottom of the trove, the user will be able to add modules in the middle (or after selected modules or titles) repeatedly one after another, without having to move them after. This could also be toggled on and adapted for the spreadsheet, slideshow or whiteboard view. Another embodiment of this is simpler and allows the user to see their cursor in the text editor view, and would add modules after the cursor position (or the module where the user has the cursor) instead of after the last touched module.

In at least some embodiments, the “context” in which the user adds modules from sources (e.g., highlights, notes, etc.) within a specific trove or not, is determined by two factors: (1) the user navigating on the side panel into a trove or outside of one and (2) by the user changing the location of the modules added through the notifications on the current tab (e.g., to confirm a highlight is added) when the side panel is closed. When the user reopens the side panel, they would see whatever context they are in (e.g., that they might have changed in the notification menu while the side panel was closed). In at least some embodiments, there are at least two types of contexts: a general user context (modules added not within a trove, that is, they would be rendered when the user navigates to the “recents” or “on this page” tab) and a trove context (e.g., when a user has selected or is within a trove in the side panel, those modules can be seen on the “recents”, “on this page” and the trove's page). If the user sets the context (e.g., which trove these modules should go into or not within a trove), then the context becomes the default location of the next module the user has, until they change their context again. This helps users to not have the side panel opened at all times (e.g., a notification that allows switching between contexts). It also helps users adding content in the project (trove) they are currently working on, instead of having to manually move the modules later or attribute the context each time they add a module.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In some instances, the benefit of simplicity may provide operational and economic benefits and exclusion of certain elements described herein is contemplated as within the scope of the invention herein by the inventors to achieve such benefits. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, by a compute device, user selection data indicative of selected content within a content item, including storing content source identification data in connection with the selected content;
classifying, by the compute device, the selected content within a container, including receiving a user designation of the container and storing data indicative of an association between the container and the selected content;
reusing, by the compute device, the selected content associated with the container, including incorporating the selected content into a report that includes at least one corresponding citation based on the content source identification data; and
exporting, by the compute device, the report.

2. The method of claim 1, further comprising highlighting the selected content within the content item and wherein exporting the report comprises exporting the report for use by one or more users or exporting the report to a software application.

3. The method of claim 2, wherein exporting the report comprises exporting the report in a selected format associated with the software application.

4. The method of claim 1, further comprising enabling, by the compute device, rearrangement of multiple sets of selected content within one or more views or across multiple views.

5. The method of claim 1, further comprising receiving the user selection data, classifying the selected content, or reusing the selected content in a web browser extension or adding a module indicative of content from a webpage or other source content after a cursor, a last touched module, or at an end of a trove.

6. The method of claim 1, wherein receiving user selection data indicative of selected content within a content item comprises receiving user selection data indicative of selected content within at least one of a web page, a document, audio, or video.

7. A method for saving content in modules comprising:
in a computer with a processor and memory including one or more programs executable by the processor to perform:
receiving an indication that a first web page is being accessed by a first user;
displaying a side panel associated with a specific trove, wherein the trove represents a container;
selecting, via the first user, content from the first web page;
in response to selecting the content, saving the content in a content annotation item box module in the side panel and saving a source module that corresponds to a digital location of the first web page in the side panel.

8. The method of claim 7, further comprising adding at least one tag indicative of a label to one or more modules, wherein each tag can be modified and can form a basis for sorting, searching, or filtering the one or more modules.

9. The method of claim 7, further comprising at least one of automatically linking the source module to the content annotation item box module in the side panel associated with the specific trove or creating, via the first user, a plurality of note annotation item box modules in the side panel associated with the specific trove.

10. The method of claim 9, further comprising enabling the first user to move, synchronize, or duplicate any element, including any module selected from the content annotation item box module, the source module, and the plurality of note annotation item box modules, or other visual element, as desired in the side panel and across views by a drag and drop interaction, a user interface menu or copying and pasting.

11. The method of claim 10, wherein the moving includes nesting any of the modules or elements under another module or element in the side panel.

12. The method of claim 7, wherein the digital location of the source module includes citation metadata for the source module.

13. The method of claim 7, further comprising displaying one or more interface buttons in the side panel, wherein the one or more interface buttons include any of a new trove tab, a recents tab, a trove tab, a page tab, a share tab, a cite tab, an export tab, or a files tab.

14. The method of claim 13, further comprising in response to the first user selecting the share tab, sharing a link to the specific trove side panel to a set of one or more other users wherein the link enables the set of one or more other users to access the saved content annotation item box module and the saved source module in the side panel, view content associated with the trove in a web application or extension, and share one or more modules, including rendering highlights or notes associated with sources associated with the trove for all users sharing the trove.

15. The method of claim 13, further comprising:
in response to the first user selecting the cite tab, generating a bibliography of the source module in a designated bibliography format as selected by the first user; and
displaying a sources view in the side panel associated with the specific trove,
wherein the bibliography and trove content created by the first user is configured to be changed or expanded by another user having editor level access to the trove, and
wherein the bibliography and trove content is configured to be edited in real time for other users to view or to be edited with a versioning system to enable users to create corresponding versions and share the versions.

16. The method of claim 13, further comprising:
in response to the first user selecting the export tab, exporting the saved content annotation item box module and the saved source module in the specific trove side panel to another software application; or
in response to the first user selecting the recents tab, displaying in a reverse chronological order all of the content annotation item box module and the source module from the side panel associated with one or more troves in a new side panel associated with the recents tab.

17. The method of claim 7, wherein in response to the first user selecting the content from the first web page, displaying an annotation input box that includes a highlight icon and a note icon, wherein the highlight icon is configured for selection by the first user to highlight content in the first web page and the note icon is configured for selection by the first user to enter text.

18. The method of claim 7, further comprising in response to the first user highlighting additional content in the first web page, saving the additional content in a second content annotation item box module in the side panel and visually representing the highlighting in first web page along with one or more notes defined by the user in association with the first web page.

19. The method of claim 7, wherein the side panel displays a user interface that includes any of a text editor view, a sources view, a spreadsheet view, a slide presentation view, a whiteboard view, an audio editor view, or video editor view.

20. The method of claim 19, wherein the side panel displaying the text editor view includes any previously saved content annotation item box module and saved source module and wherein the method further includes enabling a user to duplicate an original view to allow the user to make changes in the duplicated view without affecting content in the original view or wherein the side panel enables a user to synchronize edits across views.
